(19) United States
(12) Patent Application Publication
(10) Pub. No.: US 2024/0314058 A1
(43) Pub. Date: Sep. 19, 2024

(54) RADIO EQUIPMENT DIRECTIVE SOLUTIONS FOR REQUIREMENTS ON CYBERSECURITY, PRIVACY AND PROTECTION OF THE NETWORK

(71) Applicant: Intel Corporation, Santa Clara, CA (US)

(72) Inventors: Markus Dominik MUECK, Unterhaching (DE); Amit ELAZARI BAR ON, Pacifica, CA (US); Stephane DU BOISPEAN, Schaerbeek, Brussels (BE)

(21) Appl. No.: 18/549,806

(22) PCT Filed: Jun. 8, 2022
(86) PCT No.: PCT/US2022/032720

§ 371 Date: Sep. 8, 2023

Related U.S. Application Data
(60) Provisional application No. 63/208,639, filed on Jun. 9, 2021.
(60) Provisional application No. 63/242,959, filed on Sep. 10, 2021.

(51) Int. Cl. H04L 43/50; H04L 41/40; H04W 12/03; H04W 12/12

(52) U.S. Cl. CPC H04L 43/50; H04L 41/40; H04W 12/12; H04W 12/03

(57) ABSTRACT

The present disclosure discusses various implementation solutions to meet the requirements of the European Union's Radio Equipment Directive (RED). Various testing architectures and test services are provided for each of the RED requirements that allow for reproducible validation and/or verification of radio equipment. Other aspects may be described and/or claimed.

### RELATED APPLICATIONS

The present disclosure claims priority to U.S. Provisional App. No. 63/208,639 filed on 9 Jun. 2021 (“['639]”), and U.S. Provisional App. No. 63/242,959 filed on 10 Sep. 2021 (“['959]”), the contents of each of which are hereby incorporated by reference in their entireties.

### TECHNICAL FIELD

The present disclosure is generally related to edge computing, cloud computing, network communication, data centers, network topologies, and communication system implementations, and in particular, to technologies for radio equipment cyber security and radio equipment supporting certain features ensuring protection from fraud.

### BACKGROUND

The DIRECTIVE 2014/53/EU OF THE EUROPEAN PARLIAMENT AND OF THE COUNCIL of 16 Apr. 2014 on the harmonization of the laws of the Member States relating to the making available on the market of radio equipment and repealing Directive 1999/5/EC (hereinafter the “Radio Equipment Directive” or “[RED]”) establishes a European Union (EU) regulatory framework for placing radio equipment (RE) on the market. The [RED] ensures a single market for RE by setting essential requirements for safety and health, electromagnetic compatibility, and the efficient use of the radio spectrum. The RED also provides the basis for further regulation governing some additional aspects. These include technical features for the protection of privacy, and protection of personal data and against fraud. Furthermore, additional aspects cover interoperability, access to emergency services, and compliance regarding the combination of RE and software.

The [RED] fully replaced the existing Radio & Telecommunications Terminal Equipment (R&TTE) Directive in June 2017. Compared to the R&TTE Directive, there are new provisions in the RED which are not yet “activated”, but which will be implemented through so-called “Delegated Acts” and/or “Implementing Acts” by the European Commission in the future. Recently, an Expert Group has been set up by the European Commission for RED Article 3(3)(i) in order to prepare new “Delegated Acts” and “Implementing Acts” regulating equipment using a combination of hardware (HW) and software (SW).

### BRIEF DESCRIPTION OF THE DRAWINGS

In the drawings, which are not necessarily drawn to scale, like numerals may describe similar components in different views. Like numerals having different letter suffixes may represent different instances of similar components. Some examples are illustrated by way of example, and not limitation, in the figures of the accompanying drawings in which:

FIG. 1 depicts an example test access to equipment under test (“EuT”) for requirements related to [RED] Article 3(3)(d), (e), and (f), including an example of test access to the EuT for performing attack tests and for verifying information of a memory unit to identify potential attacks.

FIG. 2 shows a signaling procedure for special test access to the EuT for verifying information of the memory unit to identify potential attacks.

FIG. 3 depicts a 3GPP 5G service based architecture with a Monitoring and Enforcement Function (MEF) and an Neff interface/reference point. FIG. 4 depicts a new hierarchical Network Exposure Function (NEF). FIG. 5 depicts the 5G service based architecture with the hierarchical NEF and related Nnef Interface(s)/Reference Point(s).

FIG. 6 depicts an example detection of neighboring untrusted equipment. FIG. 7 depicts a procedure for discovery of trusted/untrusted neighboring equipment. FIG. 8 depicts an example routing process.

FIG. 9 illustrates an example network architecture. FIGS. 10 and 11 illustrate example core network architectures. FIG. 12 illustrates a non-roaming architecture for Network Exposure Function in reference point representation.

FIG. 13 illustrates an example edge computing environment. FIG. 14 illustrates an overview of an edge cloud configuration for edge computing. FIG. 15 illustrates operational layers among endpoints, an edge cloud, and cloud computing environments. FIG. 16 illustrates an example approach for networking and services in an edge computing system. FIG. 17 illustrates deployment of a virtual edge configuration in an edge computing system operated among multiple edge nodes and multiple tenants. FIG. 18 illustrates various compute arrangements deploying containers in an edge computing system. FIG. 19 illustrates an example software distribution platform. FIG. 20 depict example components of various compute nodes, which may be used in edge computing system(s). FIGS. 21 and 22 depict example processes for practicing various aspects discussed herein.

### DETAILED DESCRIPTION

### 1. [RED] Article 3(3)(d), (e), (f) Solutions

The present disclosure is related to various aspects of the [RED]. [RED] Article 3 Requirements are not yet “activated”. This “activation” requires a Delegated Act and possibly an Implementing Act by the European Commission. The European Commission has created an Expert Group which is working towards the implementation of the sub-articles of [RED]. In particular, the present disclosure is relevant to [RED] Article 3(3)(d) (“Protection of the Network”), Article 3(3)(e) (“Privacy”), and Article 3(3)(f) (“Cybersecurity”). The articles are defined is as shown by Table 0.

TABLE 0
[RED] Article 3(3)(d), (e), (f)

3. Radio equipment within certain categories or classes shall be so constructed that
it complies with the following essential requirements: [. . .]
(d) radio equipment does not harm the network or its functioning nor misuse
network resources, thereby causing an unacceptable degradation of service;
(e) radio equipment incorporates safeguards to ensure that the personal data and
privacy of the user and of the subscriber are protected;
(f) radio equipment supports certain features ensuring protection from fraud.

[RED] Article 3 Requirements are not yet “activated”. This “activation” requires a Delegated Act and possibly an Implementing Act by the European Commission. The European Commission has created an Expert Group which is working towards the implementation of the subarticles of [RED] Article 3 such as those shown by Table 0.

The present disclosure solutions for all of the requirements outlined by the European Commission, and in particular, solutions to meet the requirements provided by the European Commission for [RED] Article 3(3)(d), (e), (f) on Cybersecurity, Privacy, and Protection of the Network. Previously, [RED] Article 3(3)(d), (e), (f) on the protection of the network, privacy and cybersecurity were not activated and no related requirements were defined under [RED]. Rather, manufacturers did choose a suitable level of protection themselves. This leads to a scattered variety of solutions across the market and unclear minimum requirements. Furthermore, for already activated [RED] Articles 3(1) and 3(2), [RED] related requirements were rather focusing on physically measureable requirements, including EMC protection, spectrum mask requirements, and/or the like. The key difference with [RED] Articles 3(3)(d), (e), (f) lies in the functional nature of these requirements, which cannot be verified by traditional measurement methods.

The present disclosure, defines solutions meeting the requirements of the European Commission as outlined in Annex II of [EGRE(09)09] and Annex II of [GROW.H.3]. In addition, the present disclosure provides Test Services for each of the requirements that will enable reproducible and binary (e.g, in the sense of pass/fail) verification of equipment as required by the European Commission. In order to maximize the flexibility of the manufacturer, the requirements may remain on a functional level, and the exact implementation remains the choice of the manufacturer. Still, in order to meet the requirement for reproducible and binary tests, the present disclosure introduces a “transcoding driver” that converts test services (as defined in a future ETSI Harmonized Standard) into the manufacturer's internal format. In these ways, equipment requirements are maintained on a functional level, leaving the full choice to the manufacturer to develop a specific technical implementation solution. Furthermore, the discussion herein defines a common set of test and verification services in an ETSI Harmonized Standard leading to reproducible and binary verification tests. The present disclosure also provides solutions ensuring that data flows that use connections to devices which are compliant to the new [RED] requirements. Due to this innovative approach, it is possible to maintain equipment requirements on a functional level, leaving the full choice to the manufacturer to develop a specific technical implementation solution; and define a common set of test and verification services in an ETSI Harmonised Standard leading to reproducible and binary verification tests.

Aspects of the present disclosure are applicable to any kind of wireless and/or radio equipment and/or components thereof, including, for example, processors/CPUs with (or capable of accessing) connectivity features, mobile devices (e.g., smartphones, feature phones, tablets, wearables (e.g., smart watches or the like), IoT devices, laptops, wireless equipment in vehicles, industrial automation equipment, etc.), network or infrastructure equipment (e.g., Macro/Micro/Femto/Pico Base Stations, repeaters, relay stations, WiFi access points, RSUs, RAN nodes, backbone equipment, routing equipment, any type of Information and Communications Technology (ICT) equipment, any type of Information Technology (IT) equipment, etc.), and systems/applications that are not classically part of a communications network (e.g., medical systems/applications (e.g., remote surgery, robotics, and/or the like), tactile internet systems/applications, satellite systems/applications, aviation systems/applications, vehicular communications systems/applications, autonomous driving systems/applications, industrial automation systems/applications, robotics systems/applications, and/or the like).

The various examples discussed herein are applicable to any kind of wireless devices, radio equipment, and/or components thereof, including, for example, processors/CPUs with (or capable of accessing) connectivity features, mobile devices (e.g, smartphones, feature phones, tablets, wearables (e.g, smart watches or the like), IoT devices, laptops, wireless equipment in vehicles such as autonomous or semi-autonomous vehicles, industrial automation equipment, and/or the like), network or infrastructure equipment (e.g, Macro/Micro/Femto/Pico base stations, repeaters, relay stations, WiFi access points, RSUs, RAN nodes, backbone equipment, routing equipment, any type of Information and Communications Technology (ICT) equipment, any type of Information Technology (IT) equipment, and/or the like), devices in conformance with one or more relevant standards (e.g., ETSI, 3GPP, [O-RAN], [MAMS], [ONAP], AECC, and/or the like), and systems/applications that are not classically part of a communications network (e.g, medical systems/applications (e.g, remote surgery, robotics, and/or the like), tactile internet systems/applications, satellite systems/applications, aviation systems/applications, vehicular communications systems/applications, autonomous driving systems/applications, industrial automation systems/applications, robotics systems/applications, and/or the like). The examples discussed herein introduce hierarchy levels for various types of equipment, for example, network equipment may have a higher hierarchy level as compared to UEs, or vice versa. Depending on the hierarchy level, some equipment may be treated preferably (less delay) or may have access to more information/data than other equipment.

Additionally or alternatively, the various examples discussed herein may involve the use of any suitable cryptographic mechanism(s)/algorithm(s) and/or any suitable confidentiality, integrity, availability, and/or privacy assurance mechanism(s)/algorithm(s) for data security, anonymization, pseudonymization, and/or the like, such as those discussed in ETSI TS 103 532 V1.2.1 (2021-05), ETSI TR 103 787-1 V1.1.1 (2021-05), ETSI TS 103 523-2 V1.1.1 (2021-02), ETSI TS 103 523-1 V1.1.1 (2020-12), ETSI TS 103 744 V1.1.1 (2020-12), ETSI TS 103 718 V1.1.1 (2020-10), ETSI TR 103 644 V1.2.1 (2020-09), ETSI TS 103 485 V1.1.1 (2020-08), ETSI TR 103 619 V1.1.1 (2020-07), ETSI EN 303 645 V2.1.1 (2020-06), ETSI TS 103 645 V2.1.2 (2020-06), ETSI TR 103 306 V1.4.1 (2020-03), ETSI TS 103 643 V1.1.1 (2020-01), and ETSI TR 103 618 V1.1.1 (2019-12), the contents of each of which are hereby incorporated by reference in their entireties.

### 1.1. Draft Harmonized Standards

The European Commission has issued a draft list of requirements to be met in future ETSI Standards (Harmonized European Norms) (see e.g., WORKING DOCUMENT on standardization request which will follow the delegated act under Articles 3(3)(d), (e) and (f) of the RED, EUROPEAN COMMISSION EXPERT GROUP ON RADIO EQUIPMENT (E03583), Ref: EG RE (09)09 (25 Feb. 2021), (“[EGRE(09)09]”), the contents of which are hereby incorporated by reference in its entirety. [EGRE(09)09] §§ 2.1, 2.2, and 2.3 describes requirements for harmonized standards produced for [RED] Article 3(3)(d), (e), and (f), respectively, which is cited in Table 1.

TABLE 1
[EGRE(09)09] § 2.1-2.3

2. Requirements for specific standards
2.1 Harmonised standards produced for Article 3(3)(d) of Directive 2014/53/EU
Harmonised standards produced for Article 3(3)(d) of Directive 2014/53/EU shall
describe solutions that ensure that equipment, as a minimum¹:
a) where appropriate, include security systems to monitor and control network
traffic based on predetermined security rules;
b) where appropriate, have a mechanism for limiting the rate of transmission of
outgoing data, in addition to what is usually necessary, in order to minimize
its use as a vector in attacks on other equipment or systems (denial of service
attack) and, in particular, include security systems to avoid repetitive
request messages;
c) where appropriate, implement mechanisms to validate the origin address of the
data packets, filtering packets with falsified origin addresses (antispoofing
filter), especially in the transmission of outgoing data;
d) where appropriate, is designed to mitigate the effects of ongoing denial of
service attacks, being resistant to an excessive number of authentication
attempts;
e) where appropriate, require regular updates of access rights;
f) protect stored, transmitted, received or otherwise processed access data
against accidental or unauthorised storage, processing, access or disclosure;
g) protect stored, transmitted, received or otherwise processed access data
against accidental or unauthorised destruction, loss or alteration or lack of
availability;
h) where appropriate, ensure that authorised persons, programs or machines are
able only to access the access data, to which their access rights refer;
i) where appropriate, make it possible to check which access data have been
accessed, used or otherwise processed, at what times and by whom;
j) where appropriate, can restore the availability and access to access data, in
a timely manner in the event of a physical or technical incident;
k) are secure by default and by design;
l) are provided with up-to-date software and hardware at the moment of placing
on the market that do not contain known vulnerabilities.
2.2 Harmonised standards produced for Article 3(3)(e) of Directive 2014/53/EU:
Harmonised standards produced for Article 3(3)(e) of Directive 2014/53/EU shall
describe solutions that ensure, as a minimum², that equipment:
a) where appropriate, protect stored, transmitted, received or otherwise
processed personal data against accidental or unauthorised storage,
processing, access or disclosure;
b) where appropriate, protect stored, transmitted, received or otherwise
processed personal data against accidental or unauthorised destruction, loss
or alteration or lack of availability;
c) where appropriate, ensure that authorised persons, programs or machines are
able only to access the personal data, to which their access rights refer;
d) where appropriate, record which personal data have been accessed, used or
otherwise processed, at what times and by whom;
e) are secure and implement data protection by default and by design;
f) without prejudice to users' changes are configured, by factory default,
restrictively rather than permissively. The selection of parameters for the
initial factory settings must be based on natively safe options;
g) are provided with up-to-date software and hardware at the moment of placing
on the market that do not contain publicly known vulnerabilities;
h) where appropriate, ensure the confidentiality of communications and the
related traffic data, avoiding being listened, tapped, stored or other kinds
of interception or surveillance of communications and the related traffic data
by persons other than users, where possible with the consent of the users
concerned. Technical storage which is necessary for the conveyance of a
communication without prejudice to the principle of confidentiality shall not
be prevented;
i) in case a non-legal nor contractual act applies, support the users' choice to
not disclose location data other than traffic data, relating to users or
subscribers of public communications networks or publicly available electronic
communications services or where applicable to give consent to processing.
They shall also support the users' or subscribers' possibility to withdraw
their consent for the processing of location data other than traffic data at
any time;
j) where consent of the users or subscribers has been obtained for the processing
of location data other than traffic data, support the user or subscriber
possibility, using a simple means and free of charge, of temporarily refusing
the processing of such data for each connection to the network or for each
transmission of a communication;
k) where appropriate, processing of location data other than traffic data in
accordance shall be restricted to persons acting under the authority of the
provider of the public communications network or publicly available
communications service or of the third party providing the value added service,
and must be restricted to what is necessary for the purposes of providing the
value added service;
l) when processing personal data, any warning information that is to be provided,
where such information is necessary to ensure that the compliance of the
products referred to in point 1.3 (a) of this Part with the corresponding
requirements is not compromised.
m) where appropriate, have automated and secure mechanisms for updating software
or firmware that employ adequate methods of encryption, authentication and
integrity verification;
n) where appropriate, have mechanisms to inform the user of software/firmware
changes implemented due to updates;
o) where appropriate, preserve the existing settings on the equipment after the
update procedure is finished. Changes in the configuration of the equipment
can be implemented in the update process only if they result in improvements
in the security of the device;
p) where appropriate, implement mechanisms to control access to remote management
and administration interfaces, in such a way as to limit access as to the
source;
q) where appropriate, implement simplified routines suitable for its installation
and configuration, avoiding potential unintended security flaws;
r) where appropriate, perform software or firmware integrity check during system
startup, being able to alert the user in cases of compromised integrity;
s) where appropriate, have a mechanism for monitoring unusual behaviours,
alerting the user or automatically restarting if suspicious behaviour is
detected. After restarting, the user must be offered the option of restoring
the equipment to factory defaults;
t) implement an activity logging tool related to, at a minimum, user
authentication, changing system settings and operating the system;
u) where appropriate, do not use credentials and initial passwords to access
device settings that are the same among all devices produced;
v) where appropriate, do not use initial passwords that are derived from
information easily obtained by methods of scanning network data traffic;
w) force, on the first use, the change of the initial password to access the
equipment configuration;
x) do not allow the use of blank passwords or weak passwords;
y) have defense mechanisms against exhaustive attempts at unauthorized access;
z) ensure that password recovery mechanisms are robust against attempts to steal
credentials;
aa) do not use credentials, passwords and cryptographic keys defined in the
software or firmware source code itself and which cannot be changed;
bb) protect passwords, access keys and credentials stored or transmitted using
appropriate methods;
cc) where appropriate, implement routines for closing inactive sessions;
dd) where appropriate, is devoid of any test tool or backdoor used in the product
development processes and unnecessary for its usual operation;
ee) where appropriate, is devoid of any form of undocumented communication,
including those for sending equipment usage profile information to
manufacturers or to third parties;
ff) where appropriate, is provided with disabled data communication services, when
they are expected not to be usually used;
gg) where appropriate, provide the user with the possibility of disabling
communication features and services not essential to the operation or
management of the equipment;
hh) where appropriate, allow users to easily delete their stored personal and
sensitive data, enabling the disposal or replacement of equipment without the
risk of exposing personal information;
ii) in the specific case of equipment which allows remote management, have a
mechanism for remote management and administration that employs appropriate
authentication and encryption methods;
jj) in the specific case of hand-held mobile telephones as defined in Commission
Delegated Regulation (EU) 2019/320 (smartphones), they shall permit the
deployment of solutions for the provision of services regulated by Regulation
(EU) No 910/2014. All their hardware components that would permit these
solutions and services to comply with the security requirements regulated by
the framework set by Regulation (EU) No 910/2014 shall be accessible by that
service.
kk) in the specific case of toy devices, they shall avoid unauthorised
communications or interactions to the user of the toy device.
2.3 Harmonised standards produced for Article 3(3)(f)
Harmonised standards produced for Article 3(3)(f) of Directive 2014/53/EU shall
describe solutions that ensure, as a minimum³, that equipment:
a) where appropriate, include security systems to monitor and control network
traffic based on predetermined security rules;
b) where appropriate, require regular updates of access rights;
c) can implement secure connection;
d) where appropriate, protect stored, transmitted, received or otherwise
processed financial or monetary data against accidental or unauthorised
storage, processing, access or disclosure;
e) where appropriate, protect stored, transmitted, received or otherwise
processed financial or monetary data against accidental or unauthorised
destruction, loss or alteration or lack of availability;
f) ensure that authorised persons, programs or machines are able only to access
the financial or monetary data, to which their access rights refer;
g) support identification of known dependencies and vulnerabilities;
h) record which financial or monetary data have been accessed, used or otherwise
processed, at what times and by whom;
i) make it possible to check which financial or monetary data have been accessed,
used or otherwise processed, at what times and by whom;
j) do not contain known vulnerabilities;
k) restore the availability and access to financial or monetary data, in a timely
manner in the event of a physical or technical incident;
l) are secure by default and by design as regards storage, processing, access or
disclosure of financial or monetary data;
m) are provided with up-to-date software and hardware at the moment of placing
on the market that do not contain publicly known vulnerabilities.
n) where appropriate, have a mechanism for monitoring unusual behaviours,
alerting the user or automatically restarting if suspicious behaviour is
detected. After restarting, the user must be offered the option of restoring
the equipment to factory defaults;
o) implement an activity logging tool related to, at a minimum, user
authentication, changing system settings and operating the system;
¹i.e. without prejudice of any additional requirement that the ESOs consider relevant for specific equipment.
²i.e. without prejudice of any additional requirement that the ESOs consider relevant for specific equipment.
³i.e. without prejudice of any additional requirement that the ESOs consider relevant for specific equipment.

The European Commission revised the list of requirements of [EGRE(09)09], and issued a draft list of these new requirements to be met in future harmonized standards (Harmonised European Norms) as GROW.H.3, Draft standardisation request to the European Telecommunications Standards Institute as regards radio equipment in support of Directive 2014/53/EU of the European Parliament and of the Council in conjunction with Commission Delegated Regulation (EU) 20211/XXX, EUROPEAN COMISSION, Brussels, Belgium (10 Jan. 2022), https://ec.europa.eu/docsroom/documents/48359 (“[GROW.H.3]”). The present disclosure provides solutions for the requirements outlined by the European Commission in [GROW.H.3]. Additionally, aspects of the present disclosure can be specified in future Harmonised Standards (e.g., to be developed when the related [RED] articles are activated). Relevant requirements introduced by the standardization request [GROW.H.3] are shown in Table 2.

TABLE 2
[GROW.H.3] Part B §§ 2.1-2.3

2. Requirements for specific standards
2.1. Harmonised standards in support of the essential requirement set out in Article
3(3)(d) of Directive 2014/53/EU as regards the radio equipment to which that
essential requirement becomes applicable pursuant to Delegated Regulation . . .
Harmonised standards shall contain technical requirements that ensure, as a
minimum¹, that those radio equipment, where applicable.
(a) include elements to monitor and control network traffic, including the
transmission of outgoing data;
(b) is designed to mitigate the effects of ongoing denial of service
attacks;
(c) implement appropriate authentication and access control mechanisms;
(d) are provided, on a risk basis, with up-to-date software and hardware
at the moment of placing on the market that do not contain publicly known
exploitable vulnerabilities as regards harm to the network or its functioning
or misuse of network resources;
(e) are provided with automated and secure mechanisms for updating software
or firmware that allow, when necessary, the mitigation of vulnerabilities
that if exploited may lead to the radio equipment harming the network or its
functioning or the misuse of network resources;
(f) protect the exposed attack surfaces and minimise the impact of
successful attacks
2.2. Harmonised standards in support of the essential requirement set out in Article
3(3)(e) of Directive 2014/53/EU as regards the radio equipment to which that
essential requirement becomes applicable pursuant to Delegated Regulation . . .
Harmonised standards shall contain technical requirements that ensure, as a
minimum², that those radio equipment, where applicable:
(a) protect stored, transmitted or otherwise processed personal data against
accidental or unauthorised storage, processing, access, disclosure,
unauthorised destruction, loss or alteration or lack of availability;
(b) implement appropriate authentication and access control mechanisms;
(c) are provided, on a risk basis, with up-to-date software and hardware at the
moment of placing on the market that do not contain publicly known exploitable
vulnerabilities as regards data protection and privacy;
(d) are provided with automated and secure mechanisms for updating software or
firmware that allow, when necessary, the mitigation vulnerabilities that if
exploited may lead to unauthorised storage, processing, access, disclosure,
unauthorised destruction, loss or alteration or lack of availability of
personal data;
(e) include functionalities to inform the user of changes that may affect data
protection and privacy;
(f) log the internal activity that can have an impact on data protection and
privacy;
(g) allow users to easily delete their stored personal data, enabling the disposal
or replacement of equipment without the risk of exposing personal information;
(h) protect the exposed attack surfaces and minimise the impact of successful
attacks.
2.2.1. In addition, harmonised standards shall contain technical requirements that
ensure, as a minimum³, that:
(i) equipment, including hand-held mobile telephones with features similar to
those of a computer in terms of capability to treat and store data
(smartphones), which shall be subject to the requirements laid down by the
framework established by Regulation (EU) No 910/2014, shall comply with the
essential requirement set out in Article 3(3)(e), which has been made
applicable to such radio equipment pursuant to Delegated Regulation XXX. The
specific technical elements, implementing the security requirements laid down
by the framework set by Regulation (EU) No 910/2014, shall provide open access
and allow the deployment of electronic identification systems and the
provision of services regulated under Regulation (EU) No 910/2014. Such
requirements shall be taken into consideration in order to ensure that the
compliance of such radio equipment with the essential requirement set out in
Article 3(3)(e) would not be adversely affected;
(ii) radio equipment designed or intended exclusively for childcare and radio
equipment covered by Directive 2009/48/EC, as defined in Article 1 of
Delegated Regulation . . ., to which the essential requirement set out in
Article 3(3)(e) becomes applicable pursuant to that Delegated Regulation,
shall avoid unauthorised communications or interactions to their user;
(iii) smart meters used for decentralised smart grids in the field of energy and
5G network equipment used by providers of public electronic communications
networks and publicly available electronic communications services within
the meaning of Directive (EU) 2018/1972 to which the essential requirement
set out in Article 3(3)(e) becomes applicable pursuant to Delegated
Regulation . . ., shall not undermine the high level of security requested at
national level.
2.3. Harmonised standards in support of the essential requirement set out in Article
3(3) (f) of Directive 2014/53/EU as regards the radio equipment to which that
essential requirement becomes applicable pursuant to Delegated Regulation . . .
Harmonised standards shall describe solutions that ensure, as a minimum⁴, that
those radio equipment, where applicable:
(a) protect stored, transmitted or otherwise processed financial or monetary data
against accidental or unauthorised storage, processing, access, disclosure,
unauthorised destruction, loss or alteration or lack of availability;
(b) implement appropriate authentication and access control mechanisms;
(c) are provided, on a risk basis, with up-to-date software and hardware at the
moment of placing on the market that do not contain publicly known exploitable
vulnerabilities as regards financial or monetary data;
(d) are provided with automated and secure mechanisms for updating software or
firmware that allow, when necessary, the mitigation vulnerabilities that if
exploited may lead to unauthorised storage, processing, access, disclosure,
unauthorised destruction, loss or alteration or lack of availability of
financial or monetary data;
(e) log the internal activity that can have an impact on financial or monetary
data;
(f) protect the exposed attack surfaces and minimise the impact of successful
attacks.
¹i.e. without prejudice of any additional requirement that the ESOs consider relevant for specific equipment.
²i.e. without prejudice of any additional requirement that the ESOs consider relevant for specific equipment.
³i.e. without prejudice of any additional requirement that the ESOs consider relevant for specific equipment.
⁴i.e. without prejudice of any additional requirement that the ESOs consider relevant for specific equipment.

### 1.1.1. Example Test Access Architecture and Interfaces

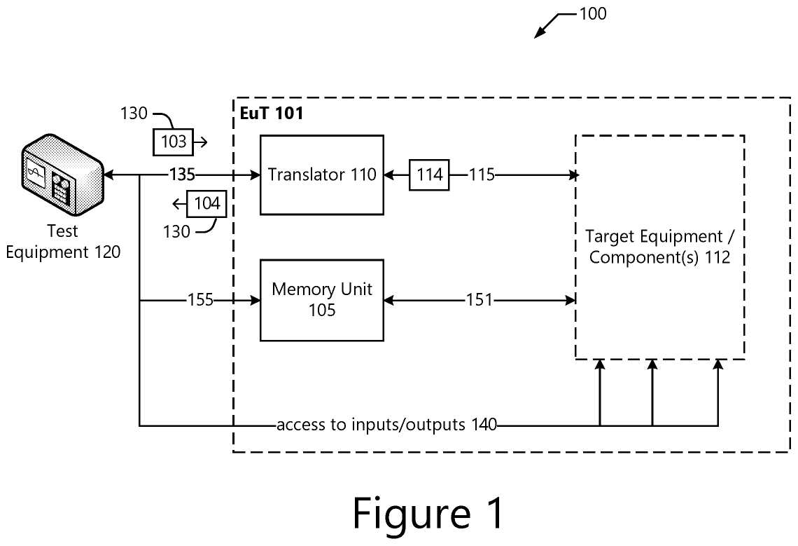

FIG. 1 depicts an example test access architecture 100 for testing, verifying, validating equipment under test (EuT) 101 for requirements related to [RED] Article 3(3)(d), (e), (f). Here, a test access interface 135 is introduced to radio equipment (RE)/EuT 101 (also referred to as radio equipment under test (REuT) 101), which allows testing equipment 120 to send test signaling/packets 130 to REuT 101 and components therein (e.g., equipment components 112). The equipment components 112 include any components and/or devices related to [RED] Article 3(3)(d), (e), (f) requirements.

As examples, the components 112 can include a radio platform or RAT circuitry of the RE 101, which may include programmable hardware elements, dedicated hardware elements, transceivers (TRx), antenna arrays or antenna elements, and/or other like components. Additionally or alternatively, the components 112 can include virtualized radio components and/or network functions. If one or more components 112 are virtualized, the virtualized components 112 should provide a same or similar results as non-virtualized versions of such components 112. Additional or alternative components 112 can be included in the REuT 101, such as any of those discussed herein, and tested according to the techniques and implementations discussed herein. The specific hardware and/or software implementation of the RE 101 may be based on the manufacturer's choice for fulfilling functional requirements outlined in various harmonised standard(s).

The testing equipment 120 can include any device, or collection of devices/components, capable of sending suitable test signals and/or data to the REuT 101. As examples, the testing equipment 120 can be a special-purpose testing device such as a digital and/or analog multimeter, LCR meter (measures inductance, capacitance, resistance), electrometer, electromagnetic field (EMF) meter, radiofrequency (RF) and/or microwave (μW) signal generator, multi-channel signal generator, frequency synthesizer (e.g., low noise RF/μW synthesizer and/or the like), digital pattern generator, pulse generator, signal injector, oscilloscope, frequency counter, test probe and/or RF/μW probe, signal tracer, automatic test equipment (ATE), radio test set, logic analyzer, spectrum analyzer, protocol analyzer, signal analyzer, vector signal analyzer (VSA), time-domain reflectometer, semiconductor curve tracer, test script processors, power meters, Q-meters, power meter, network analyzer, switching systems (e.g., including multiple test equipment such as any of those discussed herein), and/or other like electronic test equipment. In some implementations, the testing equipment 120 can include one or more user/client devices, servers, or other compute nodes such as any of those discussed herein. Additionally or alternatively, the testing equipment 120 can include virtualized or emulations of the aforementioned test devices/instruments. In some implementations, the testing equipment 120 can include network functions (NFs) and/or virtualized NFs that pass test signals to the test signals and/or data to the REuT 101, either directly or through one or more intermediary nodes (hops). In some implementations, the testing equipment 120 can include one or several modular electronic instrumentation platforms used for configuring automated electronic test and measurement systems. Such implementations may include connecting multiple test devices/instruments using one or more communication interfaces (or RATs), connecting multiple test devices/instruments in “rack-and-stack” or chassis-/mainframe-based system or enclosure, and/or using some other means of connecting multiple devices together. In some implementations, the testing equipment 120 and/or interconnected test equipment/instruments can be under the control of a custom software application running on a suitable compute node such as a client/user device, an NF, an application function (AF), one or more servers, a cloud computing service, and/or the like.

The RE 101 can be tested and/or validated using one or more qualification methods to validate that the [RED] Article 3(3)(d), (e), (f) requirements can be met. A feature list exposing [RED] Article 3(3)(d), (e), (f) capabilities is created. The qualification methods correspond to the feature list and they qualify features of a particular [RED] implementation against the feature list. In various implementations, the following qualification methods can be applied: demonstration, test (testing), analysis, inspection, and/or special qualification methods. Demonstration involves the operation of interfacing entities that rely on observable functional operation. Test (testing) involves the operation of interfacing entities using specialist test equipment (e.g., test equipment 120) to collect data for analysis (e.g., signaling/packets 130). Analysis involves the processing of data obtained from methods, such as reduction, interpretation, or extrapolation of test results. Inspection involves the examination of interfacing entities, documentation, and/or the like. Special qualification methods include one or more methods for the interfacing entities, such as specialist tools, techniques, procedures, facilities, and/or the like.

The test access interface 135 may be based on any suitable communication standard such as, for example, Ethernet, JTAG, a wireless test access (e.g., using any of the radio access technologies (RATs) discussed herein), and/or using some other access technology. In some implementations, the RE 101 may be placed in a test mode in which a transmitter chain is connected to a receiver chain in a loop-back mode in order to test the equipment/components 112 (see e.g., section of 6.5.6 of ETSI EN 303 641 V1.1.2 (2020-06) (“[EN303641]”)). The testing could also include the

The RE manufacturer provides a translation or transcoding entity (translator 110), which translates data/commands 130 conveyed by the test equipment 120 over the test access interface 135 into message(s) 114 to be conveyed over an internal RE internal interface 115 between the translator 110 and one or more components 112 of the REuT 101. The translator 110 may be an API, driver, middleware, firmware, and/or hardware component(s) enabling translation (e.g., transcoding) of test messages 130 into manufacturers internal representation 114, and vice versa. The translator 110 translates openly defined test access packets 130 into an internal format 114 for data/commands to be sent from external measurement (test) equipment 120 to the REuT 101, and translates data/commands from the internal format 114 to the test access packet format 130 for data/commands to be sent from REuT 101 to the measurement equipment 120.

The test access 100/135 is provided to external measurement (test) equipment 120 for the following purposes: (i) measurement equipment 120 provides data/commands to the REuT 101; (ii) measurement equipment 120 provides data/commands to REuT 101 using specific services, which are discussed in the present disclosure; and/or (iii) the REuT 101 provides data/commands to measurement equipment 120 for verifying and/or validating the execution of the data/commands provided by measurement equipment 120. The order that these operations are performed may be based on the specific test protocol and/or procedure being carried out, RE implementation, and/or based on any other criteria and/or parameters.

With the system 100 introduced in FIG. 1, the test equipment 120 can directly access the target EuT 101 and is able to verify the correct implementation of functional requirements of one or more equipment components 112 as outlined in the relevant to-be-published harmonized standards in support of [RED] Article 3(3)(d), (e), (f) via the access to inputs/outputs 140. The inputs/outputs 140 may include RF inputs/outputs and/or other inputs/outputs ports or interfaces (see e.g., IX 2056 of FIG. 20). Services to be used by the measurement equipment 120 at the test access inputs/outputs 140 of the EuT 101 and related test approaches are identified below for all requirements proposed by the European Commission in Annex II of [EGRE(09)09] and/or [GROW.H.3]. Furthermore, additional implementation solutions are provided infra in order to meet the Harmonized standards produced for [RED] Article 3(3) of Directive 2014/53/EU (see e.g., [EGRE(09)09] and/or [GROW.H.3]).

Described infra are specific mechanisms to be introduced to meet the requirements for [RED] Article 3(3)(d), (e), and (f) as specified in various paragraphs of [EGRE(09)09] and/or [GROW.H.3]. Additionally, the mechanisms described infra can be employed to meet requirements of [RED] Article 3 and/or any of the requirements outlined in [EGRE(09)09] and/or in addition to any of those listed.

### 1.1.1.1. Detection of Attacks

Following the [RED] requirement described previously under [GROW.H.3] § 2.1(d), various implementations include test access interfaces to wireless/wired equipment.

Referring back to FIG. 1, the test access 135 allows test equipment 120 to initiate known and/or new attacks (e.g., simulated/test) as attack vectors 103 onto the target equipment 101/components 112. The attack vectors 103 are provided to the translator 110 in the RE 101 via the test access interface 135. The translator 110 transfers the attack vectors 103 to the “interior” of the target device/components 112 via an internal interface 115. The internal interface 115 may be the same or similar as the an interconnect (IX) 2056 of FIG. 20, an mfg's internal interface/format, and/or the like. The translator 110 may be a device driver, middleware, firmware, or other software element used to interact with the test equipment/components 112.

Additionally, the translator 110 signals whether an attack was successful or unsuccessful using a test results indicator 104. The test results indicator 104 shows whether the attack 103 was success or unsuccessful. The attack 103 is considered unsuccessful if the target equipment 112 detects the attack 103 and is able to initiate countermeasures such as any of those discussed herein. The attack 103 is considered successful if the target equipment 112 is unable to detect the attack 103 during a predefined period of time and/or is unable to timely initiate suitable countermeasures. An example of a possible attack 103 can relate to [GROW.H.3] requirements 2.3(a), 2.3(b), and/or 2.1(b) (see Table 2 supra). Additionally or alternatively, the attack vectors 103 can be used to verify that the components/equipment 112 can protect the exposed attack surfaces and minimise the impact of successful attacks per [GROW.H.3] requirements 2.1(f), 2.2(h), and 2.2(f).

### 1.1.1.2. Internal History Tracking Module

Based on [GROW.H.3] requirement 2.2(f) (“log the internal activity that can have an impact on data protection and privacy”), some implementations include an internal memory entity that stores history data on exchanges with external equipment and is only accessible through a highly protect access mode available to authorized personnel only.

Here, the test access architecture 100 in FIG. 1 can include test access interface 155 between access equipment 120 and target equipment/components 112 for verifying information of a memory unit 105 to identify potential attacks. In FIG. 1, a special access interface 155 is introduced for access to a memory unit 105 that buffers history data related to exchanges with external entities. The test access equipment 120 accesses the memory unit 105 via the special access interface 155. Additionally, the memory unit 105 interacts with the target equipment/components 112 via an internal interface 151, which may be the same or similar as the internal interface 115.

The memory unit 105 is specially protected memory circuitry (or tamper-resistant circuitry) that buffers history data related to exchanges with external entities, observed attacks, etc. In some implementations, the memory unit 105 may include some or all of a write-only memory of the RE 101. Additionally or alternatively, the memory unit 105 may be a trusted platform module (TPM), trusted execution environment (see e.g., TEE 2090 of FIG. 20), one or more secure enclaves (see e.g., TEE 2090 of FIG. 20), and/or some other shielded location or protected memory/device. Additionally or alternatively, the memory unit 105 can include one or more memory devices such as any of those discussed infra with respect to FIG. 20. The special access interface 155 may be the same or different interface as the test access interface 135.

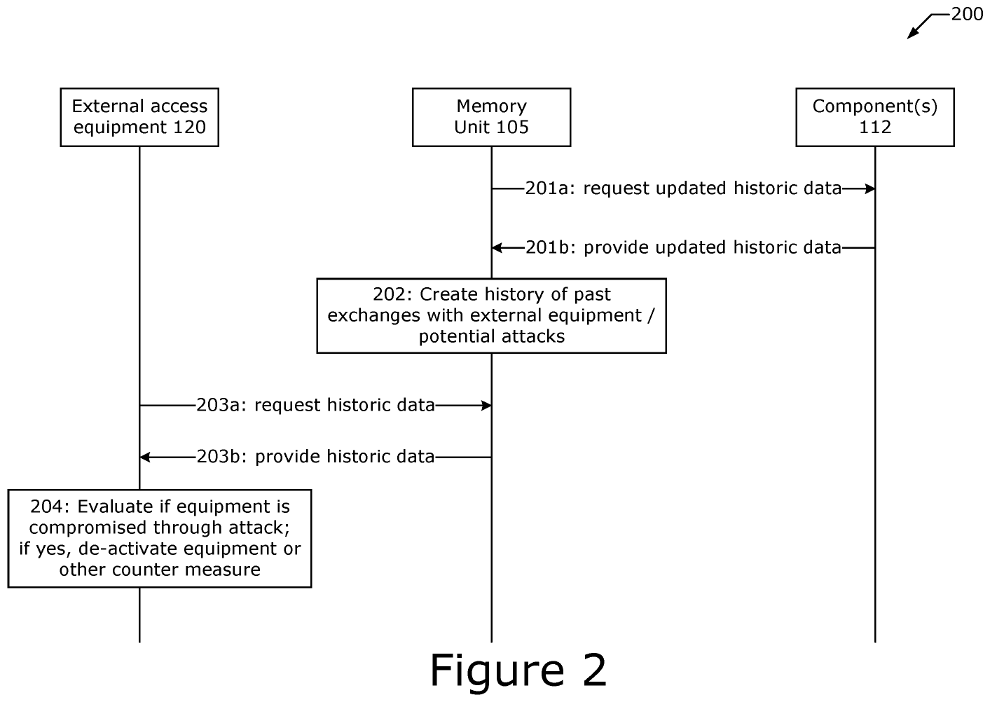

FIG. 2 shows a signaling procedure 200 for special access to the equipment/components 112 for verifying information of the memory unit 105 to identify potential attacks. In procedure 200, the memory unit 105 requests updated historic (attack-related) data from the target component 112 (201a), and the target component 112 provides the updated historic (attack-related) data to the memory unit 105 (201b). The memory unit 105 generates a suitable data structure including a history of past exchanges with external equipment/potential attacks (202). Operations 201a, 201b, and 202 may be performed on a periodic basis or in response to detection of some specified/configured event.

At some point, the access equipment 120 requests historic (attack-related) data from the memory unit 105 via the special access 155 (203a), and the memory unit 105 provides the historic (attack-related) data to the access equipment 120 via the special access 155 (203b). The access equipment 120 evaluates whether the target equipment 112 is compromised through an attack. If the access equipment 120 determines that an attack did take place, the access equipment 120 (initiates) de-activation of the equipment 112 (or RE 101), or takes one or more other counter measures.

In case that that the target equipment 112 is possibly compromised, one or multiple of the following counter measures may be taken: de-activate equipment 112 and/or 101; reject any connection request; reboot equipment 112 and/or 101; reset equipment 112 and/or 101 to factory setting or other “safe mode” of operation; re-install firmware and/or other software elements; and/or disconnect the equipment 112 and/or 101 from any peer equipment that is identified as possible source of an attack (following the indications of the Memory Unit 105).

1.1.2. [EGRE(09)09] § 2.1(a), [EGRE(09)09] § 2.3(a), [GROW.H.3] § 2.1(a): Elements to Monitor and Control Network Traffic

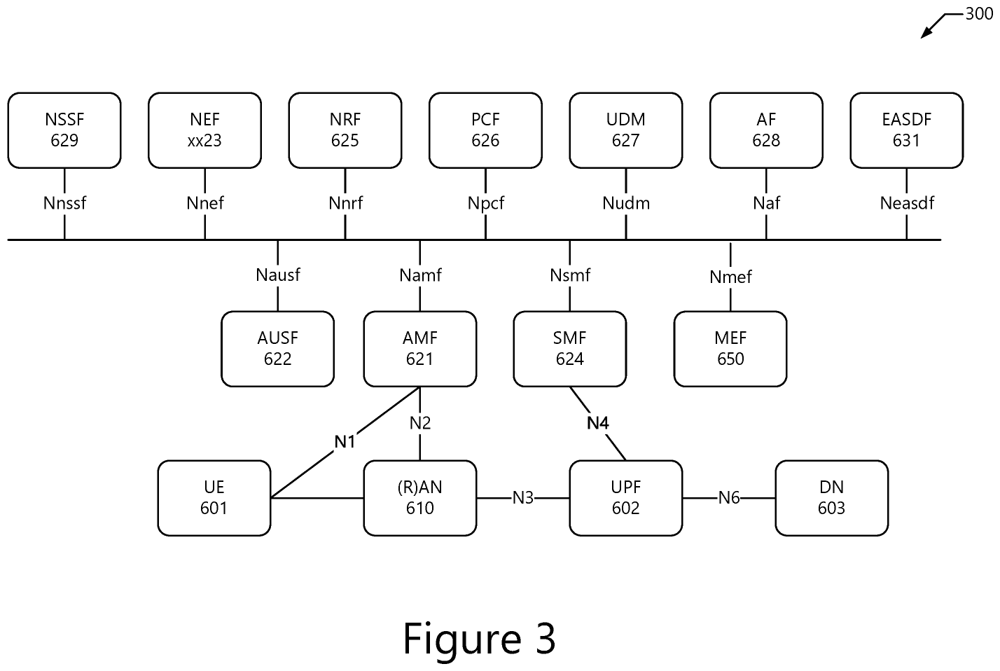

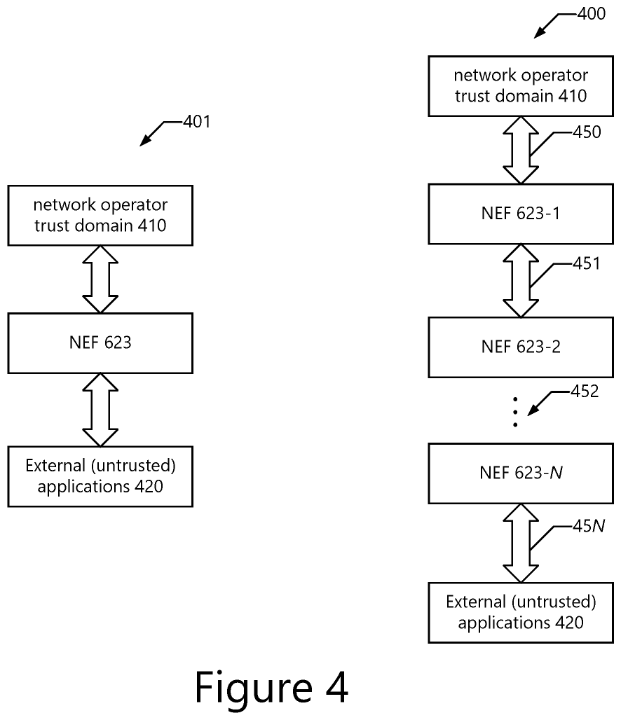

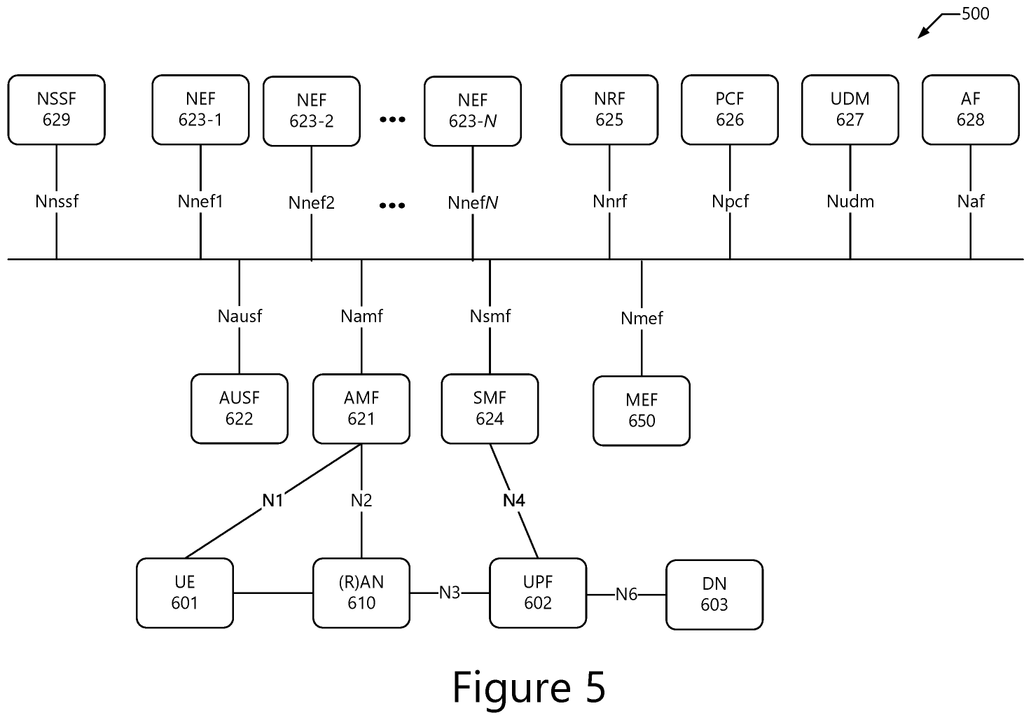

FIG. 3 depicts a 3GPP 5G service based architecture 300 (see e.g, [TS23501], McGrath, Understanding 5G Service-Based Architecture, KEYSIGHT BLOGS (2020-06-30), https://blogs.keysight.com/blogs/inds.entry.html/2020/06/30/understanding_the5g-yfi6.html). The functions in FIG. 3 are explained in as follows: The authentication server function (AUSF) 1022 authenticates UEs and stores authentication keys. The access and mobility management function (AMF) 1021 manages UE registration and authentication (via the AUSF 1022) and identification (via unified data management) and mobility, and also terminates non-access stratum (NAS) signaling. The network exposure function (NEF) 1023 exposes capabilities and events, stores the received information as structured data, and exposes data to other NFs. The network repository function (NRF) 1025 provides service discovery between individual NFs, maintaining profiles of NFs and their functions. The network slice selection function (NSSF) 1029 selects the set of network slice instances serving the UE and determines which AMF to use. The policy control function (PCF) 1026 provides policy rules to control plane functions. The session management function (SMF) 1024 establishes and manages sessions. It also selects and controls the user plane function (UPF) and handles paging. The unified data management (UDM) 1027 stores subscriber data and profiles. It generates the authentication vector. The User Plane Function (UPF) 1002 is responsible for packet handling and forwarding, mobility anchor, and IP anchor towards the internet. The UPF 1002 performs quality of service (QoS) enforcement. Application Function (AF) 1028 interacts with the 3GPP core network (e.g., CN 920) in order to provide various services. Other aspects of these NFs and other NFs in the 5G system are discussed infra with respect to FIGS. 10 and 11.

The 5G service based architecture 300 also includes a Monitoring and Enforcement Function (MEF) 1050 and a related Nmef Interface/Reference Point. Here, instead of adding the MEF 1050 into the upper Service Architecture, there are several alternative solutions to be considered as well: (i) The functionality of MEF 1050 may be included into another (existing/newly introduced) function of the Service Architecture; (ii) the functionality of NEF may be added in a UE 1001, RAN 1010, IPF (or UPF 1002), and/or DN 1003; and/or (iii) the functionality of NEF may be added in an entity external of the service architecture. In some examples, the MEF 1050 may be operated in or by a RAN Intelligent Controller (RIC) such as those discussed by relevant [O-RAN] standards/specifications, and/or as a functional element in a NG-RAN architecture as defined by relevant 3GPP standards/specifications.

Also, the 5G service based architecture of FIG. 3 is based on 3GPP Rel. 15 to 3GPP Rel. 19; however, aspects of the present document can be applied to later generations such as 3GPP Rel. 20 (possibly labeled “6G”) and later. Also, the proposed approach can be applied to technologies beyond the 3GPP scope, such as [IEEE802] technology including WiFi (e.g., [IEEE80211] and variants thereof such as IEEE 802.11a/b/g/n/ac/ad/ax/ay, and so forth), Bluetooth, WiGig, and/or the like, such as any of the network access technologies discussed herein.

Tasks and/or functions of the MEF 1050 include the following: monitor network traffic based on predetermined security rules; assess and categorize network traffic based on predetermined security rules (e.g, no security issues, low security requirements, medium security requirements, high security requirements, and/or the like); detect any security threats, breaches, and/or the like; control network traffic based on predetermined security rules, for example, route security sensitive traffic through trusted routes, ensure suitable protection of security sensitive payload (e.g, through suitable encryption), and/or address any detected security issues/breaches, for example terminating the transmission of security sensitive data in case of detection of such issues/breaches; and/or the other functions of the 5G service architecture interact with MEF 1050 in order to validate any transmission strategy (e.g, level of encryption, routing strategy, validation of recipients, and/or the like).

Furthermore, today's 5G networks are designed to have a “network operator trust domain” and external applications which are outside of this trust domain. For instance, “[t]he 5G Network Exposure Function (NEF) facilitates secure, robust, developer-friendly access to exposed network services and capabilities. This access is provided by a set of northbound RESTful (or web-style) APIs from the network domain to both internal (e.g., within the network operator's trust domain) and external applications” (D'Souza, Network Exposure: Opening up 5G networks to partners, OPENET BLOG (21 May 2020), https://www.openet.com/blog/5g-networks/). This principle is extended to include a “network operator trust domain” and external applications which are outside of this trust domain. Under the new Cybersecurity and Privacy requirements framework, a finer grained differentiation may be needed. An example of this principle is illustrated by FIG. 4.

FIG. 4 depicts a hierarchical Network Exposure Function (NEF) framework 400. As shown by FIG. 4, the existing approach 401 involves an NEF 1023 moderating access to the network operator trust domain 410 by external (untrusted) applications 420. Here, “external” refers to applications being outside of the 3GPP network or network operator's domain. In the hierarchical NEF framework 400, 1-N NEFs 1023 (where N is a number) are introduced (labeled at NEF 1023-1, 1023-2, . . . 1023-N in FIG. 4), where individual NEFs 1023 provide different levels of trust (or individual trust domains). This includes a fully trusted domain 450 with full access to all data, which is disposed between the network operator trust domain 410 and a first NEF (NEF 1023-1); a Level 1 trusted domain 451 with partial access to privacy and security related data, which is disposed between NEF 1023-1 and a second NEF (NEF 1023-2); Levels 2, . . . , N−1 trusted domain(s) 452 with access to privacy and security related data, which is reduced with each level (these levels are disposed between multiple additional NEFs (e.g, NEF 1023-2 through NEF 1023-(N−1)); and Level N trusted domain 45N with very limited access (or no access) to privacy and security related data (e.g., NEF 1023-N).

In this example, the trust domains 450-45N cover entities that are protected by adequate network domain security. The entities and interfaces within the trust domain 450-45N may all be within one operator's control, or some may be controlled by a trusted organization partner(s) that have a trust relationship with the operator (e.g, another operator, a 3rd party, or the like). The same or similar approach can be applied to the service capability exposure functions (SCEF) in the EPC 922. An example service-based architecture with the hierarchical NEFs is shown by FIG. 5.

FIG. 5 depicts the 5G service based architecture 500 incorporating the hierarchical NEF framework 400 of FIG. 4, and including related Nnef Interface(s)/Reference Point(s). Here, each NEF 1023 includes a corresponding service-based interface. For example, Nnef1 is a service-based interface exhibited by the NEF 1023-1, Nnef2 is a service-based interface exhibited by the NEF 1023-2, and so forth to NnefN, which is a service-based interface exhibited by the NEF 1023-N.

Tasks and/or functions of the hierarchical NEFs (e.g, NEF 1023-1, . . . , NEF 1023-N) include differentiating availability of privacy and/or security related information among multiple levels; granting access to controlled and/or a limited set of available data to (external) functions; and/or defining a set of information elements for each of the hierarchy levels.

The sensitivity of the various information elements will be determined through a suitable risk assessment. In some implementations, the information available on hierarchy level of a particular NEF 1023 relates to a corresponding risk level, where each of the different risk levels are identified through suitable risk analysis. For example, a first NEF 1023-1 may correspond to a first risk level “1”, a second NEF 1023-1 may correspond to a second risk level “2”, and so forth to NEF 1023-N may correspond to an Nth risk level “N”.

Examples for the highest protection level “NEF 1023-1” can include personal data, sensitive data, and/or confidential data such as, for example, social security number, individual codes (e.g, vaccination ID number, medical test results, and/or the like), passwords for bank accounts, bank account numbers, driver license information (e.g., driver's license number, driver license expiration date, and the like), biometric identification related data (e.g, digital fingerprint, eye scan, voice print, and/or the like), user name and password for online systems such as official voting systems, tax declaration, and/or the like.

Examples for the second highest protection level “NEF 1023-2” can include personal data, sensitive data, and/or confidential data such as, for example, credit number for payment, user IDs for bank applications and similar sensitive applications, historic data (e.g, movement pattern, favorite or frequently visited addresses (e.g, home address), and/or the like), and the like.

Examples for the lowest protection level “NEF 1023-N” can include anonymized or pseudonymized personal data, sensitive data, and/or confidential data such as, for example, anonymized or pseudonymized user data, unique generic codes (e.g., authentication codes used in two step authentication (2FA) processes), unique generic login codes, anonymized IDs, and/or the like.

The data may be anonymized or pseudonymized using any number of data anonymization or pseudonymization techniques including, for example, data encryption, substitution, shuffling, number and date variance, and nulling out specific fields or data sets. Data encryption is an anonymization or pseudonymization technique that replaces personal/sensitive/confidential data with encrypted data. In some examples, anonymization or pseudonymization may take place through an ID provided by the privacy-related component. Any action which requires the linkage of data or dataset to a specific person or entity takes place inside the privacy-related component. Anonymization is a type of information sanitization technique that removes PII and/or sensitive data from data or datasets so that the person described or indicated by the data/datasets remain anonymous Pseudonymization is a data management and de-identification procedure by which PII and/or sensitive data within information objects (e.g, fields and/or records, data elements, documents, and/or the like) is/are replaced by one or more artificial identifiers, or pseudonyms. In most pseudonymization mechanisms, a single pseudonym is provided for each replaced data item or a collection of replaced data items, which makes the data less identifiable while remaining suitable for data analysis and data processing. Although “anonymization” and “pseudonymization” refer to different concepts, these terms may be used interchangeably throughout the present disclosure.

In addition to the architectural changes to the 3GPP system, and similar changes being used for any other radio equipment, the test services of Table 1.1.1-1 can be used to validate the new architectural changes.

TABLE 1.1.1-1
Class ITestServices
This class describes a test access interface supporting the verification of the correct implementation of FUNCTIONAL
requirements related to RED Articles 3(3)(d/e/f).
OPERATIONS

| | | | |
|---|---|---|---|
| RequestNWTrafficMonitoring Data | Input type: | Return type: | Value type: |
| | AuthorizationCode | Data | Public |

This operation is related to the request of providing internal NW Traffic Monitoring data which is then verified to meet
all applicable requirements. An AuthorizationCode is required to access the test access (interface).

| | | | |
|---|---|---|---|
| ControlNWTraffic | Input type: | Return type: | Value type: |
| | AuthorizationCode, | INTEGER | Public |
| | NWTrafficControlCommand | | |

This operation is related to the control of NW Traffic which is then verified (at the outputs of the implementation
component relating to RED Articles 3(3)(d/e/f)) to meet all applicable requirements. An AuthorizationCode is required
to access the test access (interface).

### 1.1.3. [EGRE(09)09] § 2.1(b)

In addition to the items introduced in section 1.1.2 supra, the tasks and/or functionality of the MEF 1050 include the following aspects: the MEF 1050 provides additional support to control network traffic based on predetermined security rules. For example, the MEF 1050 addresses any detected security issues/breaches, for example, terminating the transmission of security sensitive data in case of detection of such issues/breaches, reduce transmission rate through interaction with suitable functions of the 5G Service Architecture (in particular if a denial of service attack or a distributed denial of service attack is detected), and/or the like. The MEF 1050 detects issues related to untrusted components, through suitable observation of inputs and outputs and the detection of anomalies. In case of a detected issue, disconnect identified untrusted component from network access.

In addition to the architectural changes to the 3GPP system, and similar changes being used for any other radio equipment, the test services in Table 1.1.2-1 are introduced to validate the new architectural changes.

TABLE 1.1.2-1
Class ITestServices
This class describes a test access interface supporting the verification of the correct implementation of
FUNCTIONAL requirements related to RED Articles 3(3)(d/e/f).
OPERATIONS

| | | | |
|---|---|---|---|
| LimitTransmissionRate | Input type: | Return type: | Value type: |
| | AuthorizationCode, | INTEGER | public |
| | MaximumTransmissionRate | | |

This operation is related to the limitation of the transmission rate of outgoing data which is then verified to meet all
applicable requirements. An AuthorizationCode is required to access the test access (interface).

### 1.1.4. [EGRE(09)09] § 2.1(c)

In addition to the items introduced in any one or more of sections 1.1.2-1.1.3 supra, the tasks and/or functionality of the MEF 1050 include the following aspects: the MEF 1050 provides additional support to control network traffic based on predetermined security rules. For example, the MEF 1050 validates origin addresses of data packets, for example, through maintaining a “rejection list” of “bad” origin (IP, MAC or other) addresses. In case that such a origin address (found on a “rejection list”) is identified, the corresponding packet is either discarded or tagged to originate from a non-trusted source. In case that a malicious new source (previously unknown) is detected, it's (IP, MAC or other) address is added to the “rejection list”.

### 1.1.5. [EGRE(09)09] § 2.1(d) and [GROW.H.3] § 2.1(b)

In addition to the items introduced in any one or more of sections 1.1.2-1.1.4 supra, the tasks and/or functionality of the MEF 1050 include the following aspects: the MEF 1050 provides additional support to control network traffic based on predetermined security rules, for example, detect substantial level of access to a specific target network address (e.g, IP address and/or the like) that is considered to hint to a (distributed) denial of service attack.

In case of detection of such an attack, implement one or multiple of the following counter-measures (optionally in combination with other counter-measures): Increase network latency randomly across the various requests in order to reduce the number of simultaneously arriving requests; Randomly drop a certain amount of packets such that the level of requests stays on a manageable level for the target network address (e.g, IP address and/or the like); Hold randomly selected packets back for a limited period of time in order to reduce the number of simultaneously arriving requests; and/or Identify source (e.g, network address (e.g, IP address and/or the like)) of massively issuing requests to a specific target network address (e.g, IP address and/or the like) and implement counter measures (e.g, exclude source fromnetwork access for a limited period of time, limit network capacity for identified source, and/or the like).

### 1.1.6. [EGRE(09)09] § 2.1(e) and [EGRE(09)09] § 2.3(b)

In addition to the items introduced in any one or more of sections 1.1.2-1.1.5 supra, the tasks and/or functionality of the MEF 1050 include the following aspects: the MEF 1050 provides additional support to control network traffic based on predetermined security rules. For example, the MEF 1050 observes the enforcement of access rights, reject any unauthorized access; attaches a limited “life-time” (or time-to-live (TTL)) to any access right status, after expiration of the related “life time” (or TTL), the access rights are withdrawn. Any upcoming expiration of access rights is being observed and corresponding users are warned ahead of time.

### 1.1.7. [EGRE(09)09] § 2.1(j)

In addition to the items introduced in any one or more of sections 1.1.2-1.1.6 supra, the tasks and/or functionality of the MEF 1050 include the following aspects: the MEF 1050 provides additional support to control network traffic based on predetermined security rules. For example, in case of a detected physical or technical incident, the MEF 1050 triggers (automatically, manually, and/or the like) the restoration of the availability and access to data. Continuously backup all data required to enable a timely restoration of the availability and access to data in case of a physical or technical incident.

### 1.1.8. [EGRE(09)09] § 2.1(k) and [EGRE(09)09] § 2.3(l)

In addition to the items introduced in any one or more of sections 1.1.2-1.1.7 supra, the tasks and/or functionality of the MEF 1050 include the following aspects: the MEF 1050 provides additional support to control network traffic based on predetermined security rules. For example, the MEF 1050 continuously monitors whether any indication is found that the system is violating the principle of being “secure by default and by design as regards protection of the network”. In case that a violation is detected, implement counter measures, e.g. take concerned nodes (those violating the principles) off the network, limit their respective capacity, and/or the like.

1.1.9. [EGRE(09)09] § 2.1(l), [EGRE(09)09] § 2.2(g), [EGRE(09)09] § 2.3(m), [GROW.H.3] § 2.1(d), [GROW.H.3] § 2.2(c), and [GROW.H.3] § 2.3(c)

In addition to the items introduced in any one or more of sections 1.1.2-1.1.8 supra, the tasks and/or functionality of the MEF 1050 include the following aspects: the MEF 1050 provides additional support to control network traffic based on predetermined security rules. For example, a database on known (HW and/or SW) vulnerabilities if maintained by the MEF, new vulnerabilities are added to the list as they are being detected.

In case that any action is detected that hints to a security issue due to a known vulnerability, then suitable counter-measures are taken, for example corresponding data packages are tagged correspondingly (“dangerous”, “relating to vulnerability”, and/or the like), or alternatively such critical data packets are being discarded.

1.1.10. [EGRE(09)09] § 2.2(m), [GROW.H.3] § 2.1(e), [GROW.H.3] § 2.2(d), [GROW.H.3] § 2.3(d)

In addition to the items introduced in any one or more of sections 1.1.2-1.1.9 supra, the tasks and/or functionality of the MEF 1050 include the following aspects: the MEF 1050 provides additional support to control network traffic based on predetermined security rules. For example, the MEF 1050 checks whether any new SW and/or HW updates meet requirements of suitable encryption, authentication and integrity verification. In case that minimum requirements are not met, a corresponding warning is issued to other functions of the 5G Service Architecture, exchange of security relevant messages may be limited/forbidden in order to avoid any expose to potential vulnerabilities.

### 1.1.11. [EGRE(09)09] § 2.2(u)

In addition to the items introduced in any one or more of sections 1.1.2-1.1.10 supra, the tasks and/or functionality of the MEF 1050 include the following aspects: the MEF 1050 provides additional support to control network traffic based on predetermined security rules. For example, the MEF 1050 checks whether any new SW and/or HW updates meet requirements of suitable encryption, authentication and integrity verification. In case that minimum requirements are not met, a corresponding warning is issued to other functions of the 5G Service Architecture, exchange of security relevant messages may be limited/forbidden in order to avoid any expose to potential vulnerabilities.

### 1.1.12. [EGRE(09)09] § 2.2(v)

In addition to the items introduced in any one or more of sections 1.1.2-1.1.11 supra, the tasks and/or functionality of the MEF 1050 include the following aspects: the MEF 1050 provides additional support to control network traffic based on predetermined security rules. For example, the MEF 1050 identifies whether any network entities are accessible by identical (manufacturer) passwords. If yes, the MEF 1050 informs corresponding owners/operators and take related entities off the network. Scan for traffic that serves the objective to “sniff” passwords. If detected, identify the corresponding source and start counter measures, e.g. take source off the network, inform concerned authorities, and/or the like.

### 1.1.13. [EGRE(09)09] § 2.2(w)

In addition to the items introduced in any one or more of sections 1.1.2-1.1.12 supra, the tasks and/or functionality of the MEF 1050 include the following aspects: the MEF 1050 provides additional support to control network traffic based on predetermined security rules. For example, the MEF 1050 checks whether a suitable password policy is implemented, e.g. default passwords are forced to be changed, minimum password requirements are enforced (e.g. use a minimum number of capital letters, numerical values, special characters, and/or the like). If the password policy is not met, the processing of security critical information may be put on hold until the issue is resolved.

### 1.1.14. [EGRE(09)09] § 2.2(x)

In addition to the items introduced in any one or more of sections 1.1.2-1.1.13 supra, the tasks and/or functionality of the MEF 1050 include the following aspects: the MEF 1050 provides additional support to control network traffic based on predetermined security rules. For example, the MEF 1050 checks whether a suitable password policy is implemented, e.g. default passwords are forced to be changed, minimum password requirements are enforced (e.g. use a minimum number of capital letters, numerical values, special characters, and/or the like). If the password policy is not met, the processing of security critical information may be put on hold until the issue is resolved.

### 1.1.15. [EGRE(09)09] § 2.2(y)

In addition to the items introduced in any one or more of sections 1.1.2-1.1.14 supra, the tasks and/or functionality of the MEF 1050 include the following aspects: the MEF 1050 provides additional support to control network traffic based on predetermined security rules. For example, the MEF 1050 checks whether an excessive number of failed accesses is observed. If yes, a corresponding warning is issued to the other functions of the 5G service architecture.

### 1.1.16. [EGRE(09)09] § 2.2(z)

In addition to the items introduced in any one or more of sections 1.1.2-1.1.15 supra, the tasks and/or functionality of the MEF 1050 include the following aspects: the MEF 1050 provides additional support to control network traffic based on predetermined security rules. For example, the MEF 1050 observes whether any attempts are discovered for stealing credentials, passwords, and/or the like. If detected, identify the corresponding source and start counter measures, e.g. take source off the network, inform concerned authorities, and/or the like.

1.1.17. [EGRE(09)09] § 2.2(aa)

In addition to the items introduced in any one or more of sections 1.1.2-1.1.16 supra, the tasks and/or functionality of the MEF 1050 include the following aspects: the MEF 1050 provides additional support to control network traffic based on predetermined security rules. For example, the MEF 1050 performs automatic code scan to identify whether credentials, passwords and cryptographic keys are defined in the software or firmware source code itself and which cannot be changed. If detected, the MEF 1050 takes corresponding entities off the network.

1.1.18. [EGRE(09)09] § 2.2(bb)

In addition to the items introduced in any one or more of sections 1.1.2-1.1.17 supra, the tasks and/or functionality of the MEF 1050 include the following aspects: the MEF 1050 provides additional support to control network traffic based on predetermined security rules. For example, the MEF 1050 cyclically verifies protection mechanisms for passwords, access keys and credentials for storage, delivery, and/or the like. In case of detection of a weakness, take corresponding entities off the network, inform the owner/operator, and/or the like.

1.1.19. [EGRE(09)09] § 2.1(f)-(g), [EGRE(09)09] § 2.1(a)-(b), and [GROW.H.3] § 2.2(a)

In addition to the items introduced in any one or more of sections 1.1.2-1.1.18 supra, the tasks and/or functionality of the MEF 1050 include the following aspects: the MEF 1050 provides additional support to control network traffic based on predetermined security rules. For example, the MEF 1050 cyclically verifies protection mechanisms for storage of processed access data, disclosure of processed access data, storage of processed personal data, disclosure of processed personal data, and/or the like. In case of detection of a weakness, take corresponding entities off the network, inform the owner/operator, and/or the like.

### 1.1.20. [EGRE(09)09] § 2.2(m) and [GROW.H.3] § 2.1(e)

In addition to the items introduced in any one or more of sections 1.1.2-1.1.19 supra, the tasks and/or functionality of the MEF 1050 include the following aspects: the MEF 1050 provides additional support to control network traffic based on predetermined security rules. For example, the MEF 1050 monitors the process of updating software or firmware that employ adequate methods of encryption, authentication and integrity verification. The process is verified to be secure. In case of detection of a weakness, take corresponding entities off the network, inform the owner/operator, and/or the like.

### 1.2. Trust Mechanisms

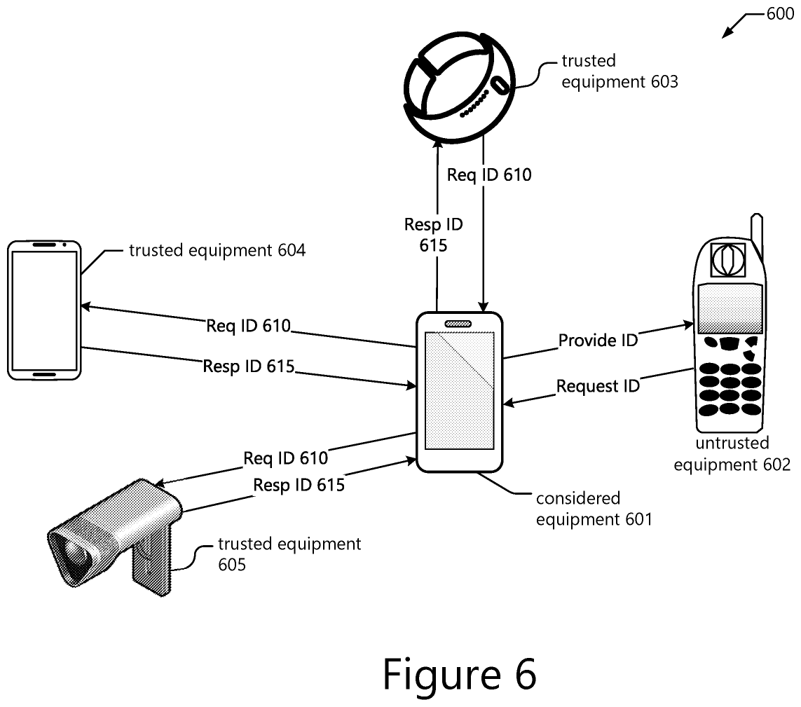

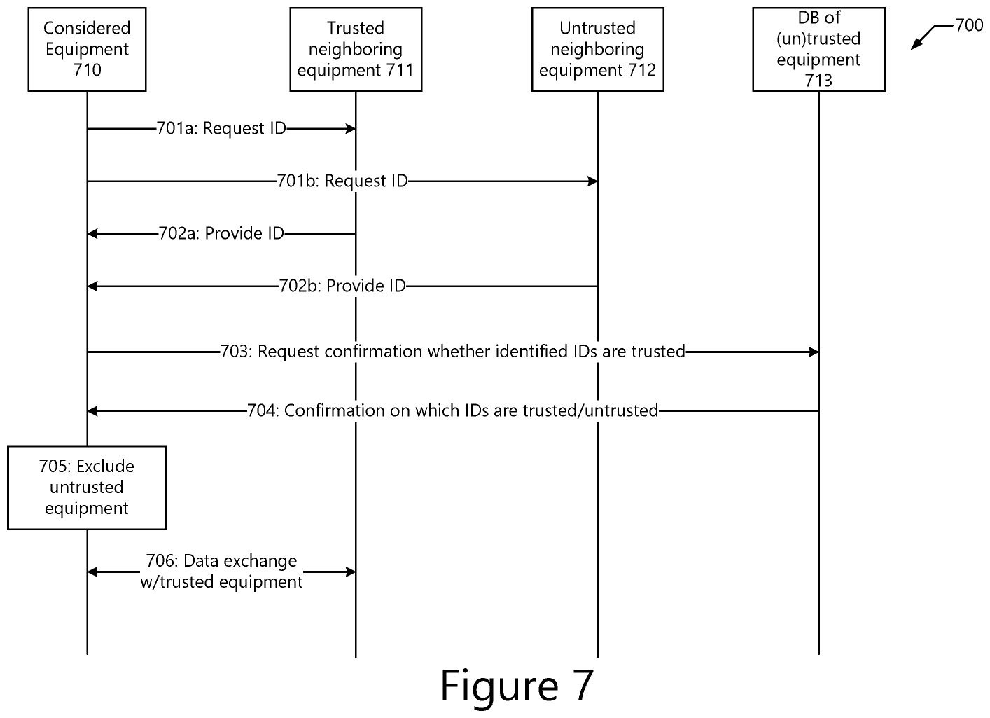

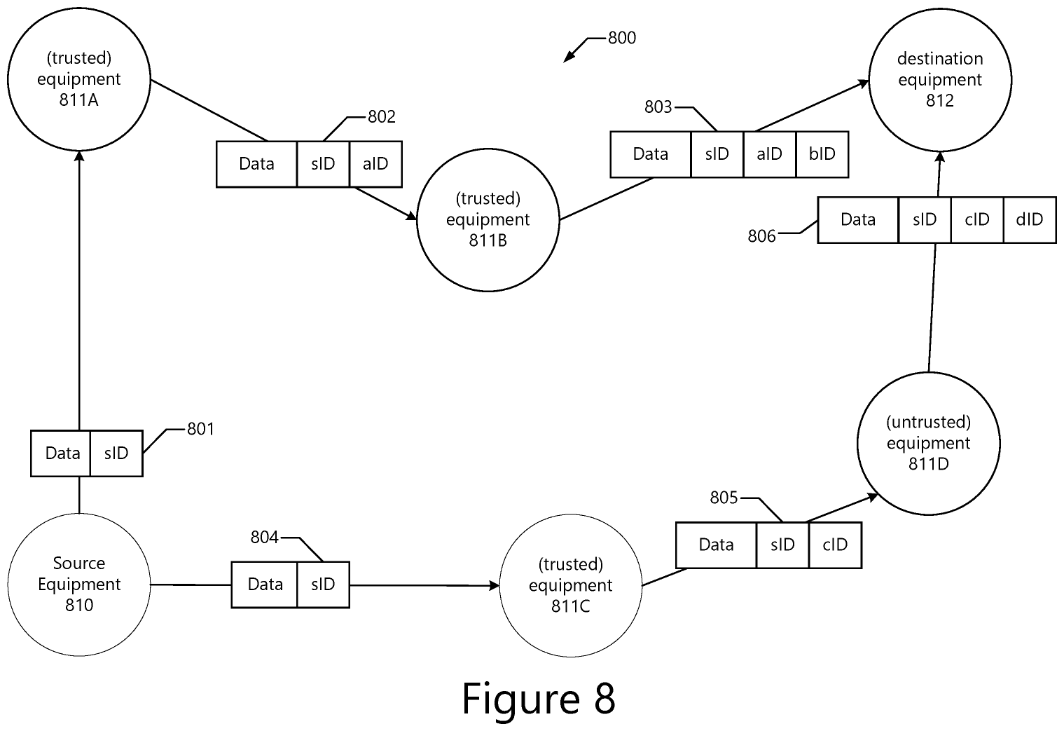

FIG. 6 shows an example environment 600 for the detection of neighboring untrusted equipment. The environment 600 includes considered equipment 601 (or “ego equipment 601”), and various neighboring equipment 602-605 including untrusted equipment 602 (e.g., depicted as a cell phone in FIG. 6), trusted equipment 603 (e.g., depicted as a wearable device in FIG. 6), trusted equipment 604 (e.g., depicted as a smartphone in FIG. 6), and trusted equipment 605 (e.g., depicted as a camera/sensor in FIG. 6). Here, the trusted equipment is/are devices compliant with [RED] requirements, and any device not compliant with [RED] requirements is considered to be untrusted equipment. There will be a number of such devices remaining in use over a number of years, since the [RED] requirements will only apply to newly developed and released equipment that is/are introduced into the market. Equipment that was previously introduced into the market before the [RED] requirements were in force will not require any updates; they are simply allowed to remain in use until the end of their lifetime. Therefore, a situation arises in which trusted equipment (e.g., equipment 603-605) and untrusted equipment (e.g., equipment 602) coexist in the same environments such as environment 600.

In FIG. 6, the considered equipment 601 sends respective request messages 610 to neighboring equipment 602-605 for equipment identifiers (IDs), and receives a suitable response messages 615 with the requested ID. In case that a neighboring equipment is identified to be untrusted (e.g., untrusted equipment 602), any connection to such untrusted equipment 602 is terminated. The corresponding decisions may be taken through a list of “untrusted” manufacturers and/or equipment. The identification of whether peer equipment is untrusted may be based on whether the ID of the peer equipment is part of a list of untrusted equipment.

FIG. 7 illustrates a procedure 700 for discovery of trusted/untrusted neighboring equipment. In procedure 700, at operation 701a, a considered equipment 710 (which may be the same or similar as equipment 601 in FIG. 6) sends a request for ID to trusted neighboring equipment 711 (which may be the same or similar as equipment 603-605 in FIG. 6), and at operation 701b, the considered equipment 710 sends a request for ID to untrusted neighboring equipment 712 (which may be the same or similar as equipment 602 in FIG. 6). At operations 702a, 702b, the equipment 711, 712 provide their respective device IDs to the considered equipment 710. At operation 703, the considered equipment 710 sends a request for confirmation as to whether the IDs are trusted or untrusted to a database (DB) of (un)trusted equipment 713. This message may include the IDs received at operations 702a, 702b. At operation 704, the considered equipment 710 receives a confirmation message from the DB 713, which confirms which supplied IDs are trusted or untrusted.

At operation 705, the considered equipment 710 terminates a connection with the neighboring equipment 712, which is identified as being untrusted. The decisions of whether a particular device/equipment is trusted or untrusted may be taken through a list of untrusted manufacturers and/or equipment (703, 704), or through a list of trusted manufacturers. At operation 706, the considered equipment 710 establishes or continues an on-going data transfer/exchange with the trusted neighbor equipment 713.

FIG. 8 shows an example routing process 800. Here, data streams (or data units) collect equipment IDs of each equipment/nodes 810, 811, 812 processing the data stream (or data units) through the routing process 800. The equipment IDs may be any suitable identifier such as a manufacturer (mfg) ID, a network ID, an application ID, a device serial number, and/or any other suitable ID such as any of those discussed herein, and the data units 801-806 can be any suitable data unit, datagram, packet, and the like, such as any of those discussed herein.

In this example, a data unit 801 sent by source equipment 810 to a node 811A includes data and an ID of the source equipment 810 (“sID”), and a data unit 804 sent by the source equipment 810 to a node 811C also includes data and the sID. The nodes 811A and 811C are trusted equipment.

After processing data unit 801, trusted equipment 811A appends its own ID (“aID”) to the data unit 801 thereby producing data unit 802, which is conveyed to node 811B. After processing the data unit 802 from trusted equipment 811A, trusted equipment 811B appends its own ID (“bID”) to the data unit 802 thereby producing data unit 803, which is then sent to the destination equipment 812. After processing data unit 804, trusted equipment 811C appends its own ID (“cID”) to the data unit 804 thereby producing data unit 805, which is then sent to node 811D. Here, node 811D is untrusted equipment. After processing the data unit 805 from trusted equipment 811C, untrusted equipment 811D appends its own ID (“dID”) to the data unit 805 thereby producing data unit 806, which is then sent to the destination equipment 812.

Any suitable insertion logic may be used to append or otherwise insert the IDs and/or other relevant information to the data units 801-806. The insertion logic may be any suitable mechanism that performs packet editing, packet injection, and/or packet insertion processes, and/or the like. In these implementations, the insertion logic may be a packet injection function, packet editor, and/or the like. In some implementations, the insertion logic can be configured with packet insertion configuration information such as, for example, specified start and end bytes within a payload and/or header section of the data units 801-806, specified DFs/DEs within the payload and/or header section where the IDs is/are to be added or inserted, header information to be includes in the data units' 801-806 header section (e.g., SNs, network addresses, flow IDs, session IDs, app IDs, and/or other IDs associated with subscriber equipment and/or UE-specific data, flow classification, zero padding replacement, and/or other like configuration information), and/or the like. Additionally or alternatively, the insertion logic can include a network provenance technique such as any of the network provenance techniques discussed in U.S. Pat. No. 11,019,183 (“['183]”), which is hereby incorporated by reference in its entirety. At the end (e.g., at the destination equipment 812), it is verified whether the data only passed through trusted equipment (e.g., nodes 811). If not, the data may be discarded (e.g., the data included in data unit 806) and a new routing choice will be initiated. In various implementations, the destination node 812 will only accept those packets 801-806 that have been processed by trusted equipment only.

In FIG. 8, the data unit 803 that travels over routing (communication) path “source node 810→node 811A→node 811B→destination node 812” would be accepted following the confirmation that the information/data was passing only through trusted devices, where this is verified by IDs “aID” and “bID” added to the original message 801. Additionally, the data unit 806 that travels over the routing (communication) path “source node 810→node 811C→node 811D→destination node 812” would be rejected since node 811D is untrusted equipment. The rejection of data unit 806 would follow the confirmation that the information was passing through one or more “untrusted” devices, verified using cID and dID added to the data unit 806. In practice, it may not be possible to discover each and every connection/communication path that includes untrusted equipment. In such a case, data units obtained over a routing (communication) path that includes the fewest number of untrusted devices may be kept, while data units obtained from other routing (communication) paths are discarded.

### 2. Cellular Communication Systems, Configurations, and Arrangements

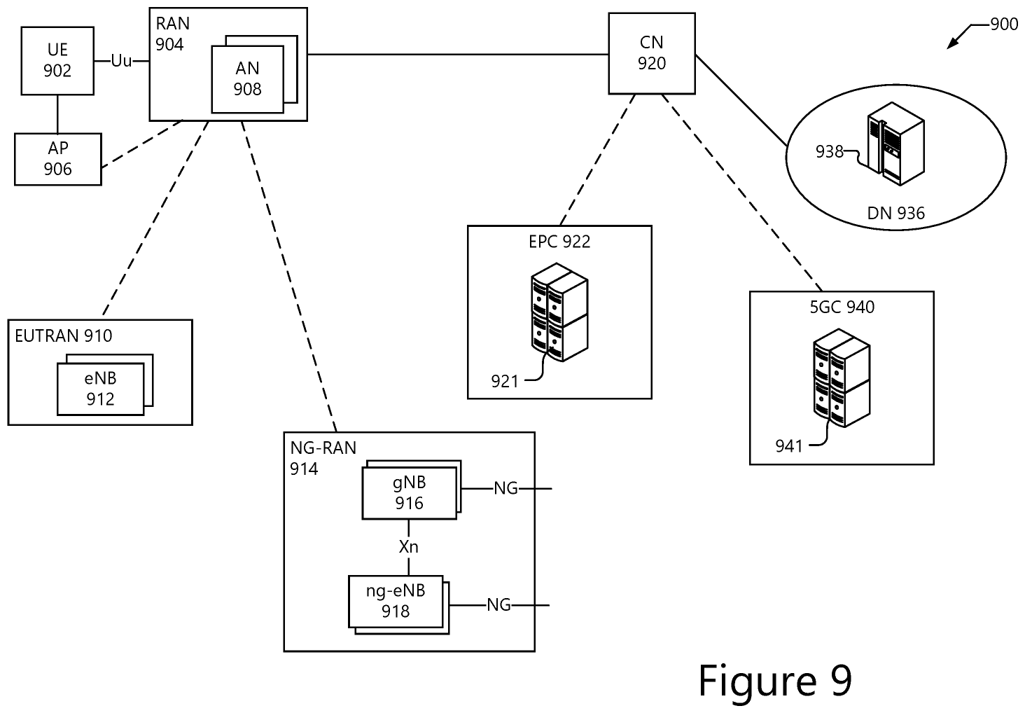

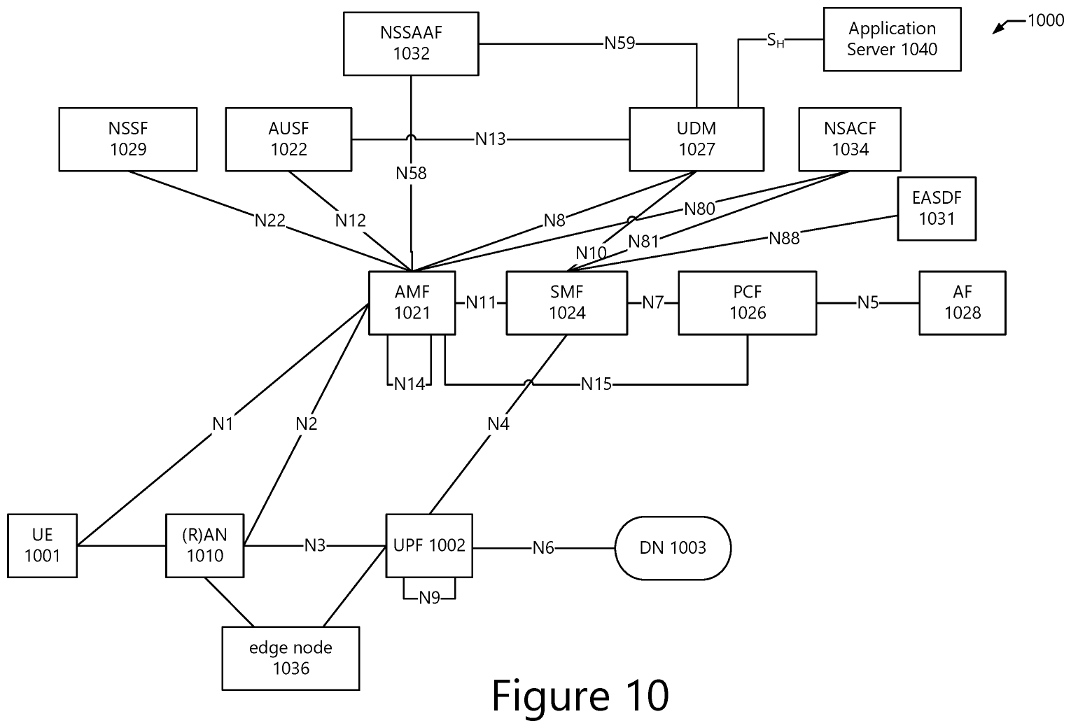

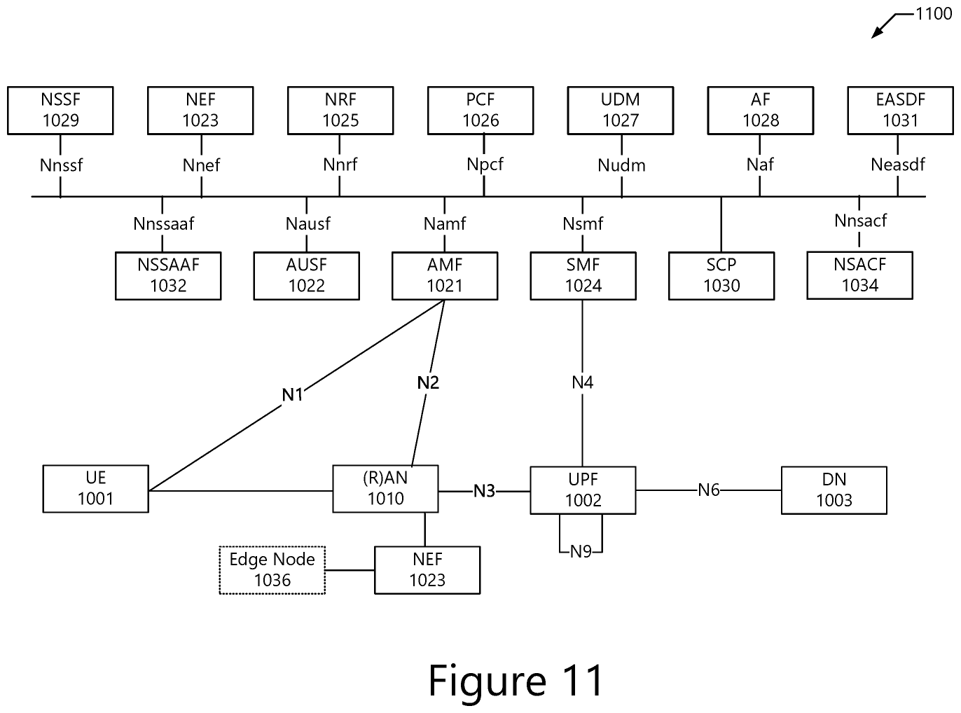

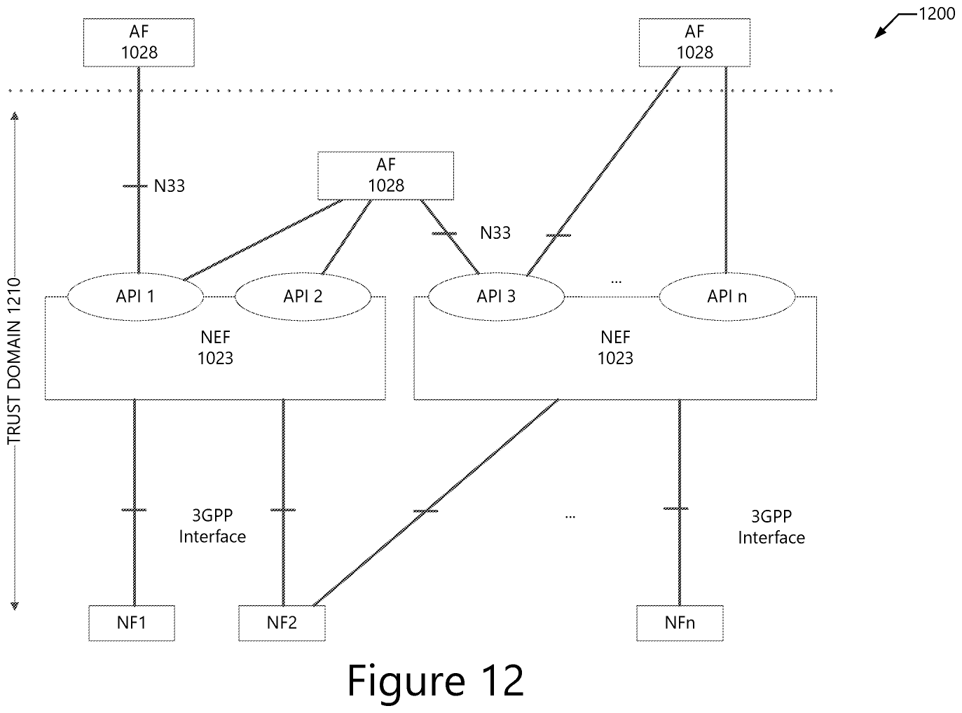

Referring now to FIG. 9, which illustrates a network 900 in accordance with various examples. The network 900 may operate in a manner consistent with 3GPP technical specifications for Long Term Evolution (LTE) or 5G/NR systems. However, the example examples are not limited in this regard and the described examples may apply to other networks that benefit from the principles described herein, such as future 3GPP systems, or the like.

The network 900 includes a UE 902, which is any mobile or non-mobile computing device designed to communicate with a RAN 904 via an over-the-air connection. The UE 902 is communicatively coupled with the RAN 904 by a Uu interface, which may be applicable to both LTE and NR systems. Examples of the UE 902 include, but are not limited to, a smartphone, tablet computer, wearable computer, desktop computer, laptop computer, in-vehicle infotainment system, in-car entertainment system, instrument cluster, head-up display (HUD) device, onboard diagnostic device, dashtop mobile equipment, mobile data terminal, electronic engine management system, electronic/engine control unit, electronic/engine control module, embedded system, sensor, microcontroller, control module, engine management system, networked appliance, machine-type communication device, machine-to-machine (M2M), device-to-device (D2D), machine-type communication (MTC) device, Internet of Things (IoT) device, and/or the like. The network 900 may include a plurality of UEs 902 coupled directly with one another via a D2D, ProSe, PC5, and/or sidelink (SL) interface. These UEs 902 may be M2M/D2D/MTC/IoT devices and/or vehicular systems that communicate using physical SL channels such as, but not limited to, Physical Sidelink Broadcast Channel (PSBCH), Physical Sidelink Discovery Channel (PSDCH), Physical Sidelink Shared Channel (PSSCH), Physical Sidelink Control Channel (PSCCH), Physical Sidelink Feedback Channel (PSFCH), etc.

In some examples, the UE 902 may additionally communicate with an AP 906 via an over-the-air (OTA) connection. The AP 906 manages a WLAN connection, which may serve to offload some/all network traffic from the RAN 904. The connection between the UE 902 and the AP 906 may be consistent with any [IEEE80211] protocol. Additionally, the UE 902, RAN 904, and AP 906 may utilize cellular-WLAN aggregation/integration (e.g., LWA/LWIP). Cellular-WLAN aggregation may involve the UE 902 being configured by the RAN 904 to utilize both cellular radio resources and WLAN resources.

The UE 902 may be configured to perform signal and/or cell measurements based on a configuration obtain from the network (e.g., RAN 904). The UE 902 derives cell measurement results by measuring one or multiple beams per cell as configured by the network. For all cell measurement results, the UE 902 applies layer 3 (L3) filtering before using the measured results for evaluation of reporting criteria and measurement reporting. For cell measurements, the network can configure Reference Signal Received Power (RSRP), Reference Signal Received Quality (RSRQ), and/or Signal-to-Interference plus Noise Ratio (SINR) as a trigger quantity. Reporting quantities can be the same as the trigger quantity or combinations of quantities (e.g., RSRP and RSRQ; RSRP and SINR; RSRQ and SINR; RSRP, RSRQ and SINR). In other examples, other measurements and/or combinations of measurements may be used as a trigger quantity such as those discussed in 3GPP TS 36.214 v17.0.0 (2022-03-31) (“[TS36214]”), 3GPP TS 38.215 v17.1.0 (2022-04-01) (“[TS38215]”), [IEEE80211], and/or the like.

The RAN 904 includes one or more access network nodes (ANs) 908. The ANs 908 terminate air-interface(s) for the UE 902 by providing access stratum protocols including Radio Resource Control (RRC), Packet Data Convergence Protocol (PDCP), Radio Link Control (RLC), Medium Access Control (MAC), and physical (PHY/L1) layer protocols. In this manner, the AN 908 enables data/voice connectivity between CN 920 and the UE 902. The UE 902 and can be configured to communicate using OFDM communication signals with other UEs 902 or with any of the AN 908 over a multicarrier communication channel in accordance with various communication techniques, such as, but not limited to, an OFDMA communication technique (e.g., for DL communications) or a SC-FDMA communication technique (e.g., for UL and SL communications), although the scope of the examples is not limited in this respect. The OFDM signals comprise a plurality of orthogonal subcarriers.

The ANs 908 may be a macrocell base station or a low power base station for providing femtocells, picocells or other like cells having smaller coverage areas, smaller user capacity, or higher bandwidth compared to macrocells; or some combination thereof. In these implementations, an AN 908 be referred to as a BS, gNB, RAN node, eNB, ng-eNB, NodeB, RSU, TRxP, and/or the like.

One example implementation is a “CU/DU split” architecture where the ANs 908 are embodied as a gNB-Central Unit (CU) that is communicatively coupled with one or more gNB-Distributed Units (DUs), where each DU may be communicatively coupled with one or more Radio Units (RUs) (also referred to as RRHs, RRUs, or the like) (see e.g., 3GPP TS 38.401 v15.7.0 (2020-01-09)). In some implementations, the one or more RUs may be individual RSUs. In some implementations, the CU/DU split may include an ng-eNB-CU and one or more ng-eNB-DUs instead of, or in addition to, the gNB-CU and gNB-DUs, respectively. The ANs 908 employed as the CU may be implemented in a discrete device or as one or more software entities running on server computers as part of, for example, a virtual network including a virtual Base Band Unit (BBU) or BBU pool, cloud RAN (CRAN), Radio Equipment Controller (REC), Radio Cloud Center (RCC), centralized RAN (C-RAN), virtualized RAN (vRAN), and/or the like (although these terms may refer to different implementation concepts). Any other type of architectures, arrangements, and/or configurations can be used.

The plurality of ANs may be coupled with one another via an X2 interface (if the RAN 904 is an LTE RAN or Evolved Universal Terrestrial Radio Access Network (E-UTRAN) 910) or an Xn interface (if the RAN 904 is a NG-RAN 914). The X2/Xn interfaces, which may be separated into control/user plane interfaces in some examples, may allow the ANs to communicate information related to handovers, data/context transfers, mobility, load management, interference coordination, and the like.

The ANs of the RAN 904 may each manage one or more cells, cell groups, component carriers, etc. to provide the UE 902 with an air interface for network access. The UE 902 may be simultaneously connected with a plurality of cells provided by the same or different ANs 908 of the RAN 904. For example, the UE 902 and RAN 904 may use carrier aggregation (CA) to allow the UE 902 to connect with a plurality of component carriers, each corresponding to a PCell or SCell. A PCell is an MCG cell, operating on a primary frequency, in which the UE 902 performs an initial connection establishment procedure and/or initiates a connection re-establishment procedure. An SCell is a cell providing additional radio resources on top of a Special Cell (SpCell) when the UE 902 is configured with CA. In CA, two or more Component Carriers (CCs) are aggregated. The UE 902 may simultaneously receive or transmit on one or multiple CCs depending on its capabilities. A UE 902 with single timing advance capability for CA can simultaneously receive and/or transmit on multiple CCs corresponding to multiple serving cells sharing the same timing advance (multiple serving cells grouped in one timing advance group (TAG)). A UE 902 with multiple timing advance capability for CA can simultaneously receive and/or transmit on multiple CCs corresponding to multiple serving cells with different timing advances (multiple serving cells grouped in multiple TAGs). The NG-RAN 914 ensures that each TAG contains at least one serving cell; A non-CA capable UE 902 can receive on a single CC and transmit on a single CC corresponding to one serving cell only (one serving cell in one TAG). CA is supported for both contiguous and non-contiguous CCs. When CA is deployed frame timing and SFN are aligned across cells that can be aggregated, or an offset in multiples of slots between the PCell/PSCell and an SCell is configured to the UE 902. In some implementations, the maximum number of configured CCs for a UE 902 is 16 for DL and 16 for UL.

In Dual Connectivity (DC) scenarios, a first AN 908 may be a master node that provides a Master Cell Group (MCG) and a second AN 908 may be secondary node that provides an Secondary Cell Group (SCG). The first and second ANs 908 may be any combination of eNB, gNB, ng-eNB, etc. The MCG is a subset of serving cells comprising the PCell and zero or more SCells. The SCG is a subset of serving cells comprising the PSCell and zero or more SCells. As alluded to previously, DC operation involves the use of PSCells and SpCells. A PSCell is an SCG cell in which the UE 902 performs random access (RA) when performing a reconfiguration with Sync procedure, and an SpCell for DC operation is a PCell of the MCG or the PSCell of the SCG; otherwise the term SpCell refers to the PCell. Additionally, the PCell, PSCells, SpCells, and the SCells can operate in the same frequency range (e.g., FR1 or FR2), or the PCell, PSCells, SpCells, and the SCells can operate in different frequency ranges. In one example, the PCell may operate in a sub-6 GHz frequency range/band and the SCell can operate at frequencies above 24.25 GHz (e.g., FR2).

The RAN 904 may provide the air interface over a licensed spectrum or an unlicensed spectrum. To operate in the unlicensed spectrum, the nodes may use LAA, eLAA, and/or feLAA mechanisms based on CA technology with PCells/Scells. Prior to accessing the unlicensed spectrum, the nodes may perform medium/carrier-sensing operations based on, for example, a listen-before-talk (LBT) protocol.

In some examples, the RAN 904 may be an E-UTRAN 910 with one or more eNBs 912. The E-UTRAN 910 provides an LTE air interface (Uu) with the following characteristics: subcarrier spacing (SCS) of 15 kHz; cyclic prefix (CP)-OFDM waveform for DL and SC-FDMA waveform for UL; turbo codes for data and TBCC for control; etc. The LTE air interface may rely on channel state information reference signals (CSI-RS) for channel state information (CSI) acquisition and beam management; Physical Downlink Shared Channel (PDSCH)/Physical Downlink Control Channel (PDCCH) Demodulation Reference Signal (DMRS) for PDSCH/PDCCH demodulation; and cell-specific reference signals (CRS) for cell search and initial acquisition, channel quality measurements, and channel estimation for coherent demodulation/detection at the UE. The LTE air interface may operating on sub-6 GHz bands.

In some examples, the RAN 904 may be an next generation (NG)-RAN 914 with one or more gNB 916 and/or on or more ng-eNB 918. The gNB 916 connects with 5G-enabled UEs 902 using a 5G NR interface. The gNB 916 connects with a 5GC 940 through an NG interface, which includes an N2 interface or an N3 interface. The ng-eNB 918 also connects with the 5GC 940 through an NG interface, but may connect with a UE 902 via the Uu interface. The gNB 916 and the ng-eNB 918 may connect with each other over an Xn interface.

In some examples, the NG interface may be split into two parts, an NG user plane (NG-U) interface, which carries traffic data between the nodes of the NG-RAN 914 and a UPF (e.g., N3 interface), and an NG control plane (NG-C) interface, which is a signaling interface between the nodes of the NG-RAN 914 and an AMF (e.g., N2 interface).

The NG-RAN 914 may provide a 5G-NR air interface (which may also be referred to as a Uu interface) with the following characteristics: variable SCS; CP-OFDM for DL, CP-OFDM and DFT-s-OFDM for UL; polar, repetition, simplex, and Reed-Muller codes for control and LDPC for data. The 5G-NR air interface may rely on CSI-RS, PDSCH/PDCCH DMRS similar to the LTE air interface. The 5G-NR air interface may not use a CRS, but may use Physical Broadcast Channel (PBCH) DMRS for PBCH demodulation; Phase Tracking Reference Signals (PTRS) for phase tracking for PDSCH; and tracking reference signal for time tracking. The 5G-NR air interface may operating on FR1 bands that include sub-6 GHz bands or FR2 bands that include bands from 24.25 GHz to 52.6 GHz. The 5G-NR air interface may include an Synchronization Signal Block (SSB) that is an area of a DL resource grid that includes Primary Synchronization Signal (PSS)/Secondary Synchronization Signal (SSS)/PBCH.

The 5G-NR air interface may utilize bandwidth parts (BWPs) for various purposes. For example, BWP can be used for dynamic adaptation of the SCS. A BWP is a subset of contiguous common resource blocks defined in clause 4.4.4.3 of 3GPP TS 38.211 or a given numerology in a BWP on a given carrier. For example, the UE 902 can be configured with multiple BWPs where each BWP configuration has a different SCS. When a BWP change is indicated to the UE 902, the SCS of the transmission is changed as well. Another use case example of BWP is related to power saving. In particular, multiple BWPs can be configured for the UE 902 with different amount of frequency resources (e.g., PRBs) to support data transmission under different traffic loading scenarios. A BWP containing a smaller number of PRBs can be used for data transmission with small traffic load while allowing power saving at the UE 902 and in some cases at the gNB 916. A BWP containing a larger number of PRBs can be used for scenarios with higher traffic load.

The RAN 904 is communicatively coupled to CN 920, which includes network elements and/or network functions (NFs) to provide various functions to support data and telecommunications services to customers/subscribers (e.g., UE 902). The network elements and/or NFs may be implemented by one or more servers 921, 941. The components of the CN 920 may be implemented in one physical node or separate physical nodes. In some examples, NFV may be utilized to virtualize any or all of the functions provided by the network elements of the CN 920 onto physical compute/storage resources in servers, switches, etc. A logical instantiation of the CN 920 may be referred to as a network slice, and a logical instantiation of a portion of the CN 920 may be referred to as a network sub-slice.

The CN 920 may be an LTE CN 922 (also referred to as an Evolved Packet Core (EPC) 922). The EPC 922 may include MME, SGW, SGSN, HSS, PGW, PCRF, and/or other NFs coupled with one another over various interfaces (or “reference points”) (not shown). The CN 920 may be a 5GC 940 including an AUSF, AMF, SMF, UPF, NSSF, NEF, NRF, PCF, UDM, AF, and/or other NFs coupled with one another over various service-based interfaces and/or reference points (see e.g., FIGS. 10 and 11). The 5GC 940 may enable edge computing by selecting operator/3rd party services to be geographically close to a point that the UE 902 is attached to the network. This may reduce latency and load on the network. In edge computing implementations, the 5GC 940 may select a UPF close to the UE 902 and execute traffic steering from the UPF to DN 936 via the N6 interface. This may be based on the UE subscription data, UE location, and information provided by the AF, which allows the AF to influence UPF (re)selection and traffic routing.

The data network (DN) 936 may represent various network operator services, Internet access, or third party services that may be provided by one or more servers including, for example, application (app)/content server 938. The DN 936 may be an operator external public, a private PDN, or an intra-operator packet data network, for example, for provision of IMS services. In this example, the server 938 can be coupled to an IMS via an S-CSCF or the I-CSCF. In some implementations, the DN 936 may represent one or more local area DNs (LADNs), which are DNs 936 (or DN names (DNNs)) that is/are accessible by a UE 902 in one or more specific areas. Outside of these specific areas, the UE 902 is not able to access the LADN/DN 936.

Additionally or alternatively, the DN 936 may be an Edge DN 936, which is a (local) Data Network that supports the architecture for enabling edge applications. In these examples, the app server 938 may represent the physical hardware systems/devices providing app server functionality and/or the application software resident in the cloud or at an edge compute node that performs server function(s). In some examples, the app/content server 938 provides an edge hosting environment that provides support required for Edge Application Server's execution.

In some examples, the 5GS can use one or more edge compute nodes to provide an interface and offload processing of wireless communication traffic. In these examples, the edge compute nodes may be included in, or co-located with one or more RAN 910, 914. For example, the edge compute nodes can provide a connection between the RAN 914 and UPF in the 5GC 940. The edge compute nodes can use one or more NFV instances instantiated on virtualization infrastructure within the edge compute nodes to process wireless connections to and from the RAN 914 and a UPF 1002.

In some implementations, the system 900 may include an SMSF, which is responsible for SMS subscription checking and verification, and relaying SM messages to/from the UE 902 to/from other entities, such as an SMS-GMSC/IWMSC/SMS-router. The SMS may also interact with AMF and UDM for a notification procedure that the UE 902 is available for SMS transfer (e.g., set a UE not reachable flag, and notifying UDM when UE 902 is available for SMS).

FIGS. 10 and 11 illustrate example system architectures 1000 and 1100 (collectively “5GC 1000”) of a 5GC such as CN 940 of FIG. 9, in accordance with various examples. In particular, FIG. 10 shows an exemplary 5G system architecture 1000 in a reference point representation where interactions between NFs are represented by corresponding point-to-point reference points Ni, and FIG. 11 illustrates an exemplary 5G system architecture 1100 in a service-based representation where interactions between NFs are represented by corresponding service-based interfaces. The system 1000 is shown to include a UE 1001, which may be the same or similar to the UEs 902 discussed previously; a (R)AN 1010, which may be the same or similar to the AN 908 discussed previously; and a DN 1003, which may be, for example, operator services, Internet access or 3rd party services, and may correspond with a Packet Data Network in LTE systems; and a 5GC 1020. The 5GC 1020 may include an Access and Mobility Management Function (AMF) 1021; an Authentication Server Function (AUSF) 1022; a Session Management Function (SMF) 1024; a Network Exposure Function (NEF) 1023; a Policy Control Function (PCF) 1026; an NF Repository Function (NRF) 1025; a Unified Data Management (UDM) 1027; an Application Function (AF) 1028; a User Plane Function (UPF) 1002; a Network Slice Selection Function (NSSF) 1029; a Service Communication Proxy (SCP) 1030; an Edge Application Server Discovery Function (EASDF) 1031, a Network Slice-specific and SNPN Authentication and Authorization Function (NSSAAF) 1032; and a Network Slice Admission Control Function (NSACF) 1034.

The reference point representation of FIG. 10 shows various interactions between corresponding NFs. For example, FIG. 10 illustrates the following reference points: N1 (between the UE 1001 and the AMF 1021), N2 (between the RAN 1010 and the AMF 1021), N3 (between the RAN 1010 and the UPF 1002), N4 (between the SMF 1024 and the UPF 1002), N5 (between the PCF 1026 and the AF 1028), N6 (between the UPF 1002 and the DN 1003), N7 (between the SMF 1024 and the PCF 1026), N8 (between the UDM 1027 and the AMF 1021), N9 (between two UPFs 1002), N10 (between the UDM 1027 and the SMF 1024), N11 (between the AMF 1021 and the SMF 1024), N12 (between the AUSF 1022 and the AMF 1021), N13 (between the AUSF 1022 and the UDM 1027), N14 (between two AMFs 1021), N15 (between the PCF 1026 and the AMF 1021 in case of a non-roaming scenario, or between the PCF 1026 and a visited network and AMF 1021 in case of a roaming scenario), N16 (between two SMFs 1024; not shown), N22 (between AMF 1021 and NSSF 1025), N58 (between the AMF 1021 and the NSSAAF 1032), N80 (between the AMF 1021 and the NSACF 1034), and N88 (between the SMF 1024 and the EASDF 1031). Other reference point representations not shown in FIG. 10 can also be used such a N59 (reference point between the UDM 1027 and the NSSAAF 1032) and the like. The service-based representation of FIG. 11 represents NFs within the control plane that enable other authorized NFs to access their services. In this regard, 5G system architecture 1000 can include the following service-based interfaces: Namf (a service-based interface exhibited by the AMF 1021), Nsmf (a service-based interface exhibited by the SMF 1024), Nnef (a service-based interface exhibited by the NEF 1023), Npcf (a service-based interface exhibited by the PCF 1026), Nudm (a service-based interface exhibited by the UDM 1027), Naf (a service-based interface exhibited by the AF 1028), Nnrf (a service-based interface exhibited by the NRF 1025), Nnssf (a service-based interface exhibited by the NSSF 1029), Nausf (a service-based interface exhibited by the AUSF 1022), Nnssaaf (a service-based interface exhibited by the NSSAAF 1032, Nnsacf (a service-based interface exhibited by the NSACF 1034), Neasdf (a service-based interface exhibited by the EASDF 1031), and the like. Other service-based interfaces (e.g., Nudr, N5g-eir, and Nudsf) not shown in FIG. 11 can also be used. In examples, the NEF 1023 can provide an interface to Edge node 1036, which can be used to process wireless connections with the RAN 1010.

The 5GS 1000 is assumed to operate with a large number of UEs 1001 used for CIoT and capable of appropriately handling overload and congestion situations. UEs 1001 used for CIoT can be mobile or nomadic/static, and resource efficiency should be considered for both for relevant optimization(s). The 5GS 1000 also supports one or more small data delivery mechanisms using IP data and Unstructured (Non-IP) data.

The AUSF 1022 stores data for authentication of UE 1001 and handle authentication-related functionality. The AUSF 1022 may facilitate a common authentication framework for various access types. The AUSF 1022 may communicate with the AMF 1021 via an N12 reference point between the AMF 1021 and the AUSF 1022; and may communicate with the UDM 1027 via an N13 reference point between the UDM 1027 and the AUSF 1022. Additionally, the AUSF 1022 may exhibit an Nausf service-based interface.

The AMF 1021 allows other functions of the 5GC 1000 to communicate with the UE 1001 and the RAN 1010 and to subscribe to notifications about mobility events with respect to the UE 1001. The AMF 1021 is also responsible for registration management (e.g., for registering UE 1001), connection management, reachability management, mobility management, lawful interception of AMF-related events, and access authentication and authorization. The AMF 1021 provides transport for SM messages between the UE 1001 and the SMF 1024, and acts as a transparent proxy for routing SM messages. AMF 1021 also provides transport for SMS messages between UE 1001 and an SMSF. AMF 944 interacts with the AUSF 1022 and the UE 1001 to perform various security anchor and context management functions. Furthermore, AMF 1021 is a termination point of a RAN-CP interface, which includes the N2 reference point between the RAN 1010 and the AMF 1021. The AMF 1021 is also a termination point of Non-Access Stratum (NAS) (N1) signaling, and performs NAS ciphering and integrity protection.

The AMF 1021 also supports NAS signaling with the UE 1001 over an N3IWF interface. The N3IWF provides access to untrusted entities. N3IWF may be a termination point for the N2 interface between the (R)AN 1010 and the AMF 1021 for the control plane, and may be a termination point for the N3 reference point between the (R)AN 1010 and the UPF 1002 for the user plane. As such, the AMF 1021 handles N2 signaling from the SMF 1024 and the AMF 1021 for PDU sessions and QoS, encapsulate/de-encapsulate packets for IPSec and N3 tunneling, marks N3 user-plane packets in the uplink, and enforces QoS corresponding to N3 packet marking taking into account QoS requirements associated with such marking received over N2. N3IWF may also relay UL and DL control-plane NAS signaling between the UE 1001 and AMF 1021 via an N1 reference point between the UE 1001 and the AMF 1021, and relay uplink and downlink user-plane packets between the UE 1001 and UPF 1002. The N3IWF also provides mechanisms for IPsec tunnel establishment with the UE 1001. The AMF 1021 may exhibit an Namf service-based interface, and may be a termination point for an N14 reference point between two AMFs 1040 and an N17 reference point between the AMF 1021 and a 5G-EIR (not shown by FIG. 9).

The SMF 1024 is responsible for SM (e.g., session establishment, tunnel management between UPF 1002 and (R)AN 1010); UE IP address (or other network address) allocation and management (including optional authorization); selection and control of UP function; configuring traffic steering at UPF 1002 to route traffic to proper destination; termination of interfaces toward policy control functions; controlling part of policy enforcement, charging, and QoS; lawful intercept (for SM events and interface to LI system); termination of SM parts of NAS messages; downlink data notification; initiating AN specific SM information, sent via AMF 1021 over N2 to (R)AN 1010; and determining SSC mode of a session. SM refers to management of a PDU session, and a PDU session or “session” refers to a PDU connectivity service that provides or enables the exchange of PDUs between the UE 1001 and the DN 1003.

The SMF 1024 may also include following functionalities to support edge computing enhancements (see e.g., 3GPP TS 23.548 v17.2.0 (2022-03-23) (“[TS23548]”)) selection of EASDF 1031 and provision of its address to the UE 1001 as the DNS Server for the PDU session; usage of the EASDF 1031 services as defined in [TS23548]; and for supporting the Application Layer Architecture defined in [TS23558]: provision and updates of ECS Address Configuration Information to the UE 1001.

The UPF 1002 acts as an anchor point for intra-RAT and inter-RAT mobility, an external PDU session point of interconnect to data network 1003, and a branching point to support multi-homed PDU session. The UPF 1002 also performs packet routing and forwarding, packet inspection, enforces user plane part of policy rules, lawfully intercept packets (UP collection), performs traffic usage reporting, perform QoS handling for a user plane (e.g., packet filtering, gating, UL/DL rate enforcement), performs uplink traffic verification (e.g., SDF-to-QoS flow mapping), transport level packet marking in the uplink and downlink, and performs downlink packet buffering and downlink data notification triggering. UPF 1002 may include an uplink classifier to support routing traffic flows to a data network.

The NSSF 1029 selects a set of network slice instances serving the UE 1001. The NSSF 1029 also determines allowed NSSAI and the mapping to the subscribed S-NSSAIs, if needed. The NSSF 1029 also determines an AMF set to be used to serve the UE 1001, or a list of candidate AMFs 1021 based on a suitable configuration and possibly by querying the NRF 1025. The selection of a set of network slice instances for the UE 1001 may be triggered by the AMF 1021 with which the UE 1001 is registered by interacting with the NSSF 1029; this may lead to a change of AMF 1021. The NSSF 1029 interacts with the AMF 1021 via an N22 reference point; and may communicate with another NSSF in a visited network via an N31 reference point (not shown).

The NEF 1023 securely exposes services and capabilities provided by 3GPP NFs for third party, internal exposure/re-exposure, AFs 1028, edge computing or fog computing systems (e.g., edge compute node 1036, etc. In such examples, the NEF 1023 may authenticate, authorize, or throttle the AFs 1028. NEF 1023 may also translate information exchanged with the AF 1028 and information exchanged with internal network functions. For example, the NEF 1023 may translate between an AF-Service-Identifier and an internal 5GC information. NEF 1023 may also receive information from other NFs based on exposed capabilities of other NFs. This information may be stored at the NEF 1023 as structured data, or at a data storage NF using standardized interfaces. The stored information can then be re-exposed by the NEF 1023 to other NFs and AFs 1028, or used for other purposes such as analytics. External exposure of network capabilities towards Services Capabilities Server (SCS)/app server 1040 or AF 1028 is supported via the NEF 1023. Notifications and data from NFs in the Visiting Public Land Mobile Network (VPLMN) to the NEF 1023 can be routed through an interworking (IWK)-NEF (not shown), similar to the IWK-Service Capability Exposure Function (SCEF) in an EPC (not shown) (see e.g., 3GPP TS 23.682 v17.2.0 (2021-12-23)).

The NRF 1025 supports service discovery functions, receives NF discovery requests from NF instances, and provides information of the discovered NF instances to the requesting NF instances. NRF 1025 also maintains information of available NF instances and their supported services. The NRF 1025 also supports service discovery functions, wherein the NRF 1025 receives NF Discovery Request from NF instance or an SCP (not shown), and provides information of the discovered NF instances to the NF instance or SCP.

The PCF 1026 provides policy rules to control plane functions to enforce them, and may also support unified policy framework to govern network behavior. The PCF 1026 may also implement a front end to access subscription information relevant for policy decisions in a UDR of the UDM 1027. In addition to communicating with functions over reference points as shown, the PCF 1026 exhibit an Npcf service-based interface.

The UDM 1027 handles subscription-related information to support the network entities' handling of communication sessions, and stores subscription data of UE 1001. For example, subscription data may be communicated via an N8 reference point between the UDM 1027 and the AMF 1021. The UDM 1027 may include two parts, an application front end and a UDR. The UDR may store subscription data and policy data for the UDM 1027 and the PCF 1026, and/or structured data for exposure and application data (including PFDs for application detection, application request information for multiple UEs 1001) for the NEF 1023. The Nudr service-based interface may be exhibited by the UDR 221 to allow the UDM 1027, PCF 1026, and NEF 1023 to access a particular set of the stored data, as well as to read, update (e.g., add, modify), delete, and subscribe to notification of relevant data changes in the UDR. The UDM may include a UDM-FE, which is in charge of processing credentials, location management, subscription management and so on. Several different front ends may serve the same user in different transactions. The UDM-FE accesses subscription information stored in the UDR and performs authentication credential processing, user identification handling, access authorization, registration/mobility management, and subscription management. In addition to communicating with other NFs over reference points as shown, the UDM 1027 may exhibit the Nudm service-based interface.

The AF 1028 interacts with the 3GPP core network (e.g., CN 920) in order to provide services, for example to support the following: application influence on traffic routing (see e.g., clause 5.6.7 of [TS23501]); accessing the NEF 1023 (see e.g., clause 5.20 of [TS23501]); interacting with the policy framework for policy control (see e.g., clause 5.14 of [TS23501]); time synchronization service (see e.g., clause 5.27.1.4 of [TS23501]); and IMS interactions with 5GC (see e.g., clause 5.16 of [TS23501]). The AF 1028 may influence UPF 1002 (re)selection and traffic routing. Based on operator deployment, when AF 1028 is considered to be a trusted entity, the network operator may permit AF 1028 to interact directly with relevant NFs. Additionally, the AF 1028 may be used for edge computing implementations. The 5GC 1000 may enable edge computing by selecting operator/3rd party services to be geographically close to a point that the UE 1001 is attached to the network. This may reduce latency and load on the network. In edge computing implementations, the 5GC 1000 may select a UPF 1002 close to the UE 902 and execute traffic steering from the UPF 1002 to DN 1003 via the N6 interface. This may be based on the UE subscription data, UE location, and information provided by the AF 1028, which allows the AF 1028 to influence UPF (re)selection and traffic routing.

The EASDF 1031 includes one or more of the following functionalities: registering to NRF 1025 for EASDF 1031 discovery and selection; handling the DNS messages according to the instruction from the SMF 1024, including: receiving DNS message handling rules and/or BaselineDNSPattem from the SMF 1024; exchanging DNS messages from the UE 1001; forwarding DNS messages to C-DNS or L-DNS for DNS Query; adding EDNS Client Subnet (ECS) option into DNS Query for an FQDN; reporting to the SMF 1024 the information related to the received DNS messages; buffering/discarding DNS response messages from the UE 1001 or DNS server; terminates the DNS security, if used. The EASDF 1031 has direct user plane connectivity (i.e. without any NAT) with the PDU session anchor (PSA) UPF over N6 for the transmission of DNS signaling exchanged with the UE. The deployment of a NAT between EASDF 1031 and PSA UPF is not supported. Multiple EASDF 1031 instances may be deployed within a PLMN. The interactions between 5GC NF(s) and the EASDF 1031 take place within a PLMN.

The DN 1003 may represent various network operator services, Internet access, or third party services that may be provided by one or more servers including, for example, application (app)/content server 1040. The DN 1003 may be an operator external public, a private PDN, or an intra-operator packet data network, for example, for provision of IMS services. In this example, the app server 1040 can be coupled to an IMS via an S-CSCF or the I-CSCF. In some implementations, the DN 1003 may represent one or more local area DNs (LADNs), which are DNs 1003 (or DN names (DNNs)) that is/are accessible by a UE 1001 in one or more specific areas. Outside of these specific areas, the UE 1001 is not able to access the LADN/DN 1003.

In some implementations, the application programming interfaces (APIs) for CIoT related services provided to the SCS/app server 1040 is/are common for UEs 1001 connected to an EPS and 5GS 1000 and accessed via an Home Public Land Mobile Network (HPLMN). The level of support of the APIs may differ between EPS and 5GS. CIoT UEs 1001 can simultaneously connect to one or multiple SCSs/app servers 1040 and/or Afs 1028.

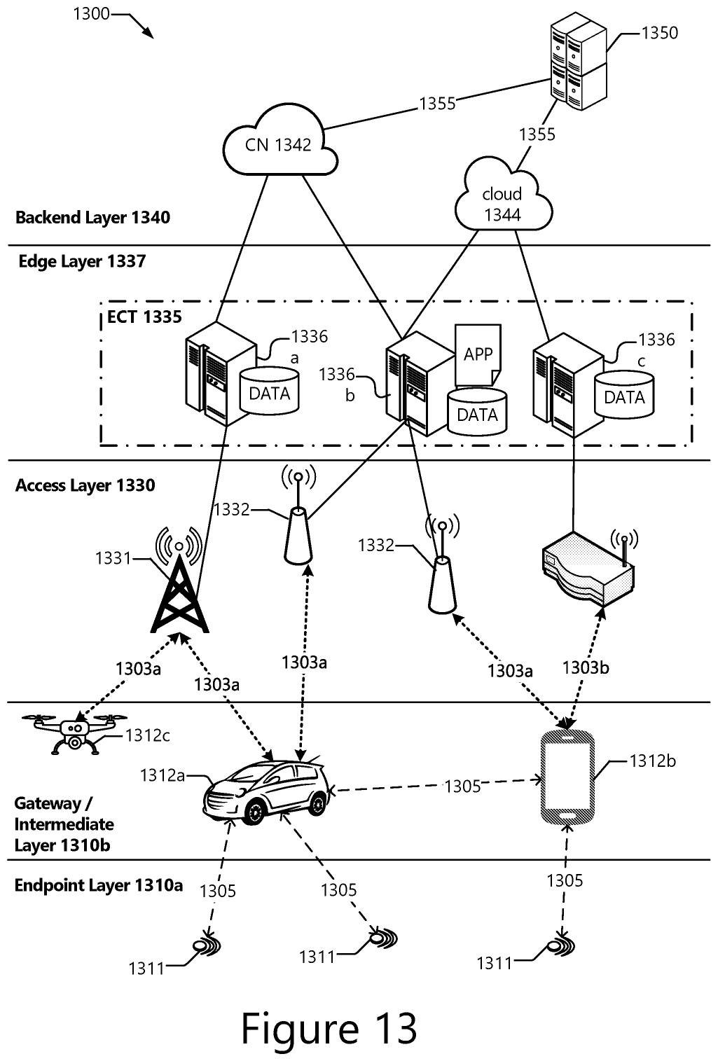

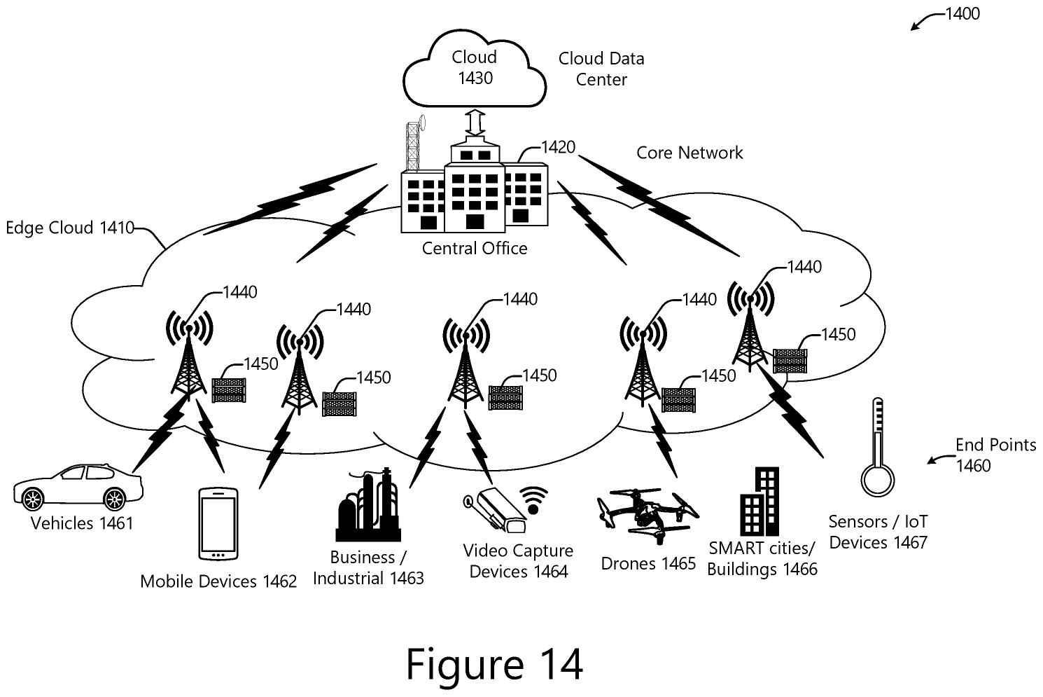

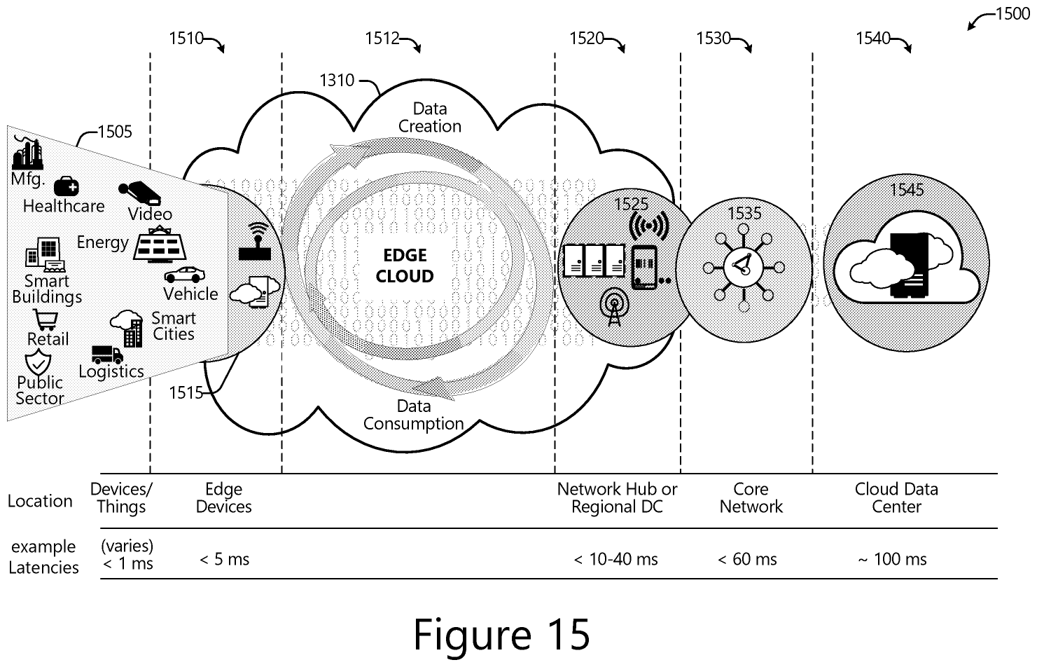

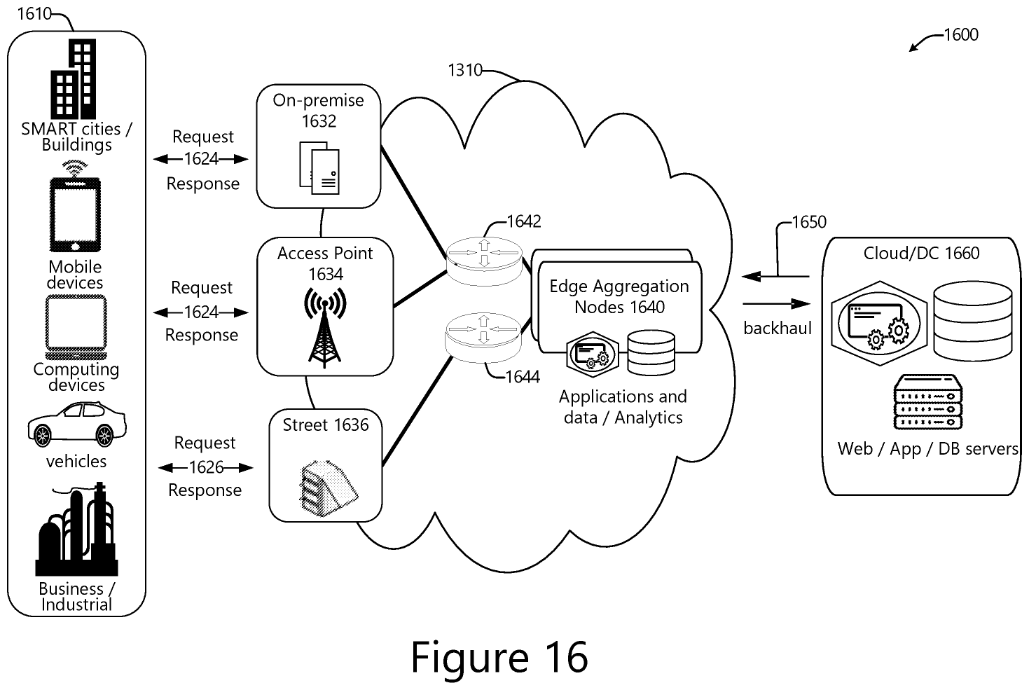

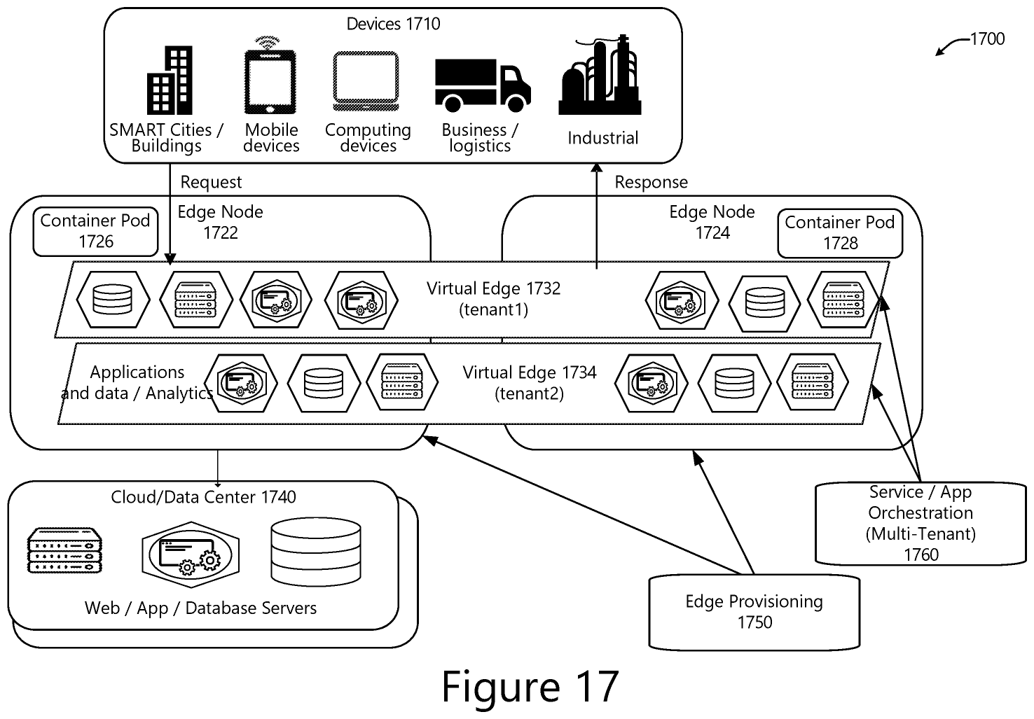

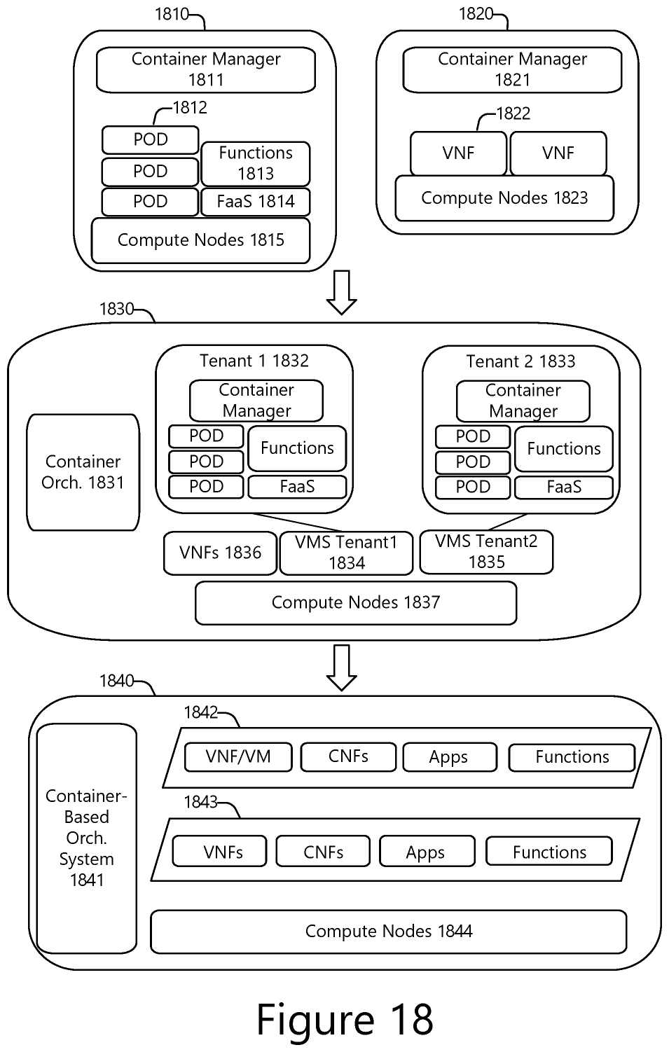

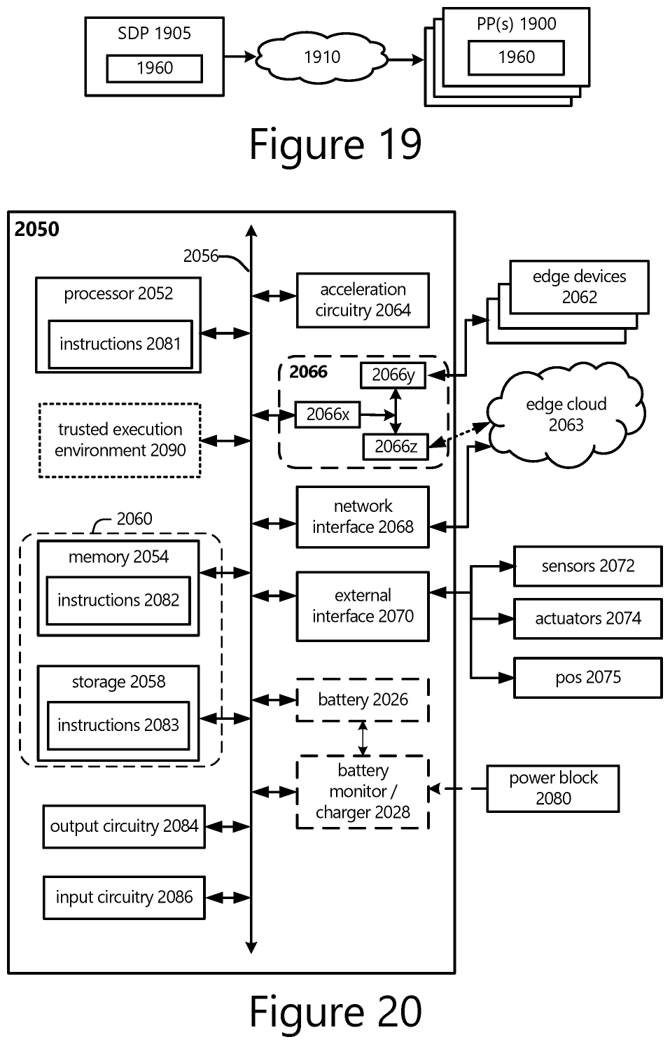

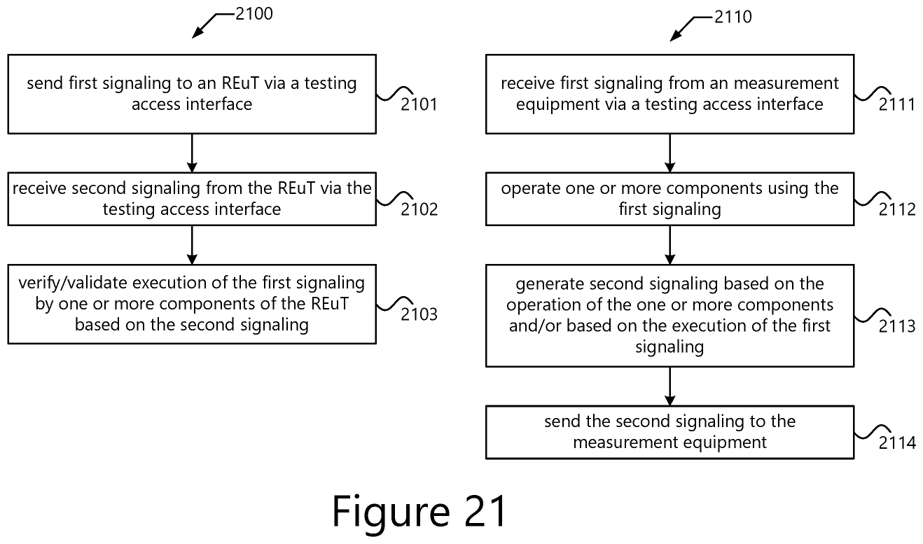

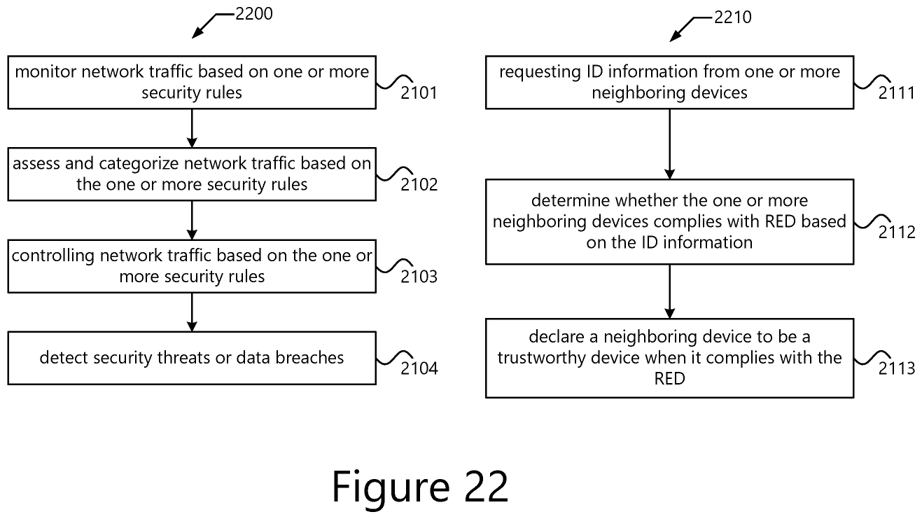

In some implementations, the DN 1003 may be, or include, one or more edge compute nodes 1036. Additionally or alternatively, the DN 1003 may be an edge DN 1003, which is a (local) DN that supports the architecture for enabling edge applications. In these examples, the app server 1040 may represent the physical hardware systems/devices providing app server functionality and/or the application software resident in the cloud or at an edge compute node 1036 that performs server function(s). In some examples, the app/content server 1040 provides an edge hosting environment that provides support required for Edge Application Server execution. The edge compute nodes 1036 provide an interface and offload processing of wireless communication traffic. The edge compute nodes 1036 may be included in, or co-located with one or more RANs 1010. For example, the edge compute nodes 1036 can provide a connection between the RAN 1010 and UPF 1002 in the 5GC 1000. The edge compute nodes 1036 can use one or more NFV instances instantiated on virtualization infrastructure within the edge compute nodes 1036 to process wireless connections to and from the RAN 1010 and UPF 1002. The edge compute nodes 1036 may be the same or similar as the edge compute nodes 1336 of FIG. 13. Additionally or alternatively, the edge compute nodes 1036 may operate according to [SA6Edge].

The SCP 1030 (or individual instances of the SCP 1030) supports indirect communication (see e.g., [TS23501] § 7.1.1); delegated discovery (see e.g., [TS23501] § 7.1.1); message forwarding and routing to destination NF/NF service(s), communication security (e.g., authorization of the NF Service Consumer to access the NF Service Producer API), load balancing, monitoring, overload control, and the like; and discovery and selection functionality for UDM(s) 1027, AUSF(s) 1022, UDR(s), PCF(s) 1026 with access to subscription data stored in the UDR based on UE's SUPI, SUCI or GPSI (see e.g., [TS23501] § 6.3). Load balancing, monitoring, overload control functionality provided by the SCP may be implementation specific. The SCP 1030 may be deployed in a distributed manner. More than one SCP 1030 can be present in the communication path between various NF Services. The SCP 1030, although not an NF instance, can also be deployed distributed, redundant, and scalable.

The NSSAAF 1032 supports Network Slice-Specific Authentication and Authorization (NSSAA) as specified in 3GPP TS 23.502 v17.4.0 (2022-03-23) (“[TS23502]”) with a authentication, authorization, and accounting (AAA) server (AAA-S). If the AAA-S belongs to a third party, the NSSAAF 1032 may contact the AAA-S via an AAA proxy (AAA-P). Support for access to Stand-alone Non-Public Networks (SNPNs) using credentials from Credentials Holder using AAA server (AAA-S) as specified in clause 5.30.2.9.2 of [TS23501] and/or using credentials from default credentials server using AAA server (AAA-S) as specified in clause 5.30.2.10.2 of [TS23501]. If the credentials holder or default credentials server belongs to a third party, the NSSAAF 1032 may contact the AAA server via an AAA proxy (AAA-P). When the NSSAAF 1032 is deployed in a PLMN, the NSSAAF 1032 supports NSSAA, while when the NSSAAF 1032 is deployed in a SNPN the NSSAAF 1032 can support NSSAA and/or the NSSAAF 1032 can support access to SNPN using credentials from credentials holder.

In the case of NF consumer based discovery and selection, the following applies: the AMF 1021 performs NSSAAF 1032 selection to select an NSSAAF Instance that supports network slice specific authentication between the UE 1001 and the AAA-S associated with the HPLMN. The AMF 1021 utilizes the NRF 1025 to discover the NSSAAF instance(s) unless NSSAAF information is available by other means (e.g., locally configured on AMF 1021, or the like). The NSSAAF 1032 selection function in the AMF 1021 selects an NSSAAF instance based on the available NSSAAF instances (obtained from the NRF or locally configured in the AMF 1021). NSSAAF selection is applicable to both 3GPP access and non-3GPP access. The NSSAAF selection function in NSSAAF NF consumers or in SCP 1030 should consider the following factor when it is available: For roaming subscribers, Home Network Identifier (e.g. MNC and MCC) of SUPI (by an NF consumer in the Serving network). In the case of delegated discovery and selection in SCP, the NSSAAF NF consumer sends all available factors to the SCP 1030. The service Nnssaaf_NSSAA, when invoked, causes the NSSAAF 1032 to provide NSSAA service to the requester NF by relaying EAP messages towards a AAA-S or AAA-P and performing related protocol conversion as needed. It also provides notification to the current AMF 1021 where the UE 1001 is of the need to re-authenticate and re-authorize the UE or to revoke the UE authorization.

The NSACF 1034 monitors and controls the number of registered UEs 1001 per network slice for the network slices that are subject to Network Slice Admission Control (NSAC); monitors and controls the number of established PDU Sessions per network slice; and supports of event based Network Slice status notification and reports to a consumer NF. The NSACF 1034 is configured with the maximum number of UEs per network slice which are allowed to be served by each network slice that is subject to NSAC. The NSACF 1034 controls (e.g., increase or decrease) the current number of UEs registered for a network slice so that it does not exceed the maximum number of UEs allowed to register with that network slice. The NSACF 1034 also maintains a list of UE IDs registered with a network slice that is subject to NSAC. When the current number of UEs registered with a network slice is to be increased, the NSACF 1034 first checks whether the UE Identity is already in the list of UEs registered with that network slice and if not, it checks whether the maximum number of UEs per network slice for that network slice has already been reached.

The AMF 1021 triggers a request to NSACF 1034 for maximum number of UEs per network slice admission control when the UE's 1001 registration status for a network slice subject to NSAC may change, i.e. during the UE Registration procedure in clause 4.2.2.2.2 in [TS23502], UE Deregistration procedure in clause 4.2.2.3 in [TS23502], Network Slice-Specific Authentication and Authorisation procedure in clause 4.2.9.2 in [TS23502], AAA Server triggered Network Slice-Specific Re-authentication and Re-authorization procedure in clause 4.2.9.3 in [TS23502], and AAA Server triggered Slice-Specific Authorization Revocation in clause 4.2.9.4 in [TS23502].

The system architecture 1000, 1100 may also include other elements that are not shown by FIG. 10 or 11, such as a Data Storage system/architecture, a 5G-EIR, a SEPP, and the like. The Data Storage system may include a SDSF, an UDSF, and/or the like. Any NF may store and retrieve unstructured data into/from the UDSF (e.g., UE contexts), via N18 reference point between any NF and the UDSF (not shown by FIG. 2). Individual NFs may share a UDSF for storing their respective unstructured data or individual NFs may each have their own UDSF located at or near the individual NFs. Additionally, the UDSF may exhibit an Nudsf service-based interface (not shown by FIG. 2). The 5G-EIR may be an NF that checks the status of PEI for determining whether particular equipment/entities are blacklisted from the network; and the SEPP may be a non-transparent proxy that performs topology hiding, message filtering, and policing on inter-PLMN control plane interfaces.

In another example, the 5G system architecture 1000 includes an IP multimedia subsystem (IMS) as well as a plurality of IP multimedia core network subsystem entities, such as call session control functions (CSCFs) (not shown by FIG. 10 or 3). More specifically, the IMS includes a CSCF, which can act as a proxy CSCF (P-CSCF), a serving CSCF (S-CSCF), an emergency CSCF (E-CSCF), or interrogating CSCF (I-CSCF). The P-CSCF can be configured to be the first contact point for the UE 1001 within the IMS. The S-CSCF can be configured to handle the session states in the network, and the E-CSCF can be configured to handle certain aspects of emergency sessions such as routing an emergency request to the correct emergency center or public safety answering point (PSAP). The I-CSCF can be configured to function as the contact point within an operator's network for all IMS connections destined to a subscriber of that network operator, or a roaming subscriber currently located within that network operator's service area. In some aspects, the I-CSCF can be connected to another IP multimedia network, for example, an IMS operated by a different network operator.

In some implementations, the 5GS architecture also includes a Security Edge Protection Proxy (SEPP) as an entity sitting at the perimeter of the PLMN for protecting control plane messages. The SEPP enforces inter-PLMN security on the N32 interface. The 5GS architecture may also include an Inter-PLMN UP Security (IPUPS) at the perimeter of the PLMN for protecting user plane messages. The IPUPS is a functionality of the UPF 1002 that enforces GTP-U security on the N9 interface between UPFs 1002 of the visited and home PLMNs. The IPUPS can be activated with other functionality in a UPF 1002 or activated in a UPF 1002 that is dedicated to be used for IPUPS functionality (see e.g., [TS23501], clause 5.8.2.14).

Additionally, there may be many more reference points and/or service-based interfaces between the NF services in the NFs; however, these interfaces and reference points have been omitted from FIGS. 10 and 11 for clarity. In one example, the CN 1020 may include an Nx interface, which is an inter-CN interface between the MME and the AMF 1021 in order to enable interworking between system 200 and an EPC. Other example interfaces/reference points may include an N5g-EIR service-based interface exhibited by a 5G-EIR, an N27 reference point between the NRF in the visited network and the NRF in the home network; and an N31 reference point between the NSSF in the visited network and the NSSF in the home network.

FIG. 12 illustrates a non-roaming architecture 1200 for the NEF 1023 in reference point representation. The NEF 1023 provides service capability exposure that provides a means to securely expose the services and capabilities provided by 3GPP network interfaces. In this example, one or more NEFs 1023 securely expose the services and capabilities provided by 3GPP network interfaces (e.g., provided by NFs 1-N where N is a number) via APIs 1-N (where N is a number). In FIG. 12, the 3GPP Interface represents southbound interfaces between the NEF 1023 and 5GC 1000 Network Functions (NFs) (e.g., N29 interface between NEF 1023 and SMF 1024, N30 interface between NEF 1023 and PCF 1026, etc.). All southbound interfaces from NEF are not shown for the sake of simplicity.

Applications operating in the trust domain 1210 may require only a subset of functionalities (e.g., authentication, authorization, etc.) provided by the NEF 1023. Applications operating in the trust domain 1210 can also access network entities (e.g., PCRF and/or the like), wherever the required 3GPP interface(s) are made available, directly without the need to go through the NEF 1023. The trust domain 1210 for NEF 1023 is same as the trust domain 1210 for the SCEF as defined in 3GPP TS 23.682 v16.9.0 (2021-03-31) (“[TS23682]”). In various implementations, the trust domain 1210 may correspond to various ones of the trust domains 450-45N discussed previously. The NEF 1023 supports the following independent functionality:

Exposure of capabilities and events: NF capabilities and events may be securely exposed by NEF 1023 for e.g. 3rd party, Application Functions, Edge Computing as described in clause 5.13 of [TS23501]. NEF 1023 stores/retrieves information as structured data using a standardized interface (Nudr) to the Unified Data Repository (UDR).

Secure provision of information from external application to 3GPP network: It provides a means for the Application Functions to securely provide information to 3GPP network, e.g. Expected UE Behavior, 5G-VN group information, time synchronization service information and service specific information. In that case the NEF 1023 may authenticate and authorize and assist in throttling the Application Functions.

Translation of internal-external information involves the translation between information exchanged with the AF 1028 and information exchanged with the internal network function. For example, it translates between an AF-Service-Identifier and internal 5G Core information such as DNN, S-NSSAI, as described in clause 5.6.7 of [TS23501].

The NEF 1023 handles masking of network and user sensitive information to external AF's according to the network policy. The NEF 1023 receives information from other network functions (based on exposed capabilities of other network functions). NEF 1023 stores the received information as structured data using a standardized interface to a Unified Data Repository (UDR). The stored information can be accessed and “re-exposed” by the NEF 1023 to other network functions and Application Functions, and used for other purposes such as analytics.

The NEF 1023 may also support a PFD Function: The PFD Function in the NEF 1023 may store and retrieve PFD(s) in the UDR and shall provide PFD(s) to the SMF 1024 on the request of SMF 1024 (pull mode) or on the request of PFD management from NEF 1023 (push mode), as described in 3GPP TS 23.503 v17.4.0 (2022-03-23) (“[TS23503]”). The NEF 1023 may also support a 5G-VN Group Management Function: The 5G-VN Group Management Function in the NEF 1023 may store the 5G-VN group information in the UDR via UDM 1027 as described in [TS23502].

Exposure of analytics: NWDAF analytics may be securely exposed by NEF 1023 for external party, as specified in 3GPP TS 23.288 v17.4.0 (2022-03-23) (“[TS23288]”). Retrieval of data from external party by NWDAF: Data provided by the external party may be collected by NWDAF via NEF 1023 for analytics generation purpose. NEF 1023 handles and forwards requests and notifications between NWDAF and AF 1028, as specified in [TS23288].

Support of Non-IP Data Delivery: The NEF 1023 provides a means for management of NIDD configuration and delivery of MO/MT unstructured data by exposing the NIDD APIs as described in [TS23502] on the N33/N NEF 1023 reference point (see e.g., clause 5.31.5 of [TS23501]). Charging data collection and support of charging interfaces.

A specific NEF 1023 instance may support one or more of the functionalities described above and consequently an individual NEF 1023 may support a subset of the APIs specified for capability exposure. The NEF 1023 can access the UDR located in the same PLMN as the NEF 1023.

The services provided by the NEF 1023 are specified in clause 7.2.8 of [TS23501]. The IP address(es)/port(s) of the NEF 1023 may be locally configured in the AF 1028, or the AF 1028 may discover the FQDN or IP address(es)/port(s) of the NEF 1023 by performing a DNS query using the External Identifier of an individual UE 1001 or using the External Group Identifier of a group of UEs 1001, or, if the AF 1028 is trusted by the operator, the AF 1028 may utilize the NRF 1025 to discover the FQDN or IP address(es)/port(s) of the NEF 1023 as described in clause 6.3.14 of [TS23501].

For external exposure of services related to specific UE(s), the NEF 1023 resides in the HPLMN. Depending on operator agreements, the NEF 1023 in the HPLMN may have interface(s) with NF(s) in the VPLMN. When a UE 1001 is capable of switching between EPC 922 and 5GC 940, an SCEF+NEF 1023 is used for service exposure. See clause 5.17.5 for a description of the SCEF+NEF 1023.

### 3. Edge Computing System Configurations and Arrangements

Edge computing refers to the implementation, coordination, and use of computing and resources at locations closer to the “edge” or collection of “edges” of a network. Deploying computing resources at the network's edge may reduce application and network latency, reduce network backhaul traffic and associated energy consumption, improve service capabilities, improve compliance with security or data privacy requirements (especially as compared to conventional cloud computing), and improve total cost of ownership.

Individual compute platforms or other components that can perform edge computing operations (referred to as “edge compute nodes,” “edge nodes,” or the like) can reside in whatever location needed by the system architecture or ad hoc service. In many edge computing architectures, edge nodes are deployed at NANs, gateways, network routers, and/or other devices that are closer to endpoint devices (e.g, UEs, IoT devices, and/or the like) producing and consuming data. As examples, edge nodes may be implemented in a high performance compute data center or cloud installation; a designated edge node server, an enterprise server, a roadside server, a telecom central office; or a local or peer at-the-edge device being served consuming edge services.

Edge compute nodes may partition resources (e.g, memory, CPU, GPU, interrupt controller, I/O controller, memory controller, bus controller, network connections or sessions, and/or the like) where respective partitionings may contain security and/or integrity protection capabilities. Edge nodes may also provide orchestration of multiple applications through isolated user-space instances such as containers, partitions, virtual environments (VEs), virtual machines (VMs), Function-as-a-Service (FaaS) engines, Servlets, servers, and/or other like computation abstractions. Containers are contained, deployable units of software that provide code and needed dependencies. Various edge system arrangements/architecture treats VMs, containers, and functions equally in terms of application composition. The edge nodes are coordinated based on edge provisioning functions, while the operation of the various applications are coordinated with orchestration functions (e.g, VM or container engine, and/or the like). The orchestration functions may be used to deploy the isolated user-space instances, identifying and scheduling use of specific hardware, security related functions (e.g, key management, trust anchor management, and/or the like), and other tasks related to the provisioning and lifecycle of isolated user spaces.

Applications that have been adapted for edge computing include but are not limited to virtualization of traditional network functions including include, for example, Software-Defined Networking (SDN), Network Function Virtualization (NFV), distributed RAN units and/or RAN clouds, and the like. Additional example use cases for edge computing include computational offloading, Content Data Network (CDN) services (e.g, video on demand, content streaming, security surveillance, alarm system monitoring, building access, data/content caching, and/or the like), gaming services (e.g, AR/VR, and/or the like), accelerated browsing, IoT and industry applications (e.g, factory automation), media analytics, live streaming/transcoding, and V2X applications (e.g, driving assistance and/or autonomous driving applications).

The present disclosure provides various examples relevant to various edge computing technologies (ECTs) and edge network configurations provided within and various access/network implementations. Any suitable standards and network implementations are applicable to the edge computing concepts discussed herein. For example, many ECTs and networking technologies may be applicable to the present disclosure in various combinations and layouts of devices located at the edge of a network. Examples of such ECTs include [MEC]; [O-RAN]; [ISEO]; [SA6Edge]; [MAMS]; Content Delivery Networks (CDNs) (also referred to as “Content Distribution Networks” or the like); Mobility Service Provider (MSP) edge computing and/or Mobility as a Service (MaaS) provider systems (e.g, used in AECC architectures); Nebula edge-cloud systems; Fog computing systems; Cloudlet edge-cloud systems; Mobile Cloud Computing (MCC) systems; Central Office Re-architected as a Datacenter (CORD), mobile CORD (M-CORD) and/or Converged Multi-Access and Core (COMAC) systems; and/or the like. Further, the techniques disclosed herein may relate to other IoT edge network systems and configurations, and other intermediate processing entities and architectures may also be used for purposes of the present disclosure. The edge computing systems and arrangements discussed herein may be applicable in various solutions, services, and/or use cases involving mobility. Examples of such scenarios are shown and described with respect to FIGS. 13-18.

FIG. 13 illustrates an example edge computing environment 1300 including different layers of communication, starting from an endpoint layer 1310a (also referred to as “sensor layer 1310a”, “things layer 1310a”, or the like) including one or more IoT devices 1311 (also referred to as “endpoints 1310a” or the like) (e.g, in an Internet of Things (IoT) network, wireless sensor network (WSN), fog, and/or mesh network topology); increasing in sophistication to intermediate layer 1310b (also referred to as “client layer 1310b”, “gateway layer 1310b”, or the like) including various user equipment (UEs) 1312a, 1312b, and 1312c (also referred to as “intermediate nodes 1310b” or the like), which may facilitate the collection and processing of data from endpoints 1310a; increasing in processing and connectivity sophistication to access layer 1330 including a set of network access nodes (NANs) 1331, 1332, and 1333 (collectively referred to as “NANs 1330” or the like); increasing in processing and connectivity sophistication to edge layer 1337 including a set of edge compute nodes 1336a-c (collectively referred to as “edge compute nodes 1336” or the like) within an edge computing framework 1335 (also referred to as “ECT 1335” or the like); and increasing in connectivity and processing sophistication to a backend layer 1340 including core network (CN) 1342, cloud 1344, and server(s) 1350. The processing at the backend layer 1340 may be enhanced by network services as performed by one or more remote servers 1350, which may be, or include, one or more CN functions, cloud compute nodes or clusters, application (app) servers, and/or other like systems and/or devices. Some or all of these elements may be equipped with or otherwise implement some or all features and/or functionality discussed herein.

The environment 1300 is shown to include end-user devices such as intermediate nodes 1310b and endpoint nodes 1310a (collectively referred to as “nodes 1310”, “UEs 1310”, or the like), which are configured to connect to (or communicatively couple with) one or more communication networks (also referred to as “access networks,” “radio access networks,” or the like) based on different access technologies (or “radio access technologies”) for accessing application, edge, and/or cloud services. These access networks may include one or more NANs 1330, which are arranged to provide network connectivity to the UEs 1310 via respective links 1303a and/or 1303b (collectively referred to as “channels 1303”, “links 1303”, “connections 1303”, and/or the like) between individual NANs 1330 and respective UEs 1310.

As examples, the communication networks and/or access technologies may include cellular technology such as LTE, MuLTEfire, and/or NR/5G (e.g, as provided by Radio Access Network (RAN) node 1331 and/or RAN nodes 1332), WiFi or wireless local area network (WLAN) technologies (e.g, as provided by access point (AP) 1333 and/or RAN nodes 1332), and/or the like. Different technologies exhibit benefits and limitations in different scenarios, and application performance in different scenarios becomes dependent on the choice of the access networks (e.g, WiFi, LTE, and/or the like) and the used network and transport protocols (e.g, Transfer Control Protocol (TCP), Virtual Private Network (VPN), Multi-Path TCP (MPTCP), Generic Routing Encapsulation (GRE), and/or the like).

The intermediate nodes 1310b include UE 1312a, UE 1312b, and UE 1312c (collectively referred to as “UE 1312” or “UEs 1312”). In this example, the UE 1312a is illustrated as a vehicle system (also referred to as a vehicle UE or vehicle station), UE 1312b is illustrated as a smartphone (e.g, handheld touchscreen mobile computing device connectable to one or more cellular networks), and UE 1312c is illustrated as a flying drone or unmanned aerial vehicle (UAV). However, the UEs 1312 may be any mobile or non-mobile computing device, such as desktop computers, workstations, laptop computers, tablets, wearable devices, PDAs, pagers, wireless handsets smart appliances, single-board computers (SBCs) (e.g, Raspberry Pi, Arduino, Intel Edison, and/or the like), plug computers, and/or any type of computing device such as any of those discussed herein.

The endpoints 1310 include UEs 1311, which may be IoT devices (also referred to as “IoT devices 1311”), which are uniquely identifiable embedded computing devices (e.g, within the Internet infrastructure) that comprise a network access layer designed for low-power IoT applications utilizing short-lived UE connections. The IoT devices 1311 are any physical or virtualized, devices, sensors, or “things” that are embedded with HW and/or SW components that enable the objects, devices, sensors, or “things” capable of capturing and/or recording data associated with an event, and capable of communicating such data with one or more other devices over a network with little or no user intervention. As examples, IoT devices 1311 may be abiotic devices such as autonomous sensors, gauges, meters, image capture devices, microphones, light emitting devices, audio emitting devices, audio and/or video playback devices, electro-mechanical devices (e.g, switch, actuator, and/or the like), EEMS, ECUs, ECMs, embedded systems, microcontrollers, control modules, networked or “smart” appliances, MTC devices, M2M devices, and/or the like. The IoT devices 1311 can utilize technologies such as M2M or MTC for exchanging data with an MTC server (e.g, a server 1350), an edge server 1336 and/or ECT 1335, or device via a PLMN, ProSe or D2D communication, sensor networks, or IoT networks. The M2M or MTC exchange of data may be a machine-initiated exchange of data.

The IoT devices 1311 may execute background applications (e.g, keep-alive messages, status updates, and/or the like) to facilitate the connections of the IoT network. Where the IoT devices 1311 are, or are embedded in, sensor devices, the IoT network may be a WSN. An IoT network describes an interconnecting IoT UEs, such as the IoT devices 1311 being connected to one another over respective direct links 1305. The IoT devices may include any number of different types of devices, grouped in various combinations (referred to as an “IoT group”) that may include IoT devices that provide one or more services for a particular user, customer, organizations, and/or the like. A service provider (e.g, an owner/operator of server(s) 1350, CN 1342, and/or cloud 1344) may deploy the IoT devices in the IoT group to a particular area (e.g, a geolocation, building, and/or the like) in order to provide the one or more services. In some implementations, the IoT network may be a mesh network of IoT devices 1311, which may be termed a fog device, fog system, or fog, operating at the edge of the cloud 1344. The fog involves mechanisms for bringing cloud computing functionality closer to data generators and consumers wherein various network devices run cloud application logic on their native architecture. Fog computing is a system-level horizontal architecture that distributes resources and services of computing, storage, control, and networking anywhere along the continuum from cloud 1344 to Things (e.g, IoT devices 1311). The fog may be established in accordance with specifications released by the OFC, the OCF, among others. Additionally or alternatively, the fog may be a tangle as defined by the IOTA foundation.

The fog may be used to perform low-latency computation/aggregation on the data while routing it to an edge cloud computing service (e.g, edge nodes 1330) and/or a central cloud computing service (e.g, cloud 1344) for performing heavy computations or computationally burdensome tasks. On the other hand, edge cloud computing consolidates human-operated, voluntary resources, as a cloud. These voluntary resource may include, inter-alia, intermediate nodes 1320 and/or endpoints 1310, desktop PCs, tablets, smartphones, nano data centers, and the like. In various implementations, resources in the edge cloud may be in one to two-hop proximity to the IoT devices 1311, which may result in reducing overhead related to processing data and may reduce network delay.

Additionally or alternatively, the fog may be a consolidation of IoT devices 1311 and/or networking devices, such as routers and switches, with high computing capabilities and the ability to run cloud application logic on their native architecture. Fog resources may be manufactured, managed, and deployed by cloud vendors, and may be interconnected with high speed, reliable links. Moreover, fog resources reside farther from the edge of the network when compared to edge systems but closer than a central cloud infrastructure. Fog devices are used to effectively handle computationally intensive tasks or workloads offloaded by edge resources.

Additionally or alternatively, the fog may operate at the edge of the cloud 1344. The fog operating at the edge of the cloud 1344 may overlap or be subsumed into an edge network 1330 of the cloud 1344. The edge network of the cloud 1344 may overlap with the fog, or become a part of the fog. Furthermore, the fog may be an edge-fog network that includes an edge layer and a fog layer. The edge layer of the edge-fog network includes a collection of loosely coupled, voluntary and human-operated resources (e.g, the aforementioned edge compute nodes 1336 or edge devices). The Fog layer resides on top of the edge layer and is a consolidation of networking devices such as the intermediate nodes 1320 and/or endpoints 1310 of FIG. 13.

Data may be captured, stored/recorded, and communicated among the IoT devices 1311 or, for example, among the intermediate nodes 1320 and/or endpoints 1310 that have direct links 1305 with one another as shown by FIG. 13. Analysis of the traffic flow and control schemes may be implemented by aggregators that are in communication with the IoT devices 1311 and each other through a mesh network. The aggregators may be a type of IoT device 1311 and/or network appliance. In the example of FIG. 13, the aggregators may be edge nodes 1330, or one or more designated intermediate nodes 1320 and/or endpoints 1310. Data may be uploaded to the cloud 1344 via the aggregator, and commands can be received from the cloud 1344 through gateway devices that are in communication with the IoT devices 1311 and the aggregators through the mesh network. Unlike the traditional cloud computing model, in some implementations, the cloud 1344 may have little or no computational capabilities and only serves as a repository for archiving data recorded and processed by the fog. In these implementations, the cloud 1344 centralized data storage system and provides reliability and access to data by the computing resources in the fog and/or edge devices. Being at the core of the architecture, the Data Store of the cloud 1344 is accessible by both Edge and Fog layers of the aforementioned edge-fog network.

As mentioned previously, the access networks provide network connectivity to the end-user devices 1320, 1310 via respective NANs 1330. The access networks may be Radio Access Networks (RANs) such as an NG RAN or a 5G RAN for a RAN that operates in a 5G/NR cellular network, an E-UTRAN for a RAN that operates in an LTE or 4G cellular network, or a legacy RAN such as a UTRAN or GERAN for GSM or CDMA cellular networks. The access network or RAN may be referred to as an Access Service Network for WiMAX implementations. Additionally or alternatively, all or parts of the RAN may be implemented as one or more software entities running on server computers as part of a virtual network, which may be referred to as a cloud RAN (CRAN), Cognitive Radio (CR), a virtual baseband unit pool (vBBUP), and/or the like. Additionally or alternatively, the CRAN, CR, or vBBUP may implement a RAN function split, wherein one or more communication protocol layers are operated by the CRAN/CR/vBBUP and other communication protocol entities are operated by individual RAN nodes 1331, 1332. This virtualized framework allows the freed-up processor cores of the NANs 1331, 1332 to perform other virtualized applications, such as virtualized applications for various elements discussed herein.

The UEs 1310 may utilize respective connections (or channels) 1303a, each of which comprises a physical communications interface or layer. The connections 1303a are illustrated as an air interface to enable communicative coupling consistent with cellular communications protocols, such as 3GPP LTE, 5G/NR, Push-to-Talk (PTT) and/or PTT over cellular (POC), UMTS, GSM, CDMA, and/or any of the other communications protocols discussed herein. Additionally or alternatively, the UEs 1310 and the NANs 1330 communicate data (e.g, transmit and receive) data over a licensed medium (also referred to as the “licensed spectrum” and/or the “licensed band”) and an unlicensed shared medium (also referred to as the “unlicensed spectrum” and/or the “unlicensed band”). To operate in the unlicensed spectrum, the UEs 1310 and NANs 1330 may operate using LAA, enhanced LAA (eLAA), and/or further eLAA (feLAA) mechanisms. The UEs 1310 may further directly exchange communication data via respective direct links 1305, which may be LTE/NR Proximity Services (ProSe) link or PC5 interfaces/links, or WiFi based links or a personal area network (PAN) based links (e.g, [IEEE802154] based protocols including ZigBee, IPv6 over Low power Wireless Personal Area Networks (6LoWPAN), WirelessHART, MiWi, Thread, and/or the like; WiFi-direct; Bluetooth/Bluetooth Low Energy (BLE) protocols).

Additionally or alternatively, individual UEs 1310 provide radio information to one or more NANs 1330 and/or one or more edge compute nodes 1336 (e.g, edge servers/hosts, and/or the like). The radio information may be in the form of one or more measurement reports, and/or may include, for example, signal strength measurements, signal quality measurements, and/or the like. Each measurement report is tagged with a timestamp and the location of the measurement (e.g, the UEs 1310 current location). As examples, the measurements collected by the UEs 1310 and/or included in the measurement reports may include one or more of the following: bandwidth (BW), network or cell load, latency, jitter, round trip time (RTT), number of interrupts, out-of-order delivery of data packets, transmission power, bit error rate, bit error ratio (BER), Block Error Rate (BLER), packet error ratio (PER), packet loss rate, packet reception rate (PRR), data rate, peak data rate, end-to-end (e2e) delay, signal-to-noise ratio (SNR), signal-to-noise and interference ratio (SINR), signal-plus-noise-plus-distortion to noise-plus-distortion (SINAD) ratio, carrier-to-interference plus noise ratio (CINR), Additive White Gaussian Noise (AWGN), energy per bit to noise power density ratio (Eb/NO), energy per chip to interference power density ratio (Ec/I0), energy per chip to noise power density ratio (Ec/NO), peak-to-average power ratio (PAPR), reference signal received power (RSRP), reference signal received quality (RSRQ), received signal strength indicator (RSSI), received channel power indicator (RCPI), received signal to noise indicator (RSNI), Received Signal Code Power (RSCP), average noise plus interference (ANPI), GNSS timing of cell frames for UE positioning for E-UTRAN or 5G/NR (e.g, a timing between an AP or RAN node reference time and a GNSS-specific reference time for a given GNSS), GNSS code measurements (e.g, the GNSS code phase (integer and fractional parts) of the spreading code of the ith GNSS satellite signal), GNSS carrier phase measurements (e.g, the number of carrier-phase cycles (integer and fractional parts) of the ith GNSS satellite signal, measured since locking onto the signal; also called Accumulated Delta Range (ADR)), channel interference measurements, thermal noise power measurements, received interference power measurements, power histogram measurements, channel load measurements, STA statistics, and/or other like measurements. The RSRP, RSSI, and/or RSRQ measurements may include RSRP, RSSI, and/or RSRQ measurements of cell-specific reference signals, channel state information reference signals (CSI-RS), and/or synchronization signals (SS) or SS blocks for 3GPP networks (e.g, LTE or 5G/NR), and RSRP, RSSI, RSRQ, RCPI, RSNI, and/or ANPI measurements of various beacon, Fast Initial Link Setup (FILS) discovery frames, or probe response frames for WLAN/WiFi (e.g, [IEEE80211]) networks. Other measurements may be additionally or alternatively used, such as those discussed in 3GPP TS 36.214 v16.2.0 (2021-03-31) (“[TS36214]”), 3GPP TS 38.215 v16.4.0 (2021-01-08) (“[TS38215]”), 3GPP TS 38.314 v16.4.0 (2021-09-30) (“[TS38314]”), IEEE Standard for Information Technology—Telecommunications and Information Exchange between Systems—Local and Metropolitan Area Networks—Specific Requirements—Part 11: Wireless LAN Medium Access Control (MAC) and Physical Layer (PHY) Specifications, IEEE Std 802.11-2020, pp. 1-4379 (26 Feb. 2021) (“[IEEE80211]”), and/or the like. Additionally or alternatively, any of the aforementioned measurements (or combination of measurements) may be collected by one or more NANs 1330 and provided to the edge compute node(s) 1336.

Additionally or alternatively, the measurements can include one or more of the following measurements: measurements related to Data Radio Bearer (DRB) (e.g, number of DRBs attempted to setup, number of DRBs successfully setup, number of released active DRBs, in-session activity time for DRB, number of DRBs attempted to be resumed, number of DRBs successfully resumed, and/or the like); measurements related to Radio Resource Control (RRC) (e.g, mean number of RRC connections, maximum number of RRC connections, mean number of stored inactive RRC connections, maximum number of stored inactive RRC connections, number of attempted, successful, and/or failed RRC connection establishments, and/or the like); measurements related to UE Context (UECNTX); measurements related to Radio Resource Utilization (RRU) (e.g, DL total PRB usage, UL total PRB usage, distribution of DL total PRB usage, distribution of UL total PRB usage, DL PRB used for data traffic, UL PRB used for data traffic, DL total available PRBs, UL total available PRBs, and/or the like); measurements related to Registration Management (RM); measurements related to Session Management (SM) (e.g, number of PDU sessions requested to setup; number of PDU sessions successfully setup; number of PDU sessions failed to setup, and/or the like); measurements related to GTP Management (GTP); measurements related to IP Management (IP); measurements related to Policy Association (PA); measurements related to Mobility Management (MM) (e.g, for inter-RAT, intra-RAT, and/or Intra/Inter-frequency handovers and/or conditional handovers: number of requested, successful, and/or failed handover preparations; number of requested, successful, and/or failed handover resource allocations; number of requested, successful, and/or failed handover executions; mean and/or maximum time of requested handover executions; number of successful and/or failed handover executions per beam pair, and/or the like); measurements related to Virtualized Resource(s) (VR); measurements related to Carrier (CARR); measurements related to QoS Flows (QF) (e.g, number of released active QoS flows, number of QoS flows attempted to release, in-session activity time for QoS flow, in-session activity time for a UE 1310, number of QoS flows attempted to setup, number of QoS flows successfully established, number of QoS flows failed to setup, number of initial QoS flows attempted to setup, number of initial QoS flows successfully established, number of initial QoS flows failed to setup, number of QoS flows attempted to modify, number of QoS flows successfully modified, number of QoS flows failed to modify, and/or the like); measurements related to Application Triggering (AT); measurements related to Short Message Service (SMS); measurements related to Power, Energy and Environment (PEE); measurements related to NF service (NFS); measurements related to Packet Flow Description (PFD); measurements related to Random Access Channel (RACH); measurements related to Measurement Report (MR); measurements related to Layer 1 Measurement (LIM); measurements related to Network Slice Selection (NSS); measurements related to Paging (PAG); measurements related to Non-IP Data Delivery (NIDD); measurements related to external parameter provisioning (EPP); measurements related to traffic influence (TI); measurements related to Connection Establishment (CE); measurements related to Service Parameter Provisioning (SPP); measurements related to Background Data Transfer Policy (BDTP); measurements related to Data Management (DM); and/or any other performance measurements such as those discussed in 3GPP TS 28.552 v17.3.1 (2021-06-24) (“[TS28552]”), 3GPP TS 32.425 v17.1.0 (2021-06-24) (“[TS32425]”), and/or the like.

The radio information may be reported in response to a trigger event and/or on a periodic basis. Additionally or alternatively, individual UEs 1310 report radio information either at a low periodicity or a high periodicity depending on a data transfer that is to take place, and/or other information about the data transfer. Additionally or alternatively, the edge compute node(s) 1336 may request the measurements from the NANs 1330 at low or high periodicity, or the NANs 1330 may provide the measurements to the edge compute node(s) 1336 at low or high periodicity. Additionally or alternatively, the edge compute node(s) 1336 may obtain other relevant data from other edge compute node(s) 1336, core network functions (NFs), application functions (AFs), and/or other UEs 1310 such as Key Performance Indicators (KPIs), with the measurement reports or separately from the measurement reports.

Additionally or alternatively, in cases where is discrepancy in the observation data from one or more UEs, one or more RAN nodes, and/or core network NFs (e.g, missing reports, erroneous data, and/or the like) simple imputations may be performed to supplement the obtained observation data such as, for example, substituting values from previous reports and/or historical data, apply an extrapolation filter, and/or the like. Additionally or alternatively, acceptable bounds for the observation data may be predetermined or configured. For example, CQI and MCS measurements may be configured to only be within ranges defined by suitable 3GPP standards. In cases where a reported data value does not make sense (e.g, the value exceeds an acceptable range/bounds, or the like), such values may be dropped for the current learning/training episode or epoch. For example, on packet delivery delay bounds may be defined or configured, and packets determined to have been received after the packet delivery delay bound may be dropped.

In any of the examples discussed herein, any suitable data collection and/or measurement mechanism(s) may be used to collect the observation data. For example, data marking (e.g, sequence numbering, and/or the like), packet tracing, signal measurement, data sampling, and/or timestamping techniques may be used to determine any of the aforementioned metrics/observations. The collection of data may be based on occurrence of events that trigger collection of the data. Additionally or alternatively, data collection may take place at the initiation or termination of an event. The data collection can be continuous, discontinuous, and/or have start and stop times. The data collection techniques/mechanisms may be specific to a HW configuration/implementation or non-HW-specific, or may be based on various software parameters (e.g, OS type and version, and/or the like). Various configurations may be used to define any of the aforementioned data collection parameters. Such configurations may be defined by suitable specifications/standards, such as 3GPP (e.g, [SA6Edge]), ETSI (e.g, [MEC]), O-RAN (e.g, [O-RAN]), Intel® Smart Edge Open (formerly OpenNESS) (e.g, [ISEO]), IETF (e.g, [MAMS]), IEEE/WiFi (e.g, [IEEE80211], [WiMAX], [IEEE16090], and/or the like), and/or any other like standards such as those discussed herein.

The UE 1312b is shown as being capable of accessing access point (AP) 1333 via a connection 1303b. In this example, the AP 1333 is shown to be connected to the Internet without connecting to the CN 1342 of the wireless system. The connection 1303b can comprise a local wireless connection, such as a connection consistent with any IEEE 802.11 protocol (e.g, [IEEE80211] and variants thereof), wherein the AP 1333 would comprise a WiFi router. Additionally or alternatively, the UEs 1310 can be configured to communicate using suitable communication signals with each other or with any of the AP 1333 over a single or multicarrier communication channel in accordance with various communication techniques, such as, but not limited to, an OFDM communication technique, a single-carrier frequency division multiple access (SC-FDMA) communication technique, and/or the like, although the scope of the present disclosure is not limited in this respect. The communication technique may include a suitable modulation scheme such as Complementary Code Keying (CCK); Phase-Shift Keying (PSK) such as Binary PSK (BPSK), Quadrature PSK (QPSK), Differential PSK (DPSK), and/or the like; or Quadrature Amplitude Modulation (QAM) such as M-QAM; and/or the like.

The one or more NANs 1331 and 1332 that enable the connections 1303a may be referred to as “RAN nodes” or the like. The RAN nodes 1331, 1332 may comprise ground stations (e.g, terrestrial access points) or satellite stations providing coverage within a geographic area (e.g, a cell). The RAN nodes 1331, 1332 may be implemented as one or more of a dedicated physical device such as a macrocell base station, and/or a low power base station for providing femtocells, picocells or other like cells having smaller coverage areas, smaller user capacity, or higher bandwidth compared to macrocells. In this example, the RAN node 1331 is embodied as a NodeB, evolved NodeB (eNB), or a next generation NodeB (gNB), and the RAN nodes 1332 are embodied as relay nodes, distributed units, or Road Side Unites (RSUs). Any other type of NANs can be used.

Any of the RAN nodes 1331, 1332 can terminate the air interface protocol and can be the first point of contact for the UEs 1312 and IoT devices 1311. Additionally or alternatively, any of the RAN nodes 1331, 1332 can fulfill various logical functions for the RAN including, but not limited to, RAN function(s) (e.g, radio network controller (RNC) functions and/or NG-RAN functions) for radio resource management, admission control, UL and DL dynamic resource allocation, radio bearer management, data packet scheduling, and/or the like. Additionally or alternatively, the UEs 1310 can be configured to communicate using OFDM communication signals with each other or with any of the NANs 1331, 1332 over a multicarrier communication channel in accordance with various communication techniques, such as, but not limited to, an OFDMA communication technique (e.g, for DL communications) and/or an SC-FDMA communication technique (e.g, for UL and ProSe or sidelink communications), although the scope of the present disclosure is not limited in this respect.

For most cellular communication systems, the RAN function(s) operated by the RAN or individual NANs 1331-1332 organize DL transmissions (e.g, from any of the RAN nodes 1331, 1332 to the UEs 1310) and UL transmissions (e.g, from the UEs 1310 to RAN nodes 1331, 1332) into radio frames (or simply “frames”) with 10 millisecond (ms) durations, where each frame includes ten 1 ms subframes. Each transmission direction has its own resource grid that indicate physical resource in each slot, where each column and each row of a resource grid corresponds to one symbol and one subcarrier, respectively. The duration of the resource grid in the time domain corresponds to one slot in a radio frame. The resource grids comprises a number of resource blocks (RBs), which describe the mapping of certain physical channels to resource elements (REs). Each RB may be a physical RB (PRB) or a virtual RB (VRB) and comprises a collection of REs. An RE is the smallest time-frequency unit in a resource grid. The RNC function(s) dynamically allocate resources (e.g, PRBs and modulation and coding schemes (MCS)) to each UE 1310 at each transmission time interval (TTI). A TTI is the duration of a transmission on a radio link 1303a, 1305, and is related to the size of the data blocks passed to the radio link layer from higher network layers.

The NANs 1331, 1332 may be configured to communicate with one another via respective interfaces or links (not shown), such as an X2 interface for LTE implementations (e.g, when CN 1342 is an Evolved Packet Core (EPC)), an Xn interface for 5G or NR implementations (e.g, when CN 1342 is an Fifth Generation Core (5GC)), or the like. The NANs 1331 and 1332 are also communicatively coupled to CN 1342. Additionally or alternatively, the CN 1342 may be an evolved packet core (EPC) 922, a NextGen Packet Core (NPC), a 5G core (5GC) 940, and/or some other type of CN. The CN 1342 is a network of network elements and/or network functions (NFs) relating to a part of a communications network that is independent of the connection technology used by a terminal or user device. The CN 1342 comprises a plurality of network elements/NFs configured to offer various data and telecommunications services to customers/subscribers (e.g, users of UEs 1312 and IoT devices 1311) who are connected to the CN 1342 via a RAN. The components of the CN 1342 may be implemented in one physical node or separate physical nodes including components to read and execute instructions from a machine-readable or computer-readable medium (e.g, a non-transitory machine-readable storage medium). Additionally or alternatively, Network Functions Virtualization (NFV) may be utilized to virtualize any or all of the above-described network node functions via executable instructions stored in one or more computer-readable storage mediums (described in further detail infra). A logical instantiation of the CN 1342 may be referred to as a network slice, and a logical instantiation of a portion of the CN 1342 may be referred to as a network sub-slice. NFV architectures and infrastructures may be used to virtualize one or more network functions, alternatively performed by proprietary hardware, onto physical resources comprising a combination of industry-standard server hardware, storage hardware, or switches. In other words, NFV systems can be used to execute virtual or reconfigurable implementations of one or more CN 1342 components/functions.

The CN 1342 is shown to be communicatively coupled to an application server 1350 and a network 1350 via an IP communications interface 1355. the one or more server(s) 1350 comprise one or more physical and/or virtualized systems for providing functionality (or services) to one or more clients (e.g, UEs 1312 and IoT devices 1311) over a network. The server(s) 1350 may include various computer devices with rack computing architecture component(s), tower computing architecture component(s), blade computing architecture component(s), and/or the like. The server(s) 1350 may represent a cluster of servers, a server farm, a cloud computing service, or other grouping or pool of servers, which may be located in one or more datacenters. The server(s) 1350 may also be connected to, or otherwise associated with one or more data storage devices (not shown). Moreover, the server(s) 1350 may include an operating system (OS) that provides executable program instructions for the general administration and operation of the individual server computer devices, and may include a computer-readable medium storing instructions that, when executed by a processor of the servers, may allow the servers to perform their intended functions. Suitable implementations for the OS and general functionality of servers are known or commercially available, and are readily implemented by persons having ordinary skill in the art. Generally, the server(s) 1350 offer applications or services that use IP/network resources. As examples, the server(s) 1350 may provide traffic management services, cloud analytics, content streaming services, immersive gaming experiences, social networking and/or microblogging services, and/or other like services. In addition, the various services provided by the server(s) 1350 may include initiating and controlling software and/or firmware updates for applications or individual components implemented by the UEs 1312 and IoT devices 1311. The server(s) 1350 can also be configured to support one or more communication services (e.g, Voice-over-Internet Protocol (VoIP) sessions, PTT sessions, group communication sessions, social networking services, and/or the like) for the UEs 1312 and IoT devices 1311 via the CN 1342.

The Radio Access Technologies (RATs) employed by the NANs 1330, the UEs 1310, and the other elements in FIG. 13 may include, for example, any of the communication protocols and/or RATs discussed herein. Different technologies exhibit benefits and limitations in different scenarios, and application performance in different scenarios becomes dependent on the choice of the access networks (e.g, WiFi, LTE, and/or the like) and the used network and transport protocols (e.g, Transfer Control Protocol (TCP), Virtual Private Network (VPN), Multi-Path TCP (MPTCP), Generic Routing Encapsulation (GRE), and/or the like). These RATs may include one or more V2X RATs, which allow these elements to communicate directly with one another, with infrastructure equipment (e.g, NANs 1330), and other devices. In some implementations, at least two distinct V2X RATs may be used including WLAN V2X (W-V2X) RAT based on IEEE V2X technologies (e.g, DSRC for the U.S. and ITS-G5 for Europe) and 3GPP C-V2X RAT (e.g, LTE, 5G/NR, and beyond). In one example, the C-V2X RAT may utilize a C-V2X air interface and the WLAN V2X RAT may utilize an W-V2X air interface.

The W-V2X RATs include, for example, IEEE Guide for Wireless Access in Vehicular Environments (WAVE) Architecture, IEEE STANDARDS ASSOCIATION, IEEE 1609.0-2019 (10 Apr. 2019) (“[IEEE16090]”), V2X Communications Message Set Dictionary, SAE INT'L (23 Jul. 2020) (“[J2735_202007]”), Intelligent Transport Systems in the 5 GHz frequency band (ITS-G5), the [IEEE80211p] (which is the layer 1 (L1) and layer 2 (L2) part of WAVE, DSRC, and ITS-G5), and/or IEEE Standard for Air Interface for Broadband Wireless Access Systems, IEEE Std 802.16-2017, pp. 1-2726 (2 Mar. 2018) (“[WiMAX]”). The term “DSRC” refers to vehicular communications in the 5.9 GHz frequency band that is generally used in the United States, while “ITS-G5” refers to vehicular communications in the 5.9 GHz frequency band in Europe. Since any number of different RATs are applicable (including [IEEE80211p] RATs) that may be used in any geographic or political region, the terms “DSRC” (used, among other regions, in the U.S) and “ITS-G5” (used, among other regions, in Europe) may be used interchangeably throughout this disclosure. The access layer for the ITS-G5 interface is outlined in ETSI EN 302 663 V1.3.1(2020-01) (hereinafter “[EN302663]”) and describes the access layer of the ITS-S reference architecture. The ITS-G5 access layer comprises [IEEE80211] (which now incorporates [IEEE80211p]), as well as features for Decentralized Congestion Control (DCC) methods discussed in ETSI TS 102 687 V1.2.1 (2018-04) (“[TS102687]”). The access layer for 3GPP LTE-V2X based interface(s) is outlined in, inter alia, ETSI EN 303 613 V1.1.1 (2020-01), 3GPP TS 23.285 v16.2.0 (2019-12); and 3GPP 5G/NR-V2X is outlined in, inter alia, 3GPP TR 23.786 v16.1.0 (2019-06) and 3GPP TS 23.287 v16.2.0 (2020-03).

The cloud 1344 may represent a cloud computing architecture/platform that provides one or more cloud computing services. Cloud computing refers to a paradigm for enabling network access to a scalable and elastic pool of shareable computing resources with self-service provisioning and administration on-demand and without active management by users. Computing resources (or simply “resources”) are any physical or virtual component, or usage of such components, of limited availability within a computer system or network. Examples of resources include usage/access to, for a period of time, servers, processor(s), storage equipment, memory devices, memory areas, networks, electrical power, input/output (peripheral) devices, mechanical devices, network connections (e.g, channels/links, ports, network sockets, and/or the like), operating systems, virtual machines (VMs), software/applications, computer files, and/or the like. Cloud computing provides cloud computing services (or cloud services), which are one or more capabilities offered via cloud computing that are invoked using a defined interface (e.g, an API or the like). Some capabilities of cloud 1344 include application capabilities type, infrastructure capabilities type, and platform capabilities type. A cloud capabilities type is a classification of the functionality provided by a cloud service to a cloud service customer (e.g, a user of cloud 1344), based on the resources used. The application capabilities type is a cloud capabilities type in which the cloud service customer can use the cloud service provider's applications; the infrastructure capabilities type is a cloud capabilities type in which the cloud service customer can provision and use processing, storage or networking resources; and platform capabilities type is a cloud capabilities type in which the cloud service customer can deploy, manage and run customer-created or customer-acquired applications using one or more programming languages and one or more execution environments supported by the cloud service provider. Cloud services may be grouped into categories that possess some common set of qualities. Some cloud service categories that the cloud 1344 may provide include, for example, Communications as a Service (CaaS), which is a cloud service category involving real-time interaction and collaboration services; Compute as a Service (CompaaS), which is a cloud service category involving the provision and use of processing resources needed to deploy and run software; Database as a Service (DaaS), which is a cloud service category involving the provision and use of database system management services; Data Storage as a Service (DSaaS), which is a cloud service category involving the provision and use of data storage and related capabilities; Firewall as a Service (FaaS), which is a cloud service category involving providing firewall and network traffic management services; Infrastructure as a Service (IaaS), which is a cloud service category involving infrastructure capabilities type; Network as a Service (NaaS), which is a cloud service category involving transport connectivity and related network capabilities; Platform as a Service (PaaS), which is a cloud service category involving the platform capabilities type; Software as a Service (SaaS), which is a cloud service category involving the application capabilities type; Security as a Service, which is a cloud service category involving providing network and information security (infosec) services; and/or other like cloud services.

Additionally or alternatively, the cloud 1344 may represent one or more cloud servers, application servers, web servers, and/or some other remote infrastructure. The remote/cloud servers may include any one of a number of services and capabilities such as, for example, any of those discussed herein. Additionally or alternatively, the cloud 1344 may represent a network such as the Internet, a local area network (LAN), a wide area network (WAN), a wireless local area network (WLAN), or a wireless wide area network (WWAN) including proprietary and/or enterprise networks for a company or organization, or combinations thereof. The cloud 1344 may be a network that comprises computers, network connections among the computers, and software routines to enable communication between the computers over network connections. In this regard, the cloud 1344 comprises one or more network elements that may include one or more processors, communications systems (e.g, including network interface controllers, one or more transmitters/receivers connected to one or more antennas, and/or the like), and computer readable media. Examples of such network elements may include wireless access points (WAPs), home/business servers (with or without RF communications circuitry), routers, switches, hubs, radio beacons, base stations, picocell or small cell base stations, backbone gateways, and/or any other like network device. Connection to the cloud 1344 may be via a wired or a wireless connection using the various communication protocols discussed infra. More than one network may be involved in a communication session between the illustrated devices. Connection to the cloud 1344 may require that the computers execute software routines which enable, for example, the seven layers of the OSI model of computer networking or equivalent in a wireless (cellular) phone network. Cloud 1344 may be used to enable relatively long-range communication such as, for example, between the one or more server(s) 1350 and one or more UEs 1310. Additionally or alternatively, the cloud 1344 may represent the Internet, one or more cellular networks, local area networks, or wide area networks including proprietary and/or enterprise networks, TCP/Internet Protocol (IP)-based network, or combinations thereof. In these implementations, the cloud 1344 may be associated with network operator who owns or controls equipment and other elements necessary to provide network-related services, such as one or more base stations or access points, one or more servers for routing digital data or telephone calls (e.g, a core network or backbone network), and/or the like. The backbone links 1355 may include any number of wired or wireless technologies, and may be part of a LAN, a WAN, or the Internet. In one example, the backbone links 1355 are fiber backbone links that couple lower levels of service providers to the Internet, such as the CN 1312 and cloud 1344.

As shown by FIG. 13, each of the NANs 1331, 1332, and 1333 are co-located with edge compute nodes (or “edge servers”) 1336a, 1336b, and 1336c, respectively. These implementations may be small-cell clouds (SCCs) where an edge compute node 1336 is co-located with a small cell (e.g, pico-cell, femto-cell, and/or the like), or may be mobile micro clouds (MCCs) where an edge compute node 1336 is co-located with a macro-cell (e.g, an eNB, gNB, and/or the like). The edge compute node 1336 may be deployed in a multitude of arrangements other than as shown by FIG. 13. In a first example, multiple NANs 1330 are co-located or otherwise communicatively coupled with one edge compute node 1336. In a second example, the edge servers 1336 may be co-located or operated by RNCs, which may be the case for legacy network deployments, such as 3G networks. In a third example, the edge servers 1336 may be deployed at cell aggregation sites or at multi-RAT aggregation points that can be located either within an enterprise or used in public coverage areas. In a fourth example, the edge servers 1336 may be deployed at the edge of CN 1342. These implementations may be used in follow-me clouds (FMC), where cloud services running at distributed data centers follow the UEs 1310 as they roam throughout the network.

In any of the implementations discussed herein, the edge servers 1336 provide a distributed computing environment for application and service hosting, and also provide storage and processing resources so that data and/or content can be processed in close proximity to subscribers (e.g, users of UEs 1310) for faster response times The edge servers 1336 also support multitenancy run-time and hosting environment(s) for applications, including virtual appliance applications that may be delivered as packaged virtual machine (VM) images, middleware application and infrastructure services, content delivery services including content caching, mobile big data analytics, and computational offloading, among others. Computational offloading involves offloading computational tasks, workloads, applications, and/or services to the edge servers 1336 from the UEs 1310, CN 1342, cloud 1344, and/or server(s) 1350, or vice versa. For example, a device application or client application operating in a UE 1310 may offload application tasks or workloads to one or more edge servers 1336. In another example, an edge server 1336 may offload application tasks or workloads to one or more UE 1310 (e.g, for distributed ML computation or the like).

The edge compute nodes 1336 may include or be part of an edge system 1335 that employs one or more ECTs 1335. The edge compute nodes 1336 may also be referred to as “edge hosts 1336” or “edge servers 1336.” The edge system 1335 includes a collection of edge servers 1336 and edge management systems (not shown by FIG. 13) necessary to run edge computing applications within an operator network or a subset of an operator network. The edge servers 1336 are physical computer systems that may include an edge platform and/or virtualization infrastructure, and provide compute, storage, and network resources to edge computing applications. Each of the edge servers 1336 are disposed at an edge of a corresponding access network, and are arranged to provide computing resources and/or various services (e.g, computational task and/or workload offloading, cloud-computing capabilities, IT services, and other like resources and/or services as discussed herein) in relatively close proximity to UEs 1310. The VI of the edge servers 1336 provide virtualized environments and virtualized resources for the edge hosts, and the edge computing applications may run as VMs and/or application containers on top of the VI.

In one example implementation, the ECT 1335 is and/or operates according to the MEC framework, as discussed in ETSI GR MEC 001 v3.1.1 (2022-01), ETSI GS MEC 003 v3.1.1 (2022-03), ETSI GS MEC 009 v3.1.1 (2021-06), ETSI GS MEC 010-1 v1.1.1 (2017-10), ETSI GS MEC 010-2 v2.2.1 (2022-02), ETSI GS MEC 011 v2.2.1(2020-12), ETSI GS MEC 012 V2.2.1 (2022-02), ETSI GS MEC 013 V2.2.1 (2022-01), ETSI GS MEC 014 v2.1.1 (2021-03), ETSI GS MEC 015 v2.1.1 (2020-06), ETSI GS MEC 016 v2.2.1 (2020-04), ETSI GS MEC 021 v2.2.1 (2022-02), ETSI GR MEC 024 v2.1.1 (2019-11), ETSI GS MEC 028 V2.2.1 (2021-07), ETSI GS MEC 029 v2.2.1 (2022-01), ETSI MEC GS 030 v2.1.1 (2020-04), ETSI GR MEC 031 v2.1.1 (2020-10), U.S. Provisional App. No. 63/003,834 filed Apr. 1, 2020 (“[US'834]”), and Int'l App. No. PCT/US2020/066969 filed on Dec. 23, 2020 (“[PCT'696]”) (collectively referred to herein as “[MEC]”), the contents of each of which are hereby incorporated by reference in their entireties. This example implementation (and/or in any other example implementation discussed herein) may also include NFV and/or other like virtualization technologies such as those discussed in ETSI GR NFV 001 V1.3.1 (2021-03), ETSI GS NFV 002 V1.2.1 (2014-12), ETSI GR NFV 003 V1.6.1 (2021-03), ETSI GS NFV 006 V2.1.1 (2021-01), ETSI GS NFV-INF 001 V1.1.1 (2015-01), ETSI GS NFV-INF 003 V1.1.1 (2014-12), ETSI GS NFV-INF 004 V1.1.1 (2015-01), ETSI GS NFV-MAN 001 v1.1.1 (2014-12), and/or Israel et al, OSM Release FIVE Technical Overview, ETSI OPEN SOURCE MANO, OSM White Paper, 1st ed. (January 2019), https://osm.etsi.org/images/OSM-Whitepaper-TechContent-ReleaseFIVE-FINAL.pdf (collectively referred to as “[ETSINFV]”), the contents of each of which are hereby incorporated by reference in their entireties. Other virtualization technologies and/or service orchestration and automation platforms may be used such as, for example, those discussed in E2E Network Slicing Architecture, GSMA, Official Doc. NG.127, v1.0 (3 Jun. 2021), https://www.gsma.com/newsroom/wp-content/uploads//NG.127-v1.0-2.pdf, Open Network Automation Platform (ONAP) documentation, Release Istanbul, v9.0.1 (17 Feb. 2022), https://docs.onap.org/en/latest/index.html (“[ONAP]”), 3GPP Service Based Management Architecture (SBMA) as discussed in 3GPP TS 28.533 v17.1.0 (2021-12-23) (“[TS28533]”), the contents of each of which are hereby incorporated by reference in their entireties.

In another example implementation, the ECT 1335 is and/or operates according to the O-RAN framework. Typically, front-end and back-end device vendors and carriers have worked closely to ensure compatibility. The flip-side of such a working model is that it becomes quite difficult to plug-and-play with other devices and this can hamper innovation. To combat this, and to promote openness and inter-operability at every level, several key players interested in the wireless domain (e.g, carriers, device manufacturers, academic institutions, and/or the like) formed the Open RAN alliance (“O-RAN”) in 2018. The O-RAN network architecture is a building block for designing virtualized RAN on programmable hardware with radio access control powered by AI. Various aspects of the O-RAN architecture are described in O-RAN Architecture Description v05.00, O-RAN ALLIANCE WG1 (July 2021); O-RAN Operations and Maintenance Architecture Specification v04.00, O-RAN ALLIANCE WG1 (November 2020); O-RAN Operations and Maintenance Interface Specification v04.00, O-RAN ALLIANCE WG1 (November 2020); O-RAN Information Model and Data Models Specification v01.00, O-RAN ALLIANCE WG1 (November 2020); O-RAN Working Group 1 Slicing Architecture v05.00, O-RAN ALLIANCE WG1 (July 2021) (“[O-RAN.WG1.Slicing-Architecture]”); O-RAN Working Group 2 (Non-RT RIC and A1 interface WG) A1 interface: Application Protocol v03.01, O-RAN ALLIANCE WG2 (March 2021); O-RAN Working Group 2 (Non-RT RIC and A1 interface WG) A1 interface: Type Definitions v02.00, O-RAN ALLIANCE WG2 (July 2021); O-RAN Working Group 2 (Non-RT RIC and A1 interface WG) A1 interface: Transport Protocol v01.01, O-RAN ALLIANCE WG2 (March 2021); O-RAN Working Group 2 AI/ML workflow description and requirements v01.03 O-RAN ALLIANCE WG2 (July 2021); O-RAN Working Group 2 Non-RT RIC: Functional Architecture v01.03 O-RAN ALLIANCE WG2 (July 2021); O-RAN Working Group 3, Near-Real-time Intelligent Controller, E2 Application Protocol (E2AP) v02.00, O-RAN ALLIANCE WG3 (July 2021); O-RAN Working Group 3 Near-Real-time Intelligent Controller Architecture & E2 General Aspects and Principles v02.00, O-RAN ALLIANCE WG3 (July 2021); O-RAN Working Group 3 Near-Real-time Intelligent Controller E2 Service Model (E2SM) v02.00, O-RAN ALLIANCE WG3 (July 2021); O-RAN Working Group 3 Near-Real-time Intelligent Controller E2 Service Model (E2SM) KPM v02.00, O-RAN ALLIANCE WG3 (July 2021); O-RAN Working Group 3 Near-Real-time Intelligent Controller E2 Service Model (E2SM) RAN Function Network Interface (NI) v01.00, O-RAN ALLIANCE WG3 (February 2020); O-RAN Working Group 3 Near-Real-time Intelligent Controller E2 Service Model (E2SM) RAN Control v01.00, O-RAN ALLIANCE WG3 (July 2021); O-RAN Working Group 3 Near-Real-time Intelligent Controller Near-RT RIC Architecture v02.00, O-RAN ALLIANCE WG3 (March 2021); O-RAN Fronthaul Working Group 4 Cooperative Transport Interface Transport Control Plane Specification v02.00, O-RAN ALLIANCE WG4 (March 2021); O-RAN Fronthaul Working Group 4 Cooperative Transport Interface Transport Management Plane Specification v02.00, O-RAN ALLIANCE WG4 (March 2021); O-RAN Fronthaul Working Group 4 Control, User, and Synchronization Plane Specification v07.00, O-RAN ALLIANCE WG4 (July 2021) (“[O-RAN.WG4.CUS]”); O-RAN Fronthaul Working Group 4 Management Plane Specification v07.00, O-RAN ALLIANCE WG4 (July 2021); O-RAN Open F1/W1/E1/X2/Xn Interfaces Working Group Transport Specification v01.00, O-RAN ALLIANCE WG5 (April 2020); O-RAN Alliance Working Group 5 O1 Interface specification for O-DU v02.00, O-RAN ALLIANCE WGX (July 2021); Cloud Architecture and Deployment Scenarios for O-RAN Virtualized RAN v02.02, O-RAN ALLIANCE WG6 (July 2021); O-RAN Acceleration Abstraction Layer General Aspects and Principles v01.01, O-RAN ALLIANCE WG6 (July 2021); Cloud Platform Reference Designs v02.00, O-RAN ALLIANCE WG6 (November 2020); O-RAN O2 Interface General Aspects and Principles v01.01, O-RAN ALLIANCE WG6 (July 2021); O-RAN White Box Hardware Working Group Hardware Reference Design Specification for Indoor Pico Cell with Fronthaul Split Option 6 v02.00, O-RAN ALLIANCE WG7 (July 2021) (“[O-RAN.WG7.IPC-HRD-Opt6]”); O-RAN WG7 Hardware Reference Design Specification for Indoor Picocell (FR1) with Split Option 7-2 v03.00, O-RAN ALLIANCE WG7 (July 2021) (“[O-RAN.WG7.IPC-HRD-Opt7]”); O-RAN WG7 Hardware Reference Design Specification for Indoor Picocell (FR1) with Split Option 8 v03.00, O-RAN ALLIANCE WG7 (July 2021) (“[O-RAN.WG7.IPC-HRD-Opt8]”); O-RAN Open Transport Working Group 9 Xhaul Packet Switched Architectures and Solutions v02.00, O-RAN ALLIANCE WG9 (July 2021) (“[ORAN-WG9.XPAAS]”); O-RAN Open X-haul Transport Working Group Management interfaces for Transport Network Elements v02.00, O-RAN ALLIANCE WG9 (July 2021) (“[ORAN-WG9.XTRP-MGT]”); O-RAN Open X-haul Transport WG9 WDM-based Fronthaul Transport v01.00, O-RAN ALLIANCE WG9 (November 2020) (“[ORAN-WG9.WDM]”); O-RAN Open X-haul Transport Working Group Synchronization Architecture and Solution Specification v01.00, O-RAN ALLIANCE WG9 (March 2021) (“[ORAN-WG9.XTRP-SYN]”); O-RAN Operations and Maintenance Interface Specification v05.00, O-RAN ALLIANCE WG10 (July 2021); O-RAN Operations and Maintenance Architecture v05.00, O-RAN ALLIANCE WG10 (July 2021); O-RAN: Towards an Open and Smart RAN, O-RAN ALLIANCE, White Paper (October 2018), https://static1.squarespace.com/static/5ad774cce74940d7115044b0/t/5bc79b371905f4197055e8c 6/1539808057078/O-RAN+WP+FInal+181017.pdf (“[ORANWP]”), and U.S. application Ser. No. 17/484,743 filed on 24 Sep. 2021 (“[US'743]”) (collectively referred to as “[O-RAN]”); the contents of each of which are hereby incorporated by reference in their entireties.

In another example implementation, the ECT 1335 operates according to the 3rd Generation Partnership Project (3GPP) System Aspects Working Group 6 (SA6) Architecture for enabling Edge Applications (referred to as “3GPP edge computing”) as discussed in 3GPP TS 23.558 v17.3.0 (2022-03-23) (“[TS23558]”), 3GPP TS 23.501 v17.4.0 (2022-03-23) (“[TS23501]”), and U.S. application Ser. No. 17/484,719 filed on 24 Sep. 2021 (“[US'719]”) (collectively referred to as “[SA6Edge]”), the contents of each of which is hereby incorporated by reference in their entireties.

In another example implementation, the ECT 1335 is and/or operates according to the Intel® Smart Edge Open framework (formerly known as OpenNESS) as discussed in Intel® Smart Edge Open Developer Guide, version 21.09 (30 Sep. 2021), available at: https://smart-edge-open.github.io/(“[ISEO]”), the contents of which is hereby incorporated by reference in its entirety.

In another example implementation, the ECT 1335 operates according to the Multi-Access Management Services (MAMS) framework as discussed in Kanugovi et al., Multi-Access Management Services (MAMS), INTERNET ENGINEERING TASK FORCE (IETF), Request for Comments (RFC) 8743 (March 2020) (“[RFC8743]”), Ford et al., TCP Extensions for Multipath Operation with Multiple Addresses, IETF RFC 8684, (March 2020), De Coninck et al., Multipath Extensions for QUIC (MP-QUIC), IETF DRAFT-DECONINCK-QUIC-MULTIPATH-07, IETA, QUIC Working Group (3 May 2021), Zhu et al., User-Plane Protocols for Multiple Access Management Service, IETF DRAFT-ZHU-INTAREA-MAMS-USER-PROTOCOL-09, IETA, INTAREA (4 Mar. 2020), and Zhu et al., Generic Multi-Access (GMA) Convergence Encapsulation Protocols, IETF RFC 9188 (February 2022) (collectively referred to as “[MAMS]”), the contents of each of which are hereby incorporated by reference in their entireties. In these implementations, an edge compute node 1335 and/or one or more cloud computing nodes/clusters may be one or more MAMS servers that includes or operates a Network Connection Manager (NCM) for downstream/DL traffic, and the individual UEs 1310 include or operate a Client Connection Manager (CCM) for upstream/UL traffic. An NCM is a functional entity that handles MAMS control messages from clients (e.g., individual UEs 1310 configures the distribution of data packets over available access paths and (core) network paths, and manages user-plane treatment (e.g., tunneling, encryption, and/or the like) of the traffic flows (see e.g., [RFC8743], [MAMS]). The CCM is the peer functional element in a client (e.g., individual UEs 1310 that handles MAMS control-plane procedures, exchanges MAMS signaling messages with the NCM, and configures the network paths at the client for the transport of user data (e.g., network packets, and/or the like) (see e.g., [RFC8743], [MAMS]).

It should be understood that the aforementioned edge computing frameworks/ECTs and services deployment examples are only illustrative examples of ECTs, and that the present disclosure may be applicable to many other or additional edge computing/networking technologies in various combinations and layouts of devices located at the edge of a network including the various edge computing networks/systems described herein. Further, the techniques disclosed herein may relate to other IoT edge network systems and configurations, and other intermediate processing entities and architectures may also be applicable to the present disclosure.

FIG. 14 is a block diagram 1400 showing an overview of a configuration for edge computing, which includes a layer of processing referred to in many of the following examples as an “edge cloud”. As shown, the edge cloud 1410 is co-located at an edge location, such as an access point or base station 1440, a local processing hub 1450, or a central office 1420, and thus may include multiple entities, devices, and equipment instances. The edge cloud 1410 is located much closer to the endpoint (consumer and producer) data sources 1460 (e.g, autonomous vehicles 1461, user equipment 1462, business and industrial equipment 1463, video capture devices 1464, drones 1465, smart cities and building devices 1466, sensors and IoT devices 1467, and/or the like) than the cloud data center 1430. Compute, memory, and storage resources which are offered at the edges in the edge cloud 1410 are critical to providing ultra-low latency response times for services and functions used by the endpoint data sources 1460 as well as reduce network backhaul traffic from the edge cloud 1410 toward cloud data center 1430 thus improving energy consumption and overall network usages among other benefits.

Compute, memory, and storage are scarce resources, and generally decrease depending on the edge location (e.g, fewer processing resources being available at consumer endpoint devices, than at a base station, than at a central office). However, the closer that the edge location is to the endpoint (e.g, user equipment (UE)), the more that space and power is often constrained. Thus, edge computing attempts to reduce the amount of resources needed for network services, through the distribution of more resources which are located closer both geographically and in network access time. In this manner, edge computing attempts to bring the compute resources to the workload data where appropriate, or, bring the workload data to the compute resources.

The following describes aspects of an edge cloud architecture that covers multiple potential deployments and addresses restrictions that some network operators or service providers may have in their own infrastructures. These include, variation of configurations based on the edge location (because edges at a base station level, for instance, may have more constrained performance and capabilities in a multi-tenant scenario); configurations based on the type of compute, memory, storage, fabric, acceleration, or like resources available to edge locations, tiers of locations, or groups of locations; the service, security, and management and orchestration capabilities; and related objectives to achieve usability and performance of end services. These deployments may accomplish processing in network layers that may be considered as “near edge”, “close edge”, “local edge”, “middle edge”, or “far edge” layers, depending on latency, distance, and timing characteristics.

Edge computing is a developing paradigm where computing is performed at or closer to the “edge” of a network, typically through the use of an appropriately arranged compute platform (e.g, x86, ARM, Nvidia or other CPU/GPU based compute hardware architecture) implemented at base stations, gateways, network routers, or other devices which are much closer to endpoint devices producing and consuming the data. For example, edge gateway servers may be equipped with pools of memory and storage resources to perform computation in real-time for low latency use-cases (e.g, autonomous driving or video surveillance) for connected client devices. Or as an example, base stations may be augmented with compute and acceleration resources to directly process service workloads for connected user equipment, without further communicating data via backhaul networks. Or as another example, central office network management hardware may be replaced with standardized compute hardware that performs virtualized network functions and offers compute resources for the execution of services and consumer functions for connected devices. Alternatively, an arrangement with hardware combined with virtualized functions, commonly referred to as a hybrid arrangement may also be successfully implemented. Within edge computing networks, there may be scenarios in services which the compute resource will be “moved” to the data, as well as scenarios in which the data will be “moved” to the compute resource. Or as an example, base station compute, acceleration and network resources can provide services in order to scale to workload demands on an as needed basis by activating dormant capacity (subscription, capacity on demand) in order to manage corner cases, emergencies or to provide longevity for deployed resources over a significantly longer implemented lifecycle.

FIG. 15 illustrates operational layers among endpoints, an edge cloud, and cloud computing environments. Specifically, FIG. 15 depicts examples of computational use cases 1505, utilizing the edge cloud 1410 among multiple illustrative layers of network computing. The layers begin at an endpoint (devices and things) layer 1500, which accesses the edge cloud 1410 to conduct data creation, analysis, and data consumption activities. The edge cloud 1410 may span multiple network layers, such as an edge devices layer 1510 having gateways, on-premise servers, or network equipment (nodes 1515) located in physically proximate edge systems; a network access layer 1520, encompassing base stations, radio processing units, network hubs, regional data centers (DC), or local network equipment (equipment 1525); and any equipment, devices, or nodes located therebetween (in layer 1512, not illustrated in detail). The network communications within the edge cloud 1410 and among the various layers may occur via any number of wired or wireless mediums, including via connectivity architectures and technologies not depicted.

Examples of latency, resulting from network communication distance and processing time constraints, may range from less than a millisecond (ms) when among the endpoint layer 1500, under 5 ms at the edge devices layer 1510, to even between 10 to 40 ms when communicating with nodes at the network access layer 1520. Beyond the edge cloud 1410 are core network 1530 and cloud data center 1540 layers, each with increasing latency (e.g, between 50-60 ms at the core network layer 1530, to 100 or more ms at the cloud data center layer). As a result, operations at a core network data center 1535 or a cloud data center 1545, with latencies of at least 50 to 100 ms or more, will not be able to accomplish many time-critical functions of the use cases 1505. Each of these latency values are provided for purposes of illustration and contrast; it will be understood that the use of other access network mediums and technologies may further reduce the latencies. In some examples, respective portions of the network may be categorized as “close edge”, “local edge”, “near edge”, “middle edge”, or “far edge” layers, relative to a network source and destination. For instance, from the perspective of the core network data center 1535 or a cloud data center 1545, a central office or content data network may be considered as being located within a “near edge” layer (“near” to the cloud, having high latency values when communicating with the devices and endpoints of the use cases 1505), whereas an access point, base station, on-premise server, or network gateway may be considered as located within a “far edge” layer (“far” from the cloud, having low latency values when communicating with the devices and endpoints of the use cases 1505). It will be understood that other categorizations of a particular network layer as constituting a “close”, “local”, “near”, “middle”, or “far” edge may be based on latency, distance, number of network hops, or other measurable characteristics, as measured from a source in any of the network layers 1500-1540.

The various use cases 1505 may access resources under usage pressure from incoming streams, due to multiple services utilizing the edge cloud. To achieve results with low latency, the services executed within the edge cloud 1410 balance varying requirements in terms of: (a) Priority (throughput or latency) and Quality of Service (QoS) (e.g, traffic for an autonomous car may have higher priority than a temperature sensor in terms of response time requirement; or, a performance sensitivity/bottleneck may exist at a compute/accelerator, memory, storage, or network resource, depending on the application); (b) Reliability and Resiliency (e.g, some input streams need to be acted upon and the traffic routed with mission-critical reliability, where as some other input streams may be tolerate an occasional failure, depending on the application); and (c) Physical constraints (e.g, power, cooling and form-factor).

The end-to-end service view for these use cases involves the concept of a service-flow and is associated with a transaction. The transaction details the overall service requirement for the entity consuming the service, as well as the associated services for the resources, workloads, workflows, and business functional and business level requirements. The services executed with the “terms” described may be managed at each layer in a way to assure real time, and runtime contractual compliance for the transaction during the lifecycle of the service. When a component in the transaction is missing its agreed to SLA, the system as a whole (components in the transaction) may provide the ability to (1) understand the impact of the SLA violation, and (2) augment other components in the system to resume overall transaction SLA, and (3) implement steps to remediate.

Thus, with these variations and service features in mind, edge computing within the edge cloud 1410 may provide the ability to serve and respond to multiple applications of the use cases 1505 (e.g, object tracking, video surveillance, connected cars, and/or the like) in real-time or near real-time, and meet ultra-low latency requirements for these multiple applications. These advantages enable a whole new class of applications (Virtual Network Functions (VNFs), Function as a Service (FaaS), Edge as a Service (EaaS), standard processes, and/or the like), which cannot leverage conventional cloud computing due to latency or other limitations.

However, with the advantages of edge computing comes the following caveats. The devices located at the edge are often resource constrained and therefore there is pressure on usage of edge resources. Typically, this is addressed through the pooling of memory and storage resources for use by multiple users (tenants) and devices. The edge may be power and cooling constrained and therefore the power usage needs to be accounted for by the applications that are consuming the most power. There may be inherent power-performance tradeoffs in these pooled memory resources, as many of them are likely to use emerging memory technologies, where more power requires greater memory bandwidth. Likewise, improved security of hardware and root of trust trusted functions are also required, because edge locations may be unmanned and may even need permissioned access (e.g, when housed in a third-party location). Such issues are magnified in the edge cloud 1410 in a multi-tenant, multi-owner, or multi-access setting, where services and applications are requested by many users, especially as network usage dynamically fluctuates and the composition of the multiple stakeholders, use cases, and services changes.

At a more generic level, an edge computing system may be described to encompass any number of deployments at the previously discussed layers operating in the edge cloud 1410 (network layers 1500-1540), which provide coordination from client and distributed computing devices. One or more edge gateway nodes, one or more edge aggregation nodes, and one or more core data centers may be distributed across layers of the network to provide an implementation of the edge computing system by or on behalf of a telecommunication service provider (“telco”, or “TSP”), internet-of-things service provider, cloud service provider (CSP), enterprise entity, or any other number of entities. Various implementations and configurations of the edge computing system may be provided dynamically, such as when orchestrated to meet service objectives.

Consistent with the examples provided herein, a client compute node may be embodied as any type of endpoint component, device, appliance, or other thing capable of communicating as a producer or consumer of data. Further, the label “node” or “device” as used in the edge computing system does not necessarily mean that such node or device operates in a client or agent/minion/follower role; rather, any of the nodes or devices in the edge computing system refer to individual entities, nodes, or subsystems which include discrete or connected hardware or software configurations to facilitate or use the edge cloud 1410.

As such, the edge cloud 1410 is formed from network components and functional features operated by and within edge gateway nodes, edge aggregation nodes, or other edge compute nodes among network layers 1510-1530. The edge cloud 1410 thus may be embodied as any type of network that provides edge computing and/or storage resources which are proximately located to radio access network (RAN) capable endpoint devices (e.g, mobile computing devices, IoT devices, smart devices, and/or the like), which are discussed herein. In other words, the edge cloud 1410 may be envisioned as an “edge” which connects the endpoint devices and traditional network access points that serve as an ingress point into service provider core networks, including mobile carrier networks (e.g, Global System for Mobile Communications (GSM) networks, Long-Term Evolution (LTE) networks, 5G/6G networks, and/or the like), while also providing storage and/or compute capabilities. Other types and forms of network access (e.g, Wi-Fi, long-range wireless, wired networks including optical networks) may also be utilized in place of or in combination with such 3GPP carrier networks.

The network components of the edge cloud 1410 may be servers, multi-tenant servers, appliance computing devices, and/or any other type of computing devices. For example, the edge cloud 1410 may include an appliance computing device that is a self-contained electronic device including a housing, a chassis, a case or a shell. In some circumstances, the housing may be dimensioned for portability such that it can be carried by a human and/or shipped. Alternatively, it may be a smaller module suitable for installation in a vehicle for example. Example housings may include materials that form one or more exterior surfaces that partially or fully protect contents of the appliance, in which protection may include weather protection, ruggedization, hazardous environment protection (e.g, EMI, vibration, extreme temperatures), and/or enable submergibility. Example housings may include power circuitry to provide power for stationary and/or portable implementations, such as AC power inputs, DC power inputs, AC/DC or DC/AC converter(s), power regulators, transformers, charging circuitry, batteries, wired inputs and/or wireless power inputs. Smaller, modular implementations may also include an extendible or embedded antenna arrangement for wireless communications. Example housings and/or surfaces thereof may include or connect to mounting hardware to enable attachment to structures such as buildings, telecommunication structures (e.g, poles, antenna structures, and/or the like) and/or racks (e.g, server racks, blade mounts, and/or the like). Example housings and/or surfaces thereof may support one or more sensors (e.g, temperature sensors, vibration sensors, light sensors, acoustic sensors, capacitive sensors, proximity sensors, and/or the like). One or more such sensors may be contained in, carried by, or otherwise embedded in the surface and/or mounted to the surface of the appliance. Example housings and/or surfaces thereof may support mechanical connectivity, such as propulsion hardware (e.g, wheels, propellers, and/or the like) and/or articulating hardware (e.g, robot arms, pivotable appendages, and/or the like). In some circumstances, the sensors may include any type of input devices such as user interface hardware (e.g, buttons, switches, dials, sliders, and/or the like). In some circumstances, example housings include output devices contained in, carried by, embedded therein and/or attached thereto. Output devices may include displays, touchscreens, lights, LEDs, speakers, I/O ports (e.g, USB), and/or the like. In some circumstances, edge devices are devices presented in the network for a specific purpose (e.g, a traffic light), but may have processing and/or other capacities that may be utilized for other purposes. Such edge devices may be independent from other networked devices and may be provided with a housing having a form factor suitable for its primary purpose; yet be available for other compute tasks that do not interfere with its primary task. Edge devices include Internet of Things devices. The appliance computing device may include hardware and software components to manage local issues such as device temperature, vibration, resource utilization, updates, power issues, physical and network security, and/or the like. Example hardware for implementing an appliance computing device is described in conjunction with FIG. 20. The edge cloud 1410 may also include one or more servers and/or one or more multi-tenant servers. Such a server may include an operating system and implement a virtual computing environment. A virtual computing environment may include a hypervisor managing (e.g, spawning, deploying, destroying, and/or the like) one or more virtual machines, one or more containers, and/or the like. Such virtual computing environments provide an execution environment in which one or more applications and/or other software, code or scripts may execute while being isolated from one or more other applications, software, code or scripts.

FIG. 16 shows various client endpoints 1610 (e.g, in the form of mobile devices, computers, autonomous vehicles, business computing equipment, industrial processing equipment) that exchange requests and responses that are specific to the type of endpoint network aggregation. For instance, client endpoints 1610 may obtain network access via a wired broadband to network, by exchanging requests and responses 1622 through an on-premise network system 1632. Some client endpoints 1610, such as mobile computing devices, may obtain network access via a wireless broadband network, by exchanging requests and responses 1624 through an access point (e.g, cellular network tower) 1634. Some client endpoints 1610, such as autonomous vehicles may obtain network access for requests and responses 1626 via a wireless vehicular network through a street-located network system 1636. However, regardless of the type of network access, the TSP may deploy aggregation points 1642, 1644 within the edge cloud 1410 to aggregate traffic and requests. Thus, within the edge cloud 1410, the TSP may deploy various compute and storage resources, such as at edge aggregation nodes 1640, to provide requested content. The edge aggregation nodes 1640 and other systems of the edge cloud 1410 are connected to a cloud or data center 1660, which uses a backhaul network 1650 to fulfill higher-latency requests from a cloud/data center for websites, applications, database servers, and/or the like. Additional or consolidated instances of the edge aggregation nodes 1640 and the aggregation points 1642, 1644, including those deployed on a single server framework, may also be present within the edge cloud 1410 or other areas of the TSP infrastructure.

FIG. 17 illustrates deployment and orchestration for virtualized and container-based edge configurations across an edge computing system operated among multiple edge nodes and multiple tenants (e.g, users, providers) which use such edge nodes. Specifically, FIG. 17 depicts coordination of a first edge node 1722 and a second edge node 1724 in an edge computing system 1700, to fulfill requests and responses for various client endpoints 1710 (e.g, smart cities/building systems, mobile devices, computing devices, business/logistics systems, industrial systems, and/or the like), which access various virtual edge instances. Here, the virtual edge instances 1732, 1734 provide edge compute capabilities and processing in an edge cloud, with access to a cloud/data center 1740 for higher-latency requests for websites, applications, database servers, and/or the like. However, the edge cloud enables coordination of processing among multiple edge nodes for multiple tenants or entities.

In FIG. 17, these virtual edge instances include: a first virtual edge 1732, offered to a first tenant (Tenant 1), which offers a first combination of edge storage, computing, and services; and a second virtual edge 1734, offering a second combination of edge storage, computing, and services. The virtual edge instances 1732, 1734 are distributed among the edge nodes 1722, 1724, and may include scenarios in which a request and response are fulfilled from the same or different edge nodes. The configuration of the edge nodes 1722, 1724 to operate in a distributed yet coordinated fashion occurs based on edge provisioning functions 1750. The functionality of the edge nodes 1722, 1724 to provide coordinated operation for applications and services, among multiple tenants, occurs based on orchestration functions 1760.

It should be understood that some of the devices in 1710 are multi-tenant devices where Tenant 1 may function within a tenant1 ‘slice’ while a Tenant 2 may function within a tenant2 slice (and, in further examples, additional or sub-tenants may exist; and each tenant may even be specifically entitled and transactionally tied to a specific set of features all the way day to specific hardware features). A trusted multi-tenant device may further contain a tenant specific cryptographic key such that the combination of key and slice may be considered a “root of trust” (RoT) or tenant specific RoT. A RoT may further be computed dynamically composed using a DICE (Device Identity Composition Engine) architecture such that a single DICE hardware building block may be used to construct layered trusted computing base contexts for layering of device capabilities (such as a Field Programmable Gate Array (FPGA)). The RoT may further be used for a trusted computing context to enable a “fan-out” that is useful for supporting multi-tenancy. Within a multi-tenant environment, the respective edge nodes 1722, 1724 may operate as security feature enforcement points for local resources allocated to multiple tenants per node. Additionally, tenant runtime and application execution (e.g, in instances 1732, 1734) may serve as an enforcement point for a security feature that creates a virtual edge abstraction of resources spanning potentially multiple physical hosting platforms. Finally, the orchestration functions 1760 at an orchestration entity may operate as a security feature enforcement point for marshalling resources along tenant boundaries.

Edge computing nodes may partition resources (memory, central processing unit (CPU), graphics processing unit (GPU), interrupt controller, input/output (I/O) controller, memory controller, bus controller, and/or the like) where respective partitionings may contain a RoT capability and where fan-out and layering according to a DICE model may further be applied to Edge Nodes. Cloud computing nodes often use containers, FaaS engines, Servlets, servers, or other computation abstraction that may be partitioned according to a DICE layering and fan-out structure to support a RoT context for each. Accordingly, the respective RoTs spanning devices 1710, 1722, and 1740 may coordinate the establishment of a distributed trusted computing base (DTCB) such that a tenant-specific virtual trusted secure channel linking all elements end to end can be established.

Further, it will be understood that a container may have data or workload specific keys protecting its content from a previous edge node. As part of migration of a container, a pod controller at a source edge node may obtain a migration key from a target edge node pod controller where the migration key is used to wrap the container-specific keys. When the container/pod is migrated to the target edge node, the unwrapping key is exposed to the pod controller that then decrypts the wrapped keys. The keys may now be used to perform operations on container specific data. The migration functions may be gated by properly attested edge nodes and pod managers (as described above).

In further examples, an edge computing system is extended to provide for orchestration of multiple applications through the use of containers (a contained, deployable unit of software that provides code and needed dependencies) in a multi-owner, multi-tenant environment. A multi-tenant orchestrator may be used to perform key management, trust anchor management, and other security functions related to the provisioning and lifecycle of the trusted ‘slice’ concept in FIG. 17. For instance, an edge computing system may be configured to fulfill requests and responses for various client endpoints from multiple virtual edge instances (and, from a cloud or remote data center). The use of these virtual edge instances may support multiple tenants and multiple applications (e.g, augmented reality (AR)/virtual reality (VR), enterprise applications, content delivery, gaming, compute offload) simultaneously. Further, there may be multiple types of applications within the virtual edge instances (e.g, normal applications; latency sensitive applications; latency-critical applications; user plane applications; networking applications; and/or the like). The virtual edge instances may also be spanned across systems of multiple owners at different geographic locations (or, respective computing systems and resources which are co-owned or co-managed by multiple owners).

For instance, each edge node 1722, 1724 may implement the use of containers, such as with the use of a container “pod” 1726, 1728 providing a group of one or more containers. In a setting that uses one or more container pods, a pod controller or orchestrator is responsible for local control and orchestration of the containers in the pod. Various edge node resources (e.g, storage, compute, services, depicted with hexagons) provided for the respective edge slices 1732, 1734 are partitioned according to the needs of each container.

With the use of container pods, a pod controller oversees the partitioning and allocation of containers and resources. The pod controller receives instructions from an orchestrator (e.g, orchestrator 1760) that instructs the controller on how best to partition physical resources and for what duration, such as by receiving key performance indicator (KPI) targets based on SLA contracts. The pod controller determines which container requires which resources and for how long in order to complete the workload and satisfy the SLA. The pod controller also manages container lifecycle operations such as: creating the container, provisioning it with resources and applications, coordinating intermediate results between multiple containers working on a distributed application together, dismantling containers when workload completes, and the like. Additionally, a pod controller may serve a security role that prevents assignment of resources until the right tenant authenticates or prevents provisioning of data or a workload to a container until an attestation result is satisfied.

Also, with the use of container pods, tenant boundaries can still exist but in the context of each pod of containers. If each tenant specific pod has a tenant specific pod controller, there will be a shared pod controller that consolidates resource allocation requests to avoid typical resource starvation situations. Further controls may be provided to ensure attestation and trustworthiness of the pod and pod controller. For instance, the orchestrator 1760 may provision an attestation verification policy to local pod controllers that perform attestation verification. If an attestation satisfies a policy for a first tenant pod controller but not a second tenant pod controller, then the second pod could be migrated to a different edge node that does satisfy it. Alternatively, the first pod may be allowed to execute and a different shared pod controller is installed and invoked prior to the second pod executing.

FIG. 18 illustrates additional compute arrangements deploying containers in an edge computing system. As a simplified example, system arrangements 1810, 1820 depict settings in which a pod controller (e.g, container managers 1811, 1821, and container orchestrator 1831) is adapted to launch containerized pods, functions, and functions-as-a-service instances through execution via compute nodes (1815 in arrangement 1810), or to separately execute containerized virtualized network functions through execution via compute nodes (1823 in arrangement 1820). This arrangement is adapted for use of multiple tenants in system arrangement 1830 (using compute nodes 1837), where containerized pods (e.g, pods 1812), functions (e.g, functions 1813, VNFs 1822, 1836), and functions-as-a-service instances (e.g, FaaS instance 1814) are launched within virtual machines (e.g, VMs 1834, 1835 for tenants 1832, 1833) specific to respective tenants (aside the execution of virtualized network functions). This arrangement is further adapted for use in system arrangement 1840, which provides containers 1842, 1843, or execution of the various functions, applications, and functions on compute nodes 1844, as coordinated by an container-based orchestration system 1841.

The system arrangements of depicted in FIG. 18 provides an architecture that treats VMs, Containers, and Functions equally in terms of application composition (and resulting applications are combinations of these three ingredients). Each ingredient may involve use of one or more accelerator (FPGA, ASIC) components as a local backend. In this manner, applications can be split across multiple edge owners, coordinated by an orchestrator.

In the context of FIG. 18, the pod controller/container manager, container orchestrator, and individual nodes may provide a security enforcement point. However, tenant isolation may be orchestrated where the resources allocated to a tenant are distinct from resources allocated to a second tenant, but edge owners cooperate to ensure resource allocations are not shared across tenant boundaries. Or, resource allocations could be isolated across tenant boundaries, as tenants could allow “use” via a subscription or transaction/contract basis. In these contexts, virtualization, containerization, enclaves and hardware partitioning schemes may be used by edge owners to enforce tenancy. Other isolation environments may include: bare metal (dedicated) equipment, virtual machines, containers, virtual machines on containers, or combinations thereof.

In further examples, aspects of software-defined or controlled silicon hardware, and other configurable hardware, may integrate with the applications, functions, and services an edge computing system. Software defined silicon (SDSi) may be used to ensure the ability for some resource or hardware ingredient to fulfill a contract or service level agreement, based on the ingredient's ability to remediate a portion of itself or the workload (e.g, by an upgrade, reconfiguration, or provision of new features within the hardware configuration itself).

### 4. Software Distribution Systems and Arrangements

FIG. 19 illustrates an example software distribution platform 1905 to distribute software 1960, such as the example computer readable instructions 2060 of FIG. 20, to one or more devices, such as example processor platform(s) 1900 and/or example connected edge devices 2062 (see e.g, FIG. 20) and/or any of the other computing systems/devices discussed herein. The example software distribution platform 1905 may be implemented by any computer server, data facility, cloud service, and/or the like, capable of storing and transmitting software to other computing devices (e.g, third parties, the example connected edge devices 2062 of FIG. 20). Example connected edge devices may be customers, clients, managing devices (e.g, servers), third parties (e.g, customers of an entity owning and/or operating the software distribution platform 1905). Example connected edge devices may operate in commercial and/or home automation environments. In some examples, a third party is a developer, a seller, and/or a licensor of software such as the example computer readable instructions 2060 of FIG. 20. The third parties may be consumers, users, retailers, OEMs, and/or the like that purchase and/or license the software for use and/or re-sale and/or sub-licensing. In some examples, distributed software causes display of one or more user interfaces (UIs) and/or graphical user interfaces (GUIs) to identify the one or more devices (e.g, connected edge devices) geographically and/or logically separated from each other (e.g, physically separated IoT devices chartered with the responsibility of water distribution control (e.g, pumps), electricity distribution control (e.g, relays), and/or the like).

In the illustrated example of FIG. 19, the software distribution platform 1905 includes one or more servers and one or more storage devices. The storage devices store the computer readable instructions 1960, which may correspond to the example computer readable instructions 2060 of FIG. 20, as described above. The one or more servers of the example software distribution platform 1905 are in communication with a network 1910, which may correspond to any one or more of the Internet and/or any of the example networks as described herein. In some examples, the one or more servers are responsive to requests to transmit the software to a requesting party as part of a commercial transaction. Payment for the delivery, sale and/or license of the software may be handled by the one or more servers of the software distribution platform and/or via a third-party payment entity. The servers enable purchasers and/or licensors to download the computer readable instructions 1960 from the software distribution platform 1905. For example, the software 1960, which may correspond to the example computer readable instructions 2060 of FIG. 20, may be downloaded to the example processor platform(s) 1900, which is/are to execute the computer readable instructions 1960 to implement Radio apps.

In some examples, one or more servers of the software distribution platform 1905 are communicatively connected to one or more security domains and/or security devices through which requests and transmissions of the example computer readable instructions 1960 must pass. In some examples, one or more servers of the software distribution platform 1905 periodically offer, transmit, and/or force updates to the software (e.g, the example computer readable instructions 2060 of FIG. 20) to ensure improvements, patches, updates, and/or the like are distributed and applied to the software at the end user devices.

In the illustrated example of FIG. 19, the computer readable instructions 1960 are stored on storage devices of the software distribution platform 1905 in a particular format. A format of computer readable instructions includes, but is not limited to a particular code language (e.g, Java, JavaScript, Python, C, C #, SQL, HTML, and/or the like), and/or a particular code state (e.g, uncompiled code (e.g, ASCII), interpreted code, linked code, executable code (e.g, a binary), and/or the like). In some examples, the computer readable instructions D182 stored in the software distribution platform 1905 are in a first format when transmitted to the example processor platform(s) 1900. In some examples, the first format is an executable binary in which particular types of the processor platform(s) 1900 can execute. However, in some examples, the first format is uncompiled code that requires one or more preparation tasks to transform the first format to a second format to enable execution on the example processor platform(s) 1900. For instance, the receiving processor platform(s) 1900 may need to compile the computer readable instructions 1960 in the first format to generate executable code in a second format that is capable of being executed on the processor platform(s) 1900. In still other examples, the first format is interpreted code that, upon reaching the processor platform(s) 1900, is interpreted by an interpreter to facilitate execution of instructions.

### 5. Hardware Components

FIG. 20 depict further examples of edge computing systems and environments that may fulfill any of the compute nodes or devices discussed herein. Respective edge compute nodes may be embodied as a type of device, appliance, computer, or other “thing” capable of communicating with other edge, networking, or endpoint components. For example, an edge compute device may be embodied as a smartphone, a mobile compute device, a smart appliance, an in-vehicle compute system (e.g, a navigation system), or other device or system capable of performing the described functions.

FIG. 20 illustrates an example of components that may be present in an compute node 2050 for implementing the techniques (e.g, operations, processes, methods, and methodologies) described herein. This compute node 2050 provides a closer view of the respective components of node 2050 when implemented as or as part of a computing device (e.g, as a mobile device, a base station, server, gateway, and/or the like). The compute node 2050 may include any combinations of the hardware or logical components referenced herein, and it may include or couple with any device usable with an edge communication network or a combination of such networks. The components may be implemented as ICs, portions thereof, discrete electronic devices, or other modules, instruction sets, programmable logic or algorithms, hardware, hardware accelerators, software, firmware, or a combination thereof adapted in the compute node 2050, or as components otherwise incorporated within a chassis of a larger system.

The compute node 2050 includes processing circuitry in the form of one or more processors 2052. The processor circuitry 2052 includes circuitry such as, but not limited to one or more processor cores and one or more of cache memory, low drop-out voltage regulators (LDOs), interrupt controllers, serial interfaces such as SPI, I2C or universal programmable serial interface circuit, real time clock (RTC), timer-counters including interval and watchdog timers, general purpose I/O, memory card controllers such as secure digital/multi-media card (SD/MMC) or similar, interfaces, mobile industry processor interface (MIPI) interfaces and Joint Test Access Group (JTAG) test access ports. In some implementations, the processor circuitry 2052 may include one or more hardware accelerators (e.g, same or similar to acceleration circuitry 2064), which may be microprocessors, programmable processing devices (e.g, FPGA, ASIC, and/or the like), or the like. The one or more accelerators may include, for example, computer vision and/or deep learning accelerators. In some implementations, the processor circuitry 2052 may include on-chip memory circuitry, which may include any suitable volatile and/or non-volatile memory, such as DRAM, SRAM, EPROM, EEPROM, Flash memory, solid-state memory, and/or any other type of memory device technology, such as those discussed herein

The processor circuitry 2052 may be, for example, one or more processor cores (CPUs), application processors, GPUs, RISC processors, Acorn RISC Machine (ARM) processors, CISC processors, one or more DSPs, one or more FPGAs, one or more PLDs, one or more ASICs, one or more baseband processors, one or more radio-frequency integrated circuits (RFIC), one or more microprocessors or controllers, a multi-core processor, a multithreaded processor, an ultra-low voltage processor, an embedded processor, a special-purpose processing unit, an specialized x-processing unit (XPU), a data processing unit (DPU), an Infrastructure Processing Unit (IPU), a network processing unit (NPU), and/or any other known processing elements, or any suitable combination thereof. The processors (or cores) 2052 may be coupled with or may include memory/storage and may be configured to execute instructions stored in the memory/storage to enable various applications or operating systems to run on the platform 2050. The processors (or cores) 2052 is configured to operate application software to provide a specific service to a user of the platform 2050. Additionally or alternatively, the processor(s) 2052 may be a special-purpose processor(s)/controller(s) configured (or configurable) to operate according to the elements, features, and implementations discussed herein.

As examples, the processor(s) 2052 may include an Intel® Architecture Core™ based processor such as an i3, an i5, an i7, an i9 based processor; an Intel® microcontroller-based processor such as a Quark™, an Atom™, or other MCU-based processor; Pentium® processor(s), Xeon® processor(s), or another such processor available from Intel® Corporation, Santa Clara, California. However, any number other processors may be used, such as one or more of Advanced Micro Devices (AMD) Zen® Architecture such as Ryzen® or EPYC® processor(s), Accelerated Processing Units (APUs), MxGPUs, Epyc® processor(s), or the like; A5-A12 and/or S1-S4 processor(s) from Apple® Inc, Snapdragon™ or Centriq™ processor(s) from Qualcomm® Technologies, Inc, Texas Instruments, Inc.® Open Multimedia Applications Platform (OMAP)™ processor(s); a MIPS-based design from MIPS Technologies, Inc. such as MIPS Warrior M-class, Warrior I-class, and Warrior P-class processors; an ARM-based design licensed from ARM Holdings, Ltd, such as the ARM Cortex-A, Cortex-R, and Cortex-M family of processors; the ThunderX2® provided by Cavium™, Inc; or the like. In some implementations, the processor(s) 2052 may be a part of a system on a chip (SoC), System-in-Package (SiP), a multi-chip package (MCP), and/or the like, in which the processor(s) 2052 and other components are formed into a single integrated circuit, or a single package, such as the Edison™ or Galileo™ SoC boards from Intel® Corporation. Other examples of the processor(s) 2052 are mentioned elsewhere in the present disclosure.

The processor(s) 2052 may communicate with system memory 2054 over an interconnect (IX) 2056. Any number of memory devices may be used to provide for a given amount of system memory. As examples, the memory may be random access memory (RAM) in accordance with a Joint Electron Devices Engineering Council (JEDEC) design such as the DDR or mobile DDR standards (e.g, LPDDR, LPDDR2, LPDDR3, or LPDDR4). In particular examples, a memory component may comply with a DRAM standard promulgated by JEDEC, such as JESD79F for DDR SDRAM, JESD79-2F for DDR2 SDRAM, JESD79-3F for DDR3 SDRAM, JESD79-4A for DDR4 SDRAM, JESD209 for Low Power DDR (LPDDR), JESD209-2 for LPDDR2, JESD209-3 for LPDDR3, and JESD209-4 for LPDDR4. Other types of RAM, such as dynamic RAM (DRAM), synchronous DRAM (SDRAM), and/or the like may also be included. Such standards (and similar standards) may be referred to as DDR-based standards and communication interfaces of the storage devices that implement such standards may be referred to as DDR-based interfaces. In various implementations, the individual memory devices may be of any number of different package types such as single die package (SDP), dual die package (DDP) or quad die package (Q17P). These devices, in some examples, may be directly soldered onto a motherboard to provide a lower profile solution, while in other examples the devices are configured as one or more memory modules that in turn couple to the motherboard by a given connector. Any number of other memory implementations may be used, such as other types of memory modules, e.g, dual inline memory modules (DIMMs) of different varieties including but not limited to microDIMMs or MiniDIMMs.

To provide for persistent storage of information such as data, applications, operating systems and so forth, a storage 2058 may also couple to the processor 2052 via the IX 2056. In an example, the storage 2058 may be implemented via a solid-state disk drive (SSDD) and/or high-speed electrically erasable memory (commonly referred to as “flash memory”). Other devices that may be used for the storage 2058 include flash memory cards, such as SD cards, microSD cards, eXtreme Digital (XD) picture cards, and the like, and USB flash drives. In an example, the memory device may be or may include memory devices that use chalcogenide glass, multi-threshold level NAND flash memory, NOR flash memory, single or multi-level Phase Change Memory (PCM), a resistive memory, nanowire memory, ferroelectric transistor random access memory (FeTRAM), anti-ferroelectric memory, magnetoresistive random access memory (MRAM) memory that incorporates memristor technology, phase change RAM (PRAM), resistive memory including the metal oxide base, the oxygen vacancy base and the conductive bridge Random Access Memory (CB-RAM), or spin transfer torque (STT)-MRAM, a spintronic magnetic junction memory based device, a magnetic tunneling junction (MTJ) based device, a Domain Wall (DW) and Spin Orbit Transfer (SOT) based device, a thyristor based memory device, or a combination of any of the above, or other memory. The memory circuitry 2054 and/or storage circuitry 2058 may also to incorporate three-dimensional (3D) cross-point (XPOINT) memories from Intel® and Micron®. In low power implementations, the storage 2058 may be on-die memory or registers associated with the processor 2052. However, in some examples, the storage 2058 may be implemented using a micro hard disk drive (HDD). Further, any number of new technologies may be used for the storage 2058 in addition to, or instead of, the technologies described, such resistance change memories, phase change memories, holographic memories, or chemical memories, among others.

Computer program code for carrying out operations of the present disclosure (e.g, computational logic and/or instructions 2081, 2082, 2083) may be written in any combination of one or more programming languages, including an object oriented programming language such as Python, Ruby, Scala, Smalltalk, Java™, C++, C #, or the like; a procedural programming languages, such as the “C” programming language, the Go (or “Golang”) programming language, or the like; a scripting language such as JavaScript, Server-Side JavaScript (SSJS), JQuery, PHP, Pearl, Python, Ruby on Rails, Accelerated Mobile Pages Script (AMPscript), Mustache Template Language, Handlebars Template Language, Guide Template Language (GTL), PHP, Java and/or Java Server Pages (JSP), Node.js, ASP.NET, JAMscript, and/or the like; a markup language such as Hypertext Markup Language (HTML), Extensible Markup Language (XML), Java Script Object Notion (JSON), Apex®, Cascading Stylesheets (CSS), JavaServer Pages (JSP), MessagePack™, Apache® Thrift, Abstract Syntax Notation One (ASN.1), Google® Protocol Buffers (protobuf), or the like; some other suitable programming languages including proprietary programming languages and/or development tools, or any other languages tools. The computer program code 2081, 2082, 2083 for carrying out operations of the present disclosure may also be written in any combination of the programming languages discussed herein. The program code may execute entirely on the system 2050, partly on the system 2050, as a stand-alone software package, partly on the system 2050 and partly on a remote computer or entirely on the remote computer or server. In the latter scenario, the remote computer may be connected to the system 2050 through any type of network, including a LAN or WAN, or the connection may be made to an external computer (e.g, through the Internet using an Internet Service Provider (ISP)).

In an example, the instructions 2081, 2082, 2083 on the processor circuitry 2052 (separately, or in combination with the instructions 2081, 2082, 2083) may configure execution or operation of a trusted execution environment (TEE) 2090. The TEE 2090 operates as a protected area and/or shielded location accessible to the processor circuitry 2002 to enable secure access to data and secure execution of instructions. In some implementations, the TEE 2090 is a physical hardware device that is separate from other components of the system 2050 such as a secure-embedded controller, a dedicated SoC, or a tamper-resistant chipset or microcontroller with embedded processing devices and memory devices. Examples of such examples include a Desktop and mobile Architecture Hardware (DASH) compliant Network Interface Card (NIC), Intel® Management/Manageability Engine, Intel® Converged Security Engine (CSE) or a Converged Security Management/Manageability Engine (CSME), Trusted Execution Engine (TXE) provided by Intel® each of which may operate in conjunction with Intel® Active Management Technology (AMT) and/or Intel® vPro™ Technology; AMD® Platform Security coProcessor (PSP), AMD® PRO A-Series Accelerated Processing Unit (APU) with DASH manageability, Apple® Secure Enclave coprocessor; IBM® Crypto Express3®, IBM® 4807, 4808, 4809, and/or 4765 Cryptographic Coprocessors, IBM® Baseboard Management Controller (BMC) with Intelligent Platform Management Interface (IPMI), Dell™ Remote Assistant Card II (DRAC II), integrated Dell™ Remote Assistant Card (iDRAC), and the like.

Additionally or alternatively, the TEE 2090 may be implemented as secure enclaves (or “enclaves”), which are isolated regions of code and/or data within the processor and/or memory/storage circuitry of the compute node 2050. Only code executed within a secure enclave may access data within the same secure enclave, and the secure enclave may only be accessible using the secure application (which may be implemented by an application processor or a tamper-resistant microcontroller). Various implementations of the TEE 2090, and an accompanying secure area in the processor circuitry 2052 or the memory circuitry 2054 and/or storage circuitry 2058 may be provided, for instance, through use of Intel® Software Guard Extensions (SGX), ARM® TrustZone® hardware security extensions, Keystone Enclaves provided by Oasis Labs™, and/or the like. Other aspects of security hardening, hardware roots-of-trust, and trusted or protected operations may be implemented in the device 2000 through the TEE 2090 and the processor circuitry 2052. Additionally or alternatively, the memory circuitry 2054 and/or storage circuitry 2058 may be divided into isolated user-space instances such as virtualization/OS containers, partitions, virtual environments (VEs), and/or the like. The isolated user-space instances may be implemented using a suitable OS-level virtualization technology such as Docker® containers, Kubemetes® containers, Solaris® containers and/or zones, OpenVZ® virtual private servers, DragonFly BSD® virtual kernels and/or jails, chroot jails, and/or the like. Virtual machines could also be used in some implementations. In some examples, the memory circuitry 2004 and/or storage circuitry 2008 may be divided into one or more trusted memory regions for storing applications or software modules of the TEE 2090.

The components of edge computing device 2050 may communicate over an interconnect (IX) 2056. The IX 2056 may include any number of technologies, including instruction set architecture (ISA), extended ISA (eISA), Inter-Integrated Circuit (I²C), serial peripheral interface (SPI), point-to-point interfaces, power management bus (PMBus), peripheral component interconnect (PCI), PCI express (PCIe), PCI extended (PCIx), Intel® Ultra Path Interconnect (UPI), Intel® Accelerator Link, Intel® QuickPath Interconnect (QPI), Intel® Omni-Path Architecture (OPA), Compute Express Link™ (CXL™) IX technology, RapidIO™ IX, Coherent Accelerator Processor Interface (CAPI), OpenCAPI, cache coherent interconnect for accelerators (CCIX), Gen-Z Consortium IXs, a HyperTransport interconnect, NVLink provided by NVIDIA®, a Time-Trigger Protocol (TTP) system, a FlexRay system, PROFIBUS, and/or any number of other IX technologies. The IX 2056 may be a proprietary bus, for example, used in a SoC based system.

The IX 2056 couples the processor 2052 to communication circuitry 2066 for communications with other devices, such as a remote server (not shown) and/or the connected edge devices 2062. The communication circuitry 2066 is a hardware element, or collection of hardware elements, used to communicate over one or more networks (e.g, cloud 2063) and/or with other devices (e.g, edge devices 2062). Communication circuitry 2066 includes modem circuitry 2066x may interface with application circuitry of system 800 (e.g, a combination of processor circuitry 802 and CRM 860) for generation and processing of baseband signals and for controlling operations of the TRx 812. The modem circuitry 2066x may handle various radio control functions that enable communication with one or more (R)ANs via the transceivers (TRx) 2066y and 2066z according to one or more wireless communication protocols and/or RATs. The modem circuitry 2066x may include circuitry such as, but not limited to, one or more single-core or multi-core processors (e.g, one or more baseband processors) or control logic to process baseband signals received from a receive signal path of the TRxs 2066y, 2066z, and to generate baseband signals to be provided to the TRxs 2066y, 2066z via a transmit signal path. The modem circuitry 2066x may implement a real-time OS (RTOS) to manage resources of the modem circuitry 2066x, schedule tasks, perform the various radio control functions, process the transmit/receive signal paths, and the like.

The TRx 2066y may use any number of frequencies and protocols, such as 2.4 Gigahertz (GHz) transmissions under the IEEE 802.15.4 standard, using the Bluetooth® low energy (BLE) standard, as defined by the Bluetooth® Special Interest Group, or the ZigBee® standard, among others. Any number of radios, configured for a particular wireless communication protocol, may be used for the connections to the connected edge devices 2062. For example, a wireless local area network (WLAN) unit may be used to implement Wi-Fi® communications in accordance with a [IEEE802] standard (e.g, [IEEE80211] and/or the like). In addition, wireless wide area communications, e.g, according to a cellular or other wireless wide area protocol, may occur via a wireless wide area network (WWAN) unit.

The TRx 2066y (or multiple transceivers 2066y) may communicate using multiple standards or radios for communications at a different range. For example, the compute node 2050 may communicate with relatively close devices (e.g, within about 10 meters) using a local transceiver based on BLE, or another low power radio, to save power. More distant connected edge devices 2062 (e.g, within about 50 meters) may be reached over ZigBee® or other intermediate power radios. Both communications techniques may take place over a single radio at different power levels or may take place over separate transceivers, for example, a local transceiver using BLE and a separate mesh transceiver using ZigBee®.

A TRx 2066z (e.g, a radio transceiver) may be included to communicate with devices or services in the edge cloud 2063 via local or wide area network protocols. The TRx 2066z may be an LPWA transceiver that follows [IEEE802154] or IEEE 802.15.4g standards, among others. The compute node 2063 may communicate over a wide area using LoRaWAN™ (Long Range Wide Area Network) developed by Semtech and the LoRa Alliance. The techniques described herein are not limited to these technologies but may be used with any number of other cloud transceivers that implement long range, low bandwidth communications, such as Sigfox, and other technologies. Further, other communications techniques, such as time-slotted channel hopping, described in the IEEE 802.15.4e specification may be used. Any number of other radio communications and protocols may be used in addition to the systems mentioned for the TRx 2066z, as described herein. For example, the TRx 2066z may include a cellular transceiver that uses spread spectrum (SPA/SAS) communications for implementing high-speed communications. Further, any number of other protocols may be used, such as WiFi® networks for medium speed communications and provision of network communications. The TRx 2066z may include radios that are compatible with any number of 3GPP specifications, such as LTE and 5G/NR communication systems.

A network interface controller (NIC) 2068 may be included to provide a wired communication to nodes of the edge cloud 2063 or to other devices, such as the connected edge devices 2062 (e.g, operating in a mesh, fog, and/or the like). The wired communication may provide an Ethernet connection (see e.g, Ethernet (e.g, IEEE Standard for Ethernet, IEEE Std 802.3-2018, pp. 1-5600 (31 Aug. 2018) (“[IEEE8023]”)) or may be based on other types of networks, such as Controller Area Network (CAN), Local Interconnect Network (LIN), DeviceNet, ControlNet, Data Highway+, or PROFINET, a SmartNIC, Intelligent Fabric Processor(s) (IFP(s)), among many others. An additional NIC 2068 may be included to enable connecting to a second network, for example, a first NIC 2068 providing communications to the cloud over Ethernet, and a second NIC 2068 providing communications to other devices over another type of network.

Given the variety of types of applicable communications from the device to another component or network, applicable communications circuitry used by the device may include or be embodied by any one or more of components 2064, 2066, 2068, or 2070. Accordingly, in various examples, applicable means for communicating (e.g, receiving, transmitting, and/or the like) may be embodied by such communications circuitry.

The compute node 2050 may include or be coupled to acceleration circuitry 2064, which may be embodied by one or more AI accelerators, a neural compute stick, neuromorphic hardware, FPGAs, GPUs, SoCs (including programmable SoCs), vision processing units (VPUs), digital signal processors, dedicated ASICs, programmable ASICs, PLDs (e.g, CPLDs and/or HCPLDs), DPUs, IPUs, NPUs, and/or other forms of specialized processors or circuitry designed to accomplish one or more specialized tasks. Additionally or alternatively, the acceleration circuitry 2064 is embodied as one or more XPUs. In some implementations, an XPU is a multi-chip package including multiple chips stacked like tiles into an XPU, where the stack of chips includes any of the processor types discussed herein. Additionally or alternatively, an XPU is implemented by a heterogeneous computing system including multiple types of processor circuitry (e.g, one or more FPGAs, one or more CPUs, one or more GPUs, one or more DSPs, and/or the like, and/or a combination thereof) and application programming interface(s) (API(s)) that may assign computing task(s) to whichever one(s) of the multiple types of the processing circuitry is/are best suited to execute the computing task(s). In any of these implementations, the tasks may include AI/ML tasks (e.g, training, inferencing/prediction, classification, and the like), visual data processing, network data processing, infrastructure function management, object detection, rule analysis, or the like. In FPGA-based implementations, the acceleration circuitry 2064 may comprise logic blocks or logic fabric and other interconnected resources that may be programmed (configured) to perform various functions, such as the procedures, methods, functions, and/or the like. discussed herein. In such implementations, the acceleration circuitry 2064 may also include memory cells (e.g, EPROM, EEPROM, flash memory, static memory (e.g, SRAM, anti-fuses, and/or the like) used to store logic blocks, logic fabric, data, and/or the like. in LUTs and the like. Some examples of the acceleration circuitry 2064 can include one or more GPUs, Google® TPUs, AlphaICs® RAPs™, Intel® Nervana™ NNPs, Intel® Movidius™ Myriad™ X VPUs, NVIDIA® PX™ based GPUs, General Vision® NM500 chip, Tesla® Hardware 3 chip/platform, an Adapteva® Epiphany™ based processor, Qualcomm® Hexagon 685 DSP, Imagination Technologies Limited® PowerVR 2NX NNA, Apple® Neural Engine core, Huawei® NPU, and/or the like.

The IX 2056 also couples the processor 2052 to a sensor hub or external interface 2070 that is used to connect additional devices or subsystems. In some implementations, the interface 2070 can include one or more input/output (I/O) controllers. Examples of such I/O controllers include integrated memory controller (IMC), memory management unit (MMU), sensor hub, General Purpose I/O (GPIO) controller, PCIe endpoint (EP) device, direct media interface (DMI) controller, Intel® Flexible Display Interface (FDI) controller(s), VGA interface controller(s), Peripheral Component Interconnect Express (PCIe) controller(s), universal serial bus (USB) controller(s), eXtensible Host Controller Interface (xHCI) controller(s), Enhanced Host Controller Interface (EHCI) controller(s), Serial Peripheral Interface (SPI) controller(s), Direct Memory Access (DMA) controller(s), hard drive controllers (e.g, Serial AT Attachment (SATA) host bus adapters/controllers, Intel® Rapid Storage Technology (RST), and/or the like), Advanced Host Controller Interface (AHCI), a Low Pin Count (LPC) interface (bridge function), Advanced Programmable Interrupt Controller(s) (APIC), audio controller(s), SMBus host interface controller(s), UART controller(s), and/or the like. The additional/external devices may include sensors 2072, actuators 2074, and positioning circuitry 2045.

The sensor circuitry 2072 includes devices, modules, or subsystems whose purpose is to detect events or changes in its environment and send the information (sensor data) about the detected events to some other a device, module, subsystem, and/or the like. Examples of such sensors 2072 include, inter alia, inertia measurement units (IMU) comprising accelerometers, gyroscopes, and/or magnetometers; microelectromechanical systems (MEMS) or nanoelectromechanical systems (NEMS) comprising 3-axis accelerometers, 3-axis gyroscopes, and/or magnetometers; level sensors; flow sensors; temperature sensors (e.g, thermistors, including sensors for measuring the temperature of internal components and sensors for measuring temperature external to the compute node 2050); pressure sensors; barometric pressure sensors; gravimeters; altimeters; image capture devices (e.g, cameras); light detection and ranging (LiDAR) sensors; proximity sensors (e.g, infrared radiation detector and the like); depth sensors, ambient light sensors; optical light sensors; ultrasonic transceivers; microphones; and the like.

The actuators 2074, allow platform 2050 to change its state, position, and/or orientation, or move or control a mechanism or system. The actuators 2074 comprise electrical and/or mechanical devices for moving or controlling a mechanism or system, and converts energy (e.g, electric current or moving air and/or liquid) into some kind of motion. The actuators 2074 may include one or more electronic (or electrochemical) devices, such as piezoelectric biomorphs, solid state actuators, solid state relays (SSRs), shape-memory alloy-based actuators, electroactive polymer-based actuators, relay driver integrated circuits (ICs), and/or the like. The actuators 2074 to may include one or more electromechanical devices such as pneumatic actuators, hydraulic actuators, electromechanical switches including electromechanical relays (EMRs), motors (e.g, DC motors, stepper motors, servomechanisms, and/or the like), power switches, valve actuators, wheels, thrusters, propellers, claws, clamps, hooks, audible sound generators, visual warning devices, and/or other like electromechanical components. The platform 2050 may be configured to operate one or more actuators 2074 based on one or more captured events and/or instructions or control signals received from a service provider and/or various client systems.

The positioning circuitry 2045 includes circuitry to receive and decode signals transmitted/broadcasted by a positioning network of a global navigation satellite system (GNSS). Examples of navigation satellite constellations (or GNSS) include United States' Global Positioning System (GPS), Russia's Global Navigation System (GLONASS), the European Union's Galileo system, China's BeiDou Navigation Satellite System, a regional navigation system or GNSS augmentation system (e.g, Navigation with Indian Constellation (NAVIC), Japan's Quasi-Zenith Satellite System (QZSS), France's Doppler Orbitography and Radio-positioning Integrated by Satellite (DORIS), and/or the like), or the like. The positioning circuitry 2045 comprises various hardware elements (e.g, including hardware devices such as switches, filters, amplifiers, antenna elements, and the like to facilitate OTA communications) to communicate with components of a positioning network, such as navigation satellite constellation nodes. Additionally or alternatively, the positioning circuitry 2045 may include a Micro-Technology for Positioning, Navigation, and Timing (Micro-PNT) IC that uses a master timing clock to perform position tracking/estimation without GNSS assistance. The positioning circuitry 2045 may also be part of, or interact with, the communication circuitry 2066 to communicate with the nodes and components of the positioning network. The positioning circuitry 2045 may also provide position data and/or time data to the application circuitry, which may use the data to synchronize operations with various infrastructure (e.g, radio base stations), for turn-by-turn navigation, or the like. When a GNSS signal is not available or when GNSS position accuracy is not sufficient for a particular application or service, a positioning augmentation technology can be used to provide augmented positioning information and data to the application or service. Such a positioning augmentation technology may include, for example, satellite based positioning augmentation (e.g, EGNOS) and/or ground based positioning augmentation (e.g, DGPS). In some implementations, the positioning circuitry 2045 is, or includes an INS, which is a system or device that uses sensor circuitry 2072 (e.g, motion sensors such as accelerometers, rotation sensors such as gyroscopes, and altimimeters, magentic sensors, and/or the like to continuously calculate (e.g, using dead by dead reckoning, triangulation, or the like) a position, orientation, and/or velocity (including direction and speed of movement) of the platform 2050 without the need for external references.

In some optional examples, various input/output (I/O) devices may be present within or connected to, the compute node 2050, which are referred to as input circuitry 2086 and output circuitry 2084 in FIG. 20. The input circuitry 2086 and output circuitry 2084 include one or more user interfaces designed to enable user interaction with the platform 2050 and/or peripheral component interfaces designed to enable peripheral component interaction with the platform 2050. Input circuitry 2086 may include any physical or virtual means for accepting an input including, inter alia, one or more physical or virtual buttons (e.g, a reset button), a physical keyboard, keypad, mouse, touchpad, touchscreen, microphones, scanner, headset, and/or the like. The output circuitry 2084 may be included to show information or otherwise convey information, such as sensor readings, actuator position(s), or other like information. Data and/or graphics may be displayed on one or more user interface components of the output circuitry 2084. Output circuitry 2084 may include any number and/or combinations of audio or visual display, including, inter alia, one or more simple visual outputs/indicators (e.g, binary status indicators (e.g, light emitting diodes (LEDs)) and multi-character visual outputs, or more complex outputs such as display devices or touchscreens (e.g, Liquid Chrystal Displays (LCD), LED displays, quantum dot displays, projectors, and/or the like), with the output of characters, graphics, multimedia objects, and the like being generated or produced from the operation of the platform 2050. The output circuitry 2084 may also include speakers or other audio emitting devices, printer(s), and/or the like. Additionally or alternatively, the sensor circuitry 2072 may be used as the input circuitry 2084 (e.g, an image capture device, motion capture device, or the like) and one or more actuators 2074 may be used as the output device circuitry 2084 (e.g, an actuator to provide haptic feedback or the like). In another example, near-field communication (NFC) circuitry comprising an NFC controller coupled with an antenna element and a processing device may be included to read electronic tags and/or connect with another NFC-enabled device. Peripheral component interfaces may include, but are not limited to, a non-volatile memory port, a USB port, an audio jack, a power supply interface, and/or the like. A display or console hardware, in the context of the present system, may be used to provide output and receive input of an edge computing system; to manage components or services of an edge computing system; identify a state of an edge computing component or service; or to conduct any other number of management or administration functions or service use cases.

A battery 2076 may power the compute node 2050, although, in examples in which the compute node 2050 is mounted in a fixed location, it may have a power supply coupled to an electrical grid, or the battery may be used as a backup or for temporary capabilities. The battery 2076 may be a lithium ion battery, or a metal-air battery, such as a zinc-air battery, an aluminum-air battery, a lithium-air battery, and the like.

A battery monitor/charger 2078 may be included in the compute node 2050 to track the state of charge (SoCh) of the battery 2076, if included. The battery monitor/charger 2078 may be used to monitor other parameters of the battery 2076 to provide failure predictions, such as the state of health (SoH) and the state of function (SoF) of the battery 2076. The battery monitor/charger 2078 may include a battery monitoring integrated circuit, such as an LTC4020 or an LTC2990 from Linear Technologies, an ADT7488A from ON Semiconductor of Phoenix Arizona, or an IC from the UCD90xxx family from Texas Instruments of Dallas, TX. The battery monitor/charger 2078 may communicate the information on the battery 2076 to the processor 2052 over the IX 2056. The battery monitor/charger 2078 may also include an analog-to-digital (ADC) converter that enables the processor 2052 to directly monitor the voltage of the battery 2076 or the current flow from the battery 2076. The battery parameters may be used to determine actions that the compute node 2050 may perform, such as transmission frequency, mesh network operation, sensing frequency, and the like.

A power block 2080, or other power supply coupled to a grid, may be coupled with the battery monitor/charger 2078 to charge the battery 2076. In some examples, the power block 2080 may be replaced with a wireless power receiver to obtain the power wirelessly, for example, through a loop antenna in the compute node 2050. A wireless battery charging circuit, such as an LTC4020 chip from Linear Technologies of Milpitas, California, among others, may be included in the battery monitor/charger 2078. The specific charging circuits may be selected based on the size of the battery 2076, and thus, the current required. The charging may be performed using the Airfuel standard promulgated by the Airfuel Alliance, the Qi wireless charging standard promulgated by the Wireless Power Consortium, or the Rezence charging standard, promulgated by the Alliance for Wireless Power, among others.

The storage 2058 may include instructions 2082 in the form of software, firmware, or hardware commands to implement the techniques described herein. Although such instructions 2082 are shown as code blocks included in the memory 2054 and the storage 2058, it may be understood that any of the code blocks may be replaced with hardwired circuits, for example, built into an application specific integrated circuit (ASIC).

In an example, the instructions 2082 provided via the memory 2054, the storage 2058, or the processor 2052 may be embodied as a non-transitory, machine-readable medium 2060 including code to direct the processor 2052 to perform electronic operations in the compute node 2050. The processor 2052 may access the non-transitory, machine-readable medium 2060 over the IX 2056. For instance, the non-transitory, machine-readable medium 2060 may be embodied by devices described for the storage 2058 or may include specific storage units such as storage devices and/or storage disks that include optical disks (e.g, digital versatile disk (DVD), compact disk (CD), CD-ROM, Blu-ray disk), flash drives, floppy disks, hard drives (e.g, SSDs), or any number of other hardware devices in which information is stored for any duration (e.g, for extended time periods, permanently, for brief instances, for temporarily buffering, and/or caching). The non-transitory, machine-readable medium 2060 may include instructions to direct the processor 2052 to perform a specific sequence or flow of actions, for example, as described with respect to the flowchart(s) and block diagram(s) of operations and functionality depicted above. As used herein, the terms “machine-readable medium” and “computer-readable medium” are interchangeable. As used herein, the term “non-transitory computer-readable medium” is expressly defined to include any type of computer readable storage device and/or storage disk and to exclude propagating signals and to exclude transmission media.

In further examples, a machine-readable medium also includes any tangible medium that is capable of storing, encoding or carrying instructions for execution by a machine and that cause the machine to perform any one or more of the methodologies of the present disclosure or that is capable of storing, encoding or carrying data structures utilized by or associated with such instructions. A “machine-readable medium” thus may include but is not limited to, solid-state memories, and optical and magnetic media. Specific examples of machine-readable media include non-volatile memory, including but not limited to, by way of example, semiconductor memory devices (e.g, electrically programmable read-only memory (EPROM), electrically erasable programmable read-only memory (EEPROM)) and flash memory devices; magnetic disks such as internal hard disks and removable disks; magneto-optical disks; and CD-ROM and DVD-ROM disks. The instructions embodied by a machine-readable medium may further be transmitted or received over a communications network using a transmission medium via a network interface device utilizing any one of a number of transfer protocols (e.g, HTTP).

A machine-readable medium may be provided by a storage device or other apparatus which is capable of hosting data in a non-transitory format. In an example, information stored or otherwise provided on a machine-readable medium may be representative of instructions, such as instructions themselves or a format from which the instructions may be derived. This format from which the instructions may be derived may include source code, encoded instructions (e.g, in compressed or encrypted form), packaged instructions (e.g, split into multiple packages), or the like. The information representative of the instructions in the machine-readable medium may be to processed by processing circuitry into the instructions to implement any of the operations discussed herein. For example, deriving the instructions from the information (e.g, processing by the processing circuitry) may include: compiling (e.g, from source code, object code, and/or the like), interpreting, loading, organizing (e.g, dynamically or statically linking), encoding, decoding, encrypting, unencrypting, packaging, unpackaging, or otherwise manipulating the information into the instructions.

In an example, the derivation of the instructions may include assembly, compilation, or interpretation of the information (e.g, by the processing circuitry) to create the instructions from some intermediate or preprocessed format provided by the machine-readable medium. The information, when provided in multiple parts, may be combined, unpacked, and modified to create the instructions. For example, the information may be in multiple compressed source code packages (or object code, or binary executable code, and/or the like) on one or several remote servers. The source code packages may be encrypted when in transit over a network and decrypted, uncompressed, assembled (e.g, linked) if necessary, and compiled or interpreted (e.g, into a library, stand-alone executable, and/or the like) at a local machine, and executed by the local machine.

The illustrations of FIG. 20 are intended to depict a high-level view of components of a varying device, subsystem, or arrangement of an compute node. However, it will be understood that some of the components shown may be omitted, additional components may be present, and a different arrangement of the components shown may occur in other implementations. Further, these arrangements are usable in a variety of use cases and environments, including those discussed below (e.g, a mobile UE in industrial compute for smart city or smart factory, among many other examples).

The respective compute platforms of FIG. 20 may support multiple edge instances (e.g, edge clusters) by use of tenant containers running on a single compute platform. Likewise, multiple edge nodes may exist as subnodes running on tenants within the same compute platform. Accordingly, based on available resource partitioning, a single system or compute platform may be partitioned or divided into supporting multiple tenants and edge node instances, each of which may support multiple services and functions-even while being potentially operated or controlled in multiple compute platform instances by multiple owners. These various types of partitions may support complex multi-tenancy and many combinations of multi-stakeholders through the use of an LSM or other implementation of an isolation/security policy. References to the use of an LSM and security features which enhance or implement such security features are thus noted in the following sections. Likewise, services and functions operating on these various types of multi-entity partitions may be load-balanced, migrated, and orchestrated to accomplish necessary service objectives and operations.

FIG. 20 depict examples of edge computing systems and environments that may fulfill any of the compute nodes or devices discussed herein. Respective edge compute nodes may be embodied as a type of device, appliance, computer, or other “thing” capable of communicating with other edge, networking, or endpoint components. For example, an edge compute device may be embodied as a smartphone, a mobile compute device, a smart appliance, an in-vehicle compute system (e.g, a navigation system), or other device or system capable of performing the described functions.

While the illustrated example of FIG. 20 includes example components for a compute node and a computing device, respectively, examples disclosed herein are not limited thereto. As used herein, a “computer”, “computing device”, and/or “computing system” may include some or all of the example components of FIG. 20 in different types of computing environments. Example computing environments include edge computing devices (e.g, Edge computers) in a distributed networking arrangement such that particular ones of participating Edge computing devices are heterogenous or homogeneous devices. As used herein, a “computer”, “computing device”, and/or “computing system” may include a personal computer, a server, user equipment, an accelerator, and/or the like, including any combinations thereof. In some examples, distributed networking and/or distributed computing includes any number of such Edge computing devices as illustrated in FIG. 20, each of which may include different sub-components, different memory capacities, I/O capabilities, and/or the like. For example, because some implementations of distributed networking and/or distributed computing are associated with particular desired functionality, examples disclosed herein include different combinations of components illustrated in FIG. 20 to satisfy functional objectives of distributed computing tasks.

In some examples, computers operating in a distributed computing and/or distributed networking environment (e.g, an Edge network) are structured to accommodate particular objective functionality in a manner that reduces computational waste. For instance, because a computer includes a subset of the components disclosed in FIG. 20, such computers satisfy execution of distributed computing objective functions without including computing structure that would otherwise be unused and/or underutilized. As such, the term “computer” as used herein includes any combination of structure of FIG. 20 that is capable of satisfying and/or otherwise executing objective functions of distributed computing tasks. In some examples, computers are structured in a manner commensurate to corresponding distributed computing objective functions in a manner that downscales or upscales in connection with dynamic demand. In some examples, different computers are invoked and/or otherwise instantiated in view of their ability to process one or more tasks of the distributed computing request(s), such that any computer capable of satisfying the tasks proceed with such computing activity.

In the illustrated examples of FIG. 20, computing devices include operating systems. As used herein, an “operating system” is software to control example computing devices, such as the example (Edge) compute node 2050 of FIG. 20. Example operating systems include, but are not limited to consumer-based operating systems (e.g, Microsoft® Windows® 10, Google® Android® OS, Apple® Mac® OS, and/or the like). Example operating systems also include, but are not limited to industry-focused operating systems, such as real-time operating systems, hypervisors, and/or the like. An example operating system on a first Edge compute node may be the same or different than an example operating system on a second Edge compute node. In some examples, the operating system invokes alternate software to facilitate one or more functions and/or operations that are not native to the operating system, such as particular communication protocols and/or interpreters. In some examples, the operating system instantiates various functionalities that are not native to the operating system. In some examples, operating systems include varying degrees of complexity and/or capabilities. For instance, a first operating system corresponding to a first Edge compute node includes a real-time operating system having particular performance expectations of responsivity to dynamic input conditions, and a second operating system corresponding to a second Edge compute node includes graphical user interface capabilities to facilitate end-user I/O.

### 6. Example Implementations

FIG. 21 shows an example process 2100 of operating measurement equipment 120. At operation 2101, the measurement equipment 120 sends first signaling to an REuT 101 via a testing access interface 135 between the measurement equipment 120 and the REuT 101. The first signaling includes data or commands for testing one or more components of the REuT 101. At operation 2102, the measurement equipment 120 receives second signaling from the REuT 101 over the testing access interface 135. The second signaling includes data or commands based on execution of the first signaling by the one or more components 112 of the REuT 101. At operation 2103, the measurement equipment 120 verifies and/or validates the execution of the first signaling by the one or more components 112 of the REuT 101 based on the second signaling.

FIG. 21 also shows an example process 2110 of operating an REuT 101. At operation 2111, the REuT 101 receives first signaling from an external measurement equipment 120 via a testing access interface 135 between the measurement equipment 120 and the REuT 101 for testing execution of one or more components 112 of the REuT 101. At operation 2112, the REuT 101 operates the one or more components 112 using data or commands included in the received first signaling. At operation 2113, the REuT 101 generates second signaling based on the operation of the one or more components 112 and/or based on the execution of the first signaling. At operation 2114, the REuT 101 sends the second signaling to the external measurement equipment 120 for validation of execution of the first signaling by the one or more components 112.

FIG. 22 shows an example process 2200 for operating a Monitoring and Enforcement Function (MEF) 1050. At operation 2201, the MEF 1050 monitors network traffic based on one or more security rules. At operation 2202, the MEF 1050 assesses and categorizes network traffic based on the one or more security rules. At operation 2203, the MEF 1050 controls network traffic based on the one or more security rules. At operation 2204, the MEF 1050 detects security threats or data breaches.

FIG. 22 also shows an example process 2210 for operating a compute device such as any of those discussed herein. At operation 2211, the compute device requests ID information from one or more neighboring devices. At operation 2212, the compute device determines whether the neighboring device complies with a Radio Equipment Directive (RED) based on the requested ID information. At operation 2213, the compute device declares each neighboring device that complies with the RED to be a trustworthy device. Additionally or alternatively, the compute device declares each neighboring device that does not comply with the RED to be an untrustworthy device.

Additional examples of the presently described methods, devices, systems, and networks discussed herein include the following, non-limiting implementations. Each of the following non-limiting examples may stand on its own or may be combined in any permutation or combination with any one or more of the other examples provided below or throughout the present disclosure.

Example 1 includes a method of operating measurement equipment, the method comprising: sending first signaling to an external radio equipment under test (REuT) via a testing access interface between the measurement equipment and the REuT, wherein the first signaling includes data or commands for testing one or more components of the REuT; receiving second signaling from the REuT over the testing access interface, wherein the second signaling includes data or commands based on execution of the first signaling by the one or more components of the REuT; and verifying or validating the execution of the first signaling by the one or more components of the REuT based on the second signaling.

Example 2 includes a method of operating radio equipment under test (REuT), the method comprising: receiving first signaling from an external measurement equipment via a testing access interface between the measurement equipment and the REuT, for testing execution of one or more components of the REuT; operating the one or more components using data or commands included to in the received first signaling; generating second signaling including second data or commands based on the operation of the one or more components; and sending the second signaling to the external measurement equipment for validation of execution of the first signaling by the one or more components.

Example 3 includes the method of examples 1-2 and/or some other example(s) herein, wherein the testing access interface is a wired or wireless connection between the REuT and the measurement equipment.

Example 4 includes the method of examples 1-3 and/or some other example(s) herein, wherein the testing access interface includes a Monitoring and Enforcement Function (MEF), the MEF is disposed between the REuT and the measurement equipment, and the first signaling is conveyed via the MEF over an Nmef service-based interface exposed by the MEF.

Example 5.0 includes the method of example 4 and/or some other example(s) herein, wherein the MEF is a network function (NF) disposed in a Radio Access Network (RAN).

Example 5.1 includes the method of example 5.0 and/or some other example(s) herein, wherein the MEF is in or operated by a RAN intelligent controller (RIC).

Example 5.2 includes the method of example 4 and/or some other example(s) herein, wherein the MEF is an NF disposed in a cellular core network.

Example 6 includes the method of examples 4-5.2 and/or some other example(s) herein, wherein the MEF is a standalone NF.

Example 7 includes the method of examples 4-5.2 and/or some other example(s) herein, wherein the MEF is part of an another NF.

Example 8 includes the method of example 8 and/or some other example(s) herein, wherein the other NF is a Network Exposure Function (NEF).

Example 9 includes the method of example 4 and/or some other example(s) herein, wherein the MEF is included in an NEF, and the NEF is part of an entity external to a cellular core network.

Example 10 includes the method of example 9 and/or some other example(s) herein, wherein the NEF is part of the measurement equipment.

Example 11 includes the method of examples 4-10 and/or some other example(s) herein, wherein the MEF is to monitor network traffic based on predetermined security rules, assess and categorize network traffic based on predetermined security rules; detect any security threats or data breaches, and control network traffic based on predetermined security rules.

Example 12 includes the method of example 11 and/or some other example(s) herein, wherein the control of the network traffic based on security rules includes routing security sensitive traffic through trusted routes, ensuring suitable protection of security sensitive payload, and addressing any detected security issues by terminating the transmission of security sensitive data in case of the detection of such issues.

Example 13 includes the method of examples 11-12 and/or some other example(s) herein, wherein the MEF is to interact with another NF or an application function (AF) to validate transmission strategies, wherein the transmission strategies include a level of encryption, a routing strategy, and validation of recipients.

Example 14 includes the method of examples 8-13 and/or some other example(s) herein, wherein the NEF is part of a hierarchical NEF framework including one or more NEFs, wherein each NEF in the hierarchical NEF framework provides a different level of trust according to a respective trust domain.

Example 15 includes the method of example 14 and/or some other example(s) herein, wherein each NEF in the hierarchical NEF framework is communicatively coupled to at least one other NEF in the hierarchical NEF framework to successively provide exposure to different levels of trust.

Example 16 includes the method of example 15 and/or some other example(s) herein, wherein each NEF in the hierarchical NEF framework provides one or more of: differentiating availability of privacy or security related information among the levels of trust; granting access to a limited set of available data to other functions including other NEFs in the hierarchical NEF framework; and defining a set of information elements for each of hierarchy levels in the hierarchical NEF framework based on the levels of trust.

Example 17 includes the method of examples 15-16 and/or some other example(s) herein, wherein each NEF in the hierarchical NEF framework provides respective risk assessments for access to a corresponding level of trust.

Example 18 includes the method of examples 1-17 and/or some other example(s) herein, wherein the measurement equipment is a user equipment (UE), a radio access network (RAN) node, a user plane function (UPF), or a data network (DN) node.

Example 19 includes the method of examples 1-18 and/or some other example(s) herein, wherein the REuT is a user equipment (UE), a radio access network (RAN) node, a user plane function (UPF), or a data network (DN) node.

Example 20 includes the method of examples 1-19 and/or some other example(s) herein, wherein a translation entity within the REuT terminates the test access interface, and the translation entity is to convert the first signaling into an internal format for consumption by a component under test (CUT) within the REuT.

Example 21 includes the method of example 20 and/or some other example(s) herein, wherein the first signaling includes an attack vector to be applied to one or more target components of the REuT, and the translation entity is to provide the attack vector to the CUT via an interface between the translation entity and the CUT.

Example 22 includes the method of example 21 and/or some other example(s) herein, wherein the interface between the translation entity and the CUT is a standardized interconnect or a proprietary interface.

Example 23 includes the method of examples 21-22 and/or some other example(s) herein, wherein the method includes: receiving, from the translation entity, a test results indicator including attack vector data, the attack vector data indicating whether the attack vector was successful or not successful.

Example 24 includes the method of example 23 and/or some other example(s) herein, wherein the test results indicator indicates that the attack was unsuccessful when the CUT is able to detect the attack vector and is able to initiate one or more countermeasures to the attack vector, and the test results indicator indicates that the attack was successful when the CUT is unable to detect the attack vector during a predefined period of time.

Example 25 includes the method of examples 1-24 and/or some other example(s) herein, wherein the method includes: accessing attack history data from the REuT via a special access interface.

Example 26 includes the method of example 25 and/or some other example(s) herein, wherein the special access interface is between the measurement equipment and a memory unit of the REuT.

Example 27 includes the method of example 26 and/or some other example(s) herein, wherein the memory unit is a shielded location or tamper-resistant circuitry configured to buffer history data related to exchanges with external entities and/or observed (attempted) attacks.

Example 28 includes the method of example 27 and/or some other example(s) herein, wherein the memory unit includes some or all of a write-only memory of the REuT, a trusted execution environment (TEE) of the REuT, a trusted platform module (TPM) of the REuT, or one or more secure enclaves of the REuT.

Example 29 includes the method of examples 26-28 and/or some other example(s) herein, wherein the method includes: receiving, from the memory unit, a data structure including the history data, the history data including information about attempted attacks on the REuT, successful attacks on the REuT, and other exchanges between the REuT and one or more other devices.

Example 30 includes the method of example 29 and/or some other example(s) herein, wherein the method includes: evaluating if the REuT has been compromised based on the history data; and deactivating the REuT when the REuT has been determined to be compromised.

Example 31 includes a method of operating a Monitoring and Enforcement Function (MEF), the method comprising: monitoring network traffic based on one or more security rules; assessing and categorizing network traffic based on the one or more security rules; controlling network traffic based on the one or more security rules; and detecting security threats or data breaches.

Example 32 includes the method of example 31 and/or some other example(s) herein, wherein the controlling the network traffic includes: routing security sensitive traffic through trusted routes; ensuring suitable protection of security sensitive payload through an encryption mechanism; and addressing any detected security issues including terminating transmission of sensitive data in case of detection of such issues.

Example 33 includes the method of example 32 and/or some other example(s) herein, wherein the controlling the network traffic includes: reducing a transmission rate through interaction with one or more network functions (NFs) of a cellular network.

Example 34 includes the method of examples 32-33 and/or some other example(s) herein, wherein the method includes: detecting issues related to untrusted components through suitable observation of inputs and outputs and detection of anomalies; and disconnecting identified untrusted components from network access when an issue is detected.

Example 35 includes the method of examples 32-34 and/or some other example(s) herein, wherein the controlling the network traffic includes: validating origin addresses of one or more data packets including identifying one or more data packets as originating from an untrusted source; and one or both of: discarding the identified one or more data packets; and tagging the identified one or more data packets.

Example 36 includes the method of examples 32-35 and/or some other example(s) herein, wherein the controlling the network traffic includes: detecting a level of access to a target network address as a potential distributed denial of service (DDoS) attack; and implementing one or more DDoS countermeasures when a potential DDoS attack is detected.

Example 37 includes the method of example 36 and/or some other example(s) herein, wherein the detecting comprises identifying a source network address issuing a threshold number of requests to a target network address.

Example 38 includes the method of examples 36-37 and/or some other example(s) herein, wherein the one or more DDoS countermeasures include one or more of: increasing network latency randomly across various requests to reduce a number of simultaneously arriving requests; to randomly dropping a certain amount of packets such that a level of requests stays at a manageable level for the target network address; holding randomly selected packets back for a limited period of time to reduce a number of simultaneously arriving requests; excluding one or more source network addresses from network access for a predetermined or configured period of time; and limiting network capacity for one or more identified source network addresses.

Example 39 includes the method of examples 32-38 and/or some other example(s) herein, wherein the controlling the network traffic includes: observing enforcement of access rights; rejecting any unauthorized access; attaching a limited time-to-live (TTL) to any access right status; and withdrawing the access rights after expiration of the TTL.

Example 40 includes the method of example 39 and/or some other example(s) herein, wherein the method includes: issuing warnings indicating upcoming expiration of access rights.

Example 41 includes the method of examples 32-40 and/or some other example(s) herein, wherein the controlling the network traffic includes: triggering restoration of availability and access to data when a physical or technical incident is detected.

Example 42 includes the method of example 41 and/or some other example(s) herein, wherein the method includes: backing-up data required to timely restore the availability and access to data in case of the physical or technical incident.

Example 43 includes the method of examples 32-42 and/or some other example(s) herein, wherein the controlling the network traffic includes: monitoring whether one or more nodes are violating any principles of being secure by default or design; and implementing principle countermeasures when a violation is detected.

Example 44 includes the method of example 43 and/or some other example(s) herein, wherein the principle countermeasures include one or more of: disabling network access for nodes identified as violating a principle; limiting network access for nodes identified as violating a principle; increasing network latency for nodes identified as violating a principle; dropping a number of packets for nodes identified as violating a principle; holding randomly selected packets back for a period of time for nodes identified as violating a principle; and limiting network capacity for nodes identified as violating a principle.

Example 45 includes the method of examples 32-44 and/or some other example(s) herein, wherein the controlling the network traffic includes: maintaining a database on known hardware and software vulnerabilities; and adding new vulnerabilities to the database as they are detected.

Example 46 includes the method of examples 33-46 and/or some other example(s) herein, wherein the controlling the network traffic includes: checking whether any new hardware and software updates meet requirements of suitable encryption, authentication, and integrity verification; and issuing a warning to the one or more NFs when the requirements are not met.

Example 47 includes the method of examples 32-46 and/or some other example(s) herein, wherein the controlling the network traffic includes: identifying network entities that are accessible by identical passwords; informing a service provider of the identified network entities of detected identical passwords; and removing network access for the identified network entities.

Example 48 includes the method of examples 32-47 and/or some other example(s) herein, wherein the controlling the network traffic includes: scanning for traffic related to password sniffing; and causing execution of one or more password sniffing countermeasures when the password sniffing is detected.

Example 49 includes the method of example 48 and/or some other example(s) herein, wherein the password sniffing countermeasures include one or more of: disabling network access for nodes communicating the traffic related to password sniffing; and informing appropriate authorities about the traffic related to password sniffing.

Example 50 includes the method of examples 32-49 and/or some other example(s) herein, wherein the controlling the network traffic includes: detecting an issue with a password policy; and pausing or stopping processing of security critical information until the password policy issue is resolved.

Example 51 includes the method of examples 33-50 and/or some other example(s) herein, wherein the controlling the network traffic includes: detecting a predetermined or configured number of failed accesses; and issuing a warning to the one or more NFs when the number of failed accesses is detected.

Example 52 includes the method of examples 32-51 and/or some other example(s) herein, wherein the controlling the network traffic includes: detecting an attempted credential theft; identifying a source node of the attempted credential theft; and executing attempted credential theft countermeasures.

Example 53 includes the method of example 52 and/or some other example(s) herein, wherein the attempted credential theft countermeasures include one or more of: disabling network access for the source node of the attempted credential theft; and informing appropriate authorities about the attempted credential theft.

Example 54 includes the method of examples 32-53 and/or some other example(s) herein, wherein the controlling the network traffic includes: performing automatic code scans to identify whether credentials, passwords, and cryptographic keys are defined in software or firmware source code itself and which cannot be changed.

Example 55 includes the method of examples 32-54 and/or some other example(s) herein, wherein the controlling the network traffic includes: periodically or cyclically verifying protection mechanisms for passwords, credentials, and cryptographic keys; detecting weaknesses in the protection mechanisms; and executing protection mechanism countermeasures based on the detected weaknesses.

Example 56 includes the method of example 55 and/or some other example(s) herein, wherein the protection mechanism countermeasures include one or more of: disabling network access for compute nodes having detected potential weaknesses; and informing appropriate authorities about the detected potential weaknesses.

Example 57 includes the method of examples 32-56 and/or some other example(s) herein, wherein the controlling the network traffic includes: updating software or firmware that employ adequate encryption, authentication, and integrity verification mechanisms.

Example 58 includes the method of examples 31-57 and/or some other example(s) herein, wherein the MEF is a same MEF of any one or more of examples 4-30.

Example 59 includes a method of operating a compute device, the method comprising: requesting identity (ID) information from a neighboring device; determining whether the neighboring device complies with a Radio Equipment Directive (RED) based on the requested ID information; and declaring the neighboring device to be a trustworthy device when the neighboring device complies with the RED.

Example 60 includes the method of example 59 and/or some other example(s) herein, wherein the method includes: obtaining a list of trustworthy devices from a RED compliance database; and determining whether the neighboring device complies with the RED further based on the list of trustworthy devices.

Example 61 includes the method of examples 59-60 and/or some other example(s) herein, wherein the method includes: obtaining a list of untrustworthy devices from a RED compliance database; and determining whether the neighboring device complies with the RED based on the list of untrustworthy devices.

Example 62 includes the method of examples 59-61 and/or some other example(s) herein, wherein the method includes: causing termination of a connection with the neighboring device when the neighboring device is not declared to be a trustworthy device.

Example 63 includes the method of examples 59-62 and/or some other example(s) herein, wherein the method includes: performing a data exchange process with the neighboring device when the neighboring device is declared to be a trustworthy device.

Example 64 includes the method of examples 59-63 and/or some other example(s) herein, wherein the method includes: receiving a data unit from a source node; adding ID information of the compute device to the data unit; and sending the data unit with the added ID information towards a destination node.

Example 65 includes the method of example 64 and/or some other example(s) herein, wherein adding the ID information of the compute device to the data unit includes: operating a network provenance process to add the ID information of the compute device to the data unit.

Example 66 includes the method of examples 64-65 and/or some other example(s) herein, wherein the compute device is the source node, the destination node, or a node between the source node and the destination node.

Example 67 includes the method of examples 64-65 and/or some other example(s) herein, wherein the neighboring device is the source node, the destination node, or a node between the source node and the destination node.

Example 68 includes the method of examples 64-67 and/or some other example(s) herein, wherein each node between the source node and the destination node adds respective ID information to the data unit, and the destination node uses the ID information included in the data unit to verify whether the data only passed through trusted equipment, and discards the data unit if the data unit passed through an untrustworthy device.

Example 69 includes one or more computer readable media comprising instructions, wherein execution of the instructions by processor circuitry is to cause the processor circuitry to perform the method of examples 1-68 and/or any other aspect discussed herein. Example 70 includes a computer program comprising the instructions of example 69 and/or some other example(s) herein. Example 71 includes an Application Programming Interface defining functions, methods, variables, data structures, and/or protocols for the computer program of example 70 and/or some other example(s) herein. Example 72 includes an apparatus comprising circuitry loaded with the instructions of example 69 and/or some other example(s) herein. Example 73 includes an apparatus comprising circuitry operable to run the instructions of example 69 and/or some other example(s) herein. Example 74 includes an integrated circuit comprising one or more of the processor circuitry and the one or more computer readable media of example 69 and/or some other example(s) herein. Example 75 includes a computing system comprising the one or more computer readable media and the processor circuitry of example 69 and/or some other example(s) herein. Example 76 includes an apparatus comprising means for executing the instructions of example 69 and/or some other example(s) herein. Example 77 includes a signal generated as a result of executing the instructions of example 69 and/or some other example(s) herein. Example 78 includes a data unit generated as a result of executing the instructions of example 69 and/or some other example(s) herein. Example 79 includes the data unit of example 78 and/or some other example(s) herein, the data unit is a datagram, network packet, data frame, data segment, a Protocol Data Unit (PDU), a Service Data Unit (SDU), a message, or a database object. Example 80 includes a signal encoded with the data unit of examples 78-79 and/or some other example(s) herein. Example 81 includes an electromagnetic signal carrying the instructions of example 69. and/or some other example(s) herein Example 82 includes an apparatus comprising means for performing the method of examples 1-68 and/or some other example(s) herein.

### 7. Terminology

As used herein, the singular forms “a,” “an” and “the” are intended to include plural forms as well, unless the context clearly indicates otherwise. It will be further understood that the terms “comprises” and/or “comprising,” when used in this specification, specific the presence of stated features, integers, steps, operations, elements, and/or components, but do not preclude the presence or addition of one or more other features, integers, steps, operation, elements, components, and/or groups thereof. The phrase “A and/or B” means (A), (B), or (A and B). For the purposes of the present disclosure, the phrase “A, B, and/or C” means (A), (B), (C), (A and B), (A and C), (B and C), or (A, B and C). The description may use the phrases “in an embodiment,” or “In some embodiments,” each of which may refer to one or more of the same or different embodiments. Furthermore, the terms “comprising,” “including,” “having,” and the like, as used with respect to the present disclosure, are synonymous.

The terms “coupled,” “communicatively coupled,” along with derivatives thereof are used herein. The term “coupled” may mean two or more elements are in direct physical or electrical contact with one another, may mean that two or more elements indirectly contact each other but still cooperate or interact with each other, and/or may mean that one or more other elements are coupled or connected between the elements that are said to be coupled with each other. The term “directly coupled” may mean that two or more elements are in direct contact with one another. The term “communicatively coupled” may mean that two or more elements may be in contact with one another by a means of communication including through a wire or other interconnect connection, through a wireless communication channel or ink, and/or the like.

The term “establish” or “establishment” at least in some examples refers to (partial or in full) acts, tasks, operations, and/or the like, related to bringing or the readying the bringing of something into existence either actively or passively (e.g, exposing a device identity or entity identity). Additionally or alternatively, the term “establish” or “establishment” at least in some examples refers to (partial or in full) acts, tasks, operations, and/or the like, related to initiating, starting, or warming communication or initiating, starting, or warming a relationship between two entities or elements (e.g, establish a session, establish a session, and/or the like). Additionally or alternatively, the term “establish” or “establishment” at least in some examples refers to initiating something to a state of working readiness. The term “established” at least in some examples refers to a state of being operational or ready for use (e.g, full establishment). Furthermore, any definition for the term “establish” or “establishment” defined in any specification or standard can be used for purposes of the present disclosure and such definitions are not disavowed by any of the aforementioned definitions.

The term “obtain” at least in some examples refers to (partial or in full) acts, tasks, operations, and/or the like, of intercepting, movement, copying, retrieval, or acquisition (e.g, from a memory, an interface, or a buffer), on the original packet stream or on a copy (e.g, anew instance) of the packet stream. Other aspects of obtaining or receiving may involving instantiating, enabling, or controlling the ability to obtain or receive a stream of packets (or the following parameters and templates or template values).

The term “receipt” at least in some examples refers to any action (or set of actions) involved with receiving or obtaining an object, data, data unit, and/or the like, and/or the fact of the object, data, data unit, and/or the like. being received. The term “receipt” at least in some examples refers to an object, data, data unit, and/or the like, being pushed to a device, system, element, and/or the like. (e.g, often referred to as a push model), pulled by a device, system, element, and/or the like. (e.g, often referred to as a pull model), and/or the like.

The term “element” at least in some examples refers to a unit that is indivisible at a given level of abstraction and has a clearly defined boundary, wherein an element may be any type of entity including, for example, one or more devices, systems, controllers, network elements, modules, and so forth, or combinations thereof.

The term “measurement” at least in some examples refers to the observation and/or quantification of attributes of an object, event, or phenomenon. Additionally or alternatively, the term “measurement” at least in some examples refers to a set of operations having the object of determining a measured value or measurement result, and/or the actual instance or execution of operations leading to a measured value.

The term “metric” at least in some examples refers to a standard definition of a quantity, produced in an assessment of performance and/or reliability of the network, which has an intended utility and is carefully specified to convey the exact meaning of a measured value.

The term “signal” at least in some examples refers to an observable change in a quality and/or quantity. Additionally or alternatively, the term “signal” at least in some examples refers to a function that conveys information about of an object, event, or phenomenon. Additionally or alternatively, the term “signal” at least in some examples refers to any time varying voltage, current, or electromagnetic wave that may or may not carry information. The term “digital signal” at least in some examples refers to a signal that is constructed from a discrete set of waveforms of a physical quantity so as to represent a sequence of discrete values.

The terms “ego” (as in, e.g, “ego device”) and “subject” (as in, e.g, “data subject”) at least in some examples refers to an entity, element, device, system, and/or the like, that is under consideration or being considered. The terms “neighbor” and “proximate” (as in, e.g, “proximate device”) at least in some examples refers to an entity, element, device, system, and/or the like, other than an ego device or subject device.

The term “event” at least in some examples refers to a set of outcomes of an experiment (e.g, a subset of a sample space) to which a probability is assigned. Additionally or alternatively, the term “event” at least in some examples refers to a software message indicating that something has happened. Additionally or alternatively, the term “event” at least in some examples refers to an object in time, or an instantiation of a property in an object. Additionally or alternatively, the term “event” at least in some examples refers to a point in space at an instant in time (e.g, a location in space-time). Additionally or alternatively, the term “event” at least in some examples refers to a notable occurrence at a particular point in time.

The term “identifier” at least in some examples refers to a value, or a set of values, that uniquely identify an identity in a certain scope. Additionally or alternatively, the term “identifier” at least in some examples refers to a sequence of characters that identifies or otherwise indicates the identity of a unique object, element, or entity, or a unique class of objects, elements, or entities. Additionally or alternatively, the term “identifier” at least in some examples refers to a sequence of characters used to identify or refer to an application, program, session, object, element, entity, variable, set of data, and/or the like. The “sequence of characters” mentioned previously at least in some examples refers to one or more names, labels, words, numbers, letters, symbols, and/or any combination thereof. Additionally or alternatively, the term “identifier” at least in some examples refers to a name, address, label, distinguishing index, and/or attribute. Additionally or alternatively, the term “identifier” at least in some examples refers to an instance of identification. The term “persistent identifier” at least in some examples refers to an identifier that is reused by a device or by another device associated with the same person or group of persons for an indefinite period.

The term “identification” at least in some examples refers to a process of recognizing an identity as distinct from other identities in a particular scope or context, which may involve processing identifiers to reference an identity in an identity database.

The term “circuitry” at least in some examples refers to a circuit or system of multiple circuits configured to perform a particular function in an electronic device. The circuit or system of circuits may be part of, or include one or more hardware components, such as a logic circuit, a processor (shared, dedicated, or group) and/or memory (shared, dedicated, or group), an application-specific integrated circuit (ASIC), field-programmable gate array (FPGA), programmable logic controller (PLC), system on chip (SoC), system in package (SiP), multi-chip package (MCP), digital signal processor (DSP), and/or the like, that are configured to provide the described functionality. In addition, the term “circuitry” may also refer to a combination of one or more hardware elements with the program code used to carry out the functionality of that program code. Some types of circuitry may execute one or more software or firmware programs to provide at least some of the described functionality. Such a combination of hardware elements and program code may be referred to as a particular type of circuitry.

The term “processor circuitry” at least in some examples refers to, is part of, or includes circuitry capable of sequentially and automatically carrying out a sequence of arithmetic or logical operations, or recording, storing, and/or transferring digital data. The term “processor circuitry” at least in some examples refers to one or more application processors, one or more baseband processors, a physical CPU, a single-core processor, a dual-core processor, a triple-core processor, a quad-core processor, and/or any other device capable of executing or otherwise operating computer-executable instructions, such as program code, software modules, and/or functional processes. The terms “application circuitry” and/or “baseband circuitry” may be considered synonymous to, and may be referred to as, “processor circuitry.”

The term “memory” and/or “memory circuitry” at least in some examples refers to one or more hardware devices for storing data, including RAM, MRAM, PRAM, DRAM, and/or SDRAM, core memory, ROM, magnetic disk storage mediums, optical storage mediums, flash memory devices or other machine readable mediums for storing data. The term “computer-readable medium” may include, but is not limited to, memory, portable or fixed storage devices, optical storage devices, and various other mediums capable of storing, containing or carrying instructions or data.

The term “interface circuitry” at least in some examples refers to, is part of, or includes circuitry that enables the exchange of information between two or more components or devices. The term “interface circuitry” at least in some examples refers to one or more hardware interfaces, for example, buses, I/O interfaces, peripheral component interfaces, network interface cards, and/or the like.

The term “device” at least in some examples refers to a physical entity embedded inside, or attached to, another physical entity in its vicinity, with capabilities to convey digital information from or to that physical entity.

The term “entity” at least in some examples refers to a distinct component of an architecture or device, or information transferred as a payload.

The term “controller” at least in some examples refers to an element or entity that has the capability to affect a physical entity, such as by changing its state or causing the physical entity to move.

The term “electronic test equipment”, “test equipment”, or “testing equipment” at least in some examples refers to a device, component, or hardware element (or virtualized device, component, equipment, or hardware elements), or combination of devices, components, and/or hardware elements, used to create analog and/or digital signals, data, instructions, commands, and/or any other means of generating an event or response at a device under test (DUT), and/or captures or otherwise receives or detects responses from the DUTs.

The term “device under test”, “DUT”, “equipment under test”, “EuT”, “unit under test”, “UUT” at least in some examples refers to a device, component, or hardware element, or a combination of devices, components, and/or hardware elements undergoing a test or tests, which may take place during a manufacturing process, as part of ongoing functional testing and/or calibration checks during its lifecycle, for detecting faults and/or during a repair process, and/or in accordance with the original product specification.

The term “terminal” at least in some examples refers to point at which a conductor from a component, device, or network comes to an end. Additionally or alternatively, the term “terminal” at least in some examples refers to an electrical connector acting as an interface to a conductor and creating a point where external circuits can be connected. In some examples, terminals may include electrical leads, electrical connectors, electrical connectors, solder cups or buckets, and/or the like.

The term “compute node” or “compute device” at least in some examples refers to an identifiable entity implementing an aspect of computing operations, whether part of a larger system, distributed collection of systems, or a standalone apparatus. In some examples, a compute node may be referred to as a “computing device”, “computing system”, or the like, whether in operation as a client, server, or intermediate entity. Specific implementations of a compute node may be incorporated into a server, base station, gateway, road side unit, on-premise unit, user equipment, end consuming device, appliance, or the like.

The term “computer system” at least in some examples refers to any type interconnected electronic devices, computer devices, or components thereof. Additionally, the terms “computer system” and/or “system” at least in some examples refer to various components of a computer that are communicatively coupled with one another. Furthermore, the term “computer system” and/or “system” at least in some examples refer to multiple computer devices and/or multiple computing systems that are communicatively coupled with one another and configured to share computing and/or networking resources.

The term “server” at least in some examples refers to a computing device or system, including processing hardware and/or process space(s), an associated storage medium such as a memory device or database, and, in some instances, suitable application(s) as is known in the art. The terms “server system” and “server” may be used interchangeably herein, and these terms at least in some examples refers to one or more computing system(s) that provide access to a pool of physical and/or virtual resources. The various servers discussed herein include computer devices with rack computing architecture component(s), tower computing architecture component(s), blade computing architecture component(s), and/or the like. The servers may represent a cluster of servers, a server farm, a cloud computing service, or other grouping or pool of servers, which may be located in one or more datacenters. The servers may also be connected to, or otherwise associated with, one or more data storage devices (not shown). Moreover, the servers may include an operating system (OS) that provides executable program instructions for the general administration and operation of the individual server computer devices, and may include a computer-readable medium storing instructions that, when executed by a processor of the servers, may allow the servers to perform their intended functions. Suitable implementations for the OS and general functionality of servers are known or commercially available, and are readily implemented by persons having ordinary skill in the art.

The term “platform” at least in some examples refers to an environment in which instructions, program code, software elements, and the like can be executed or otherwise operate, and examples of such an environment include an architecture (e.g, a motherboard, a computing system, and/or the like), one or more hardware elements (e.g, embedded systems, and the like), a cluster of compute nodes, a set of distributed compute nodes or network, an operating system, a virtual machine (VM), a virtualization container, a software framework, a client application (e.g, web browser or the like) and associated application programming interfaces, a cloud computing service (e.g, platform as a service (PaaS)), or other underlying software executed with instructions, program code, software elements, and the like.

The term “architecture” at least in some examples refers to a computer architecture or a network architecture. The term “computer architecture” at least in some examples refers to a physical and logical design or arrangement of software and/or hardware elements in a computing system or platform including technology standards for interacts therebetween. The term “network architecture” at least in some examples refers to a physical and logical design or arrangement of software and/or hardware elements in a network including communication protocols, interfaces, and media transmission.

The term “appliance,” “computer appliance,” and the like, at least in some examples refers to a computer device or computer system with program code (e.g, software or firmware) that is specifically designed to provide a specific computing resource. The term “virtual appliance” at least in some examples refers to a virtual machine image to be implemented by a hypervisor-equipped device that virtualizes or emulates a computer appliance or otherwise is dedicated to provide a specific computing resource. The term “security appliance”, “firewall”, and the like at least in some examples refers to a computer appliance designed to protect computer networks from unwanted traffic and/or malicious attacks. The term “policy appliance” at least in some examples refers to technical control and logging mechanisms to enforce or reconcile policy rules (information use rules) and to ensure accountability in information systems.

The term “gateway” at least in some examples refers to a network appliance that allows data to flow from one network to another network, or a computing system or application configured to perform such tasks. Examples of gateways include IP gateways, Internet-to-Orbit (I2O) gateways, IoT gateways, cloud storage gateways, and/or the like.

The term “user equipment” or “UE” at least in some examples refers to a device with radio communication capabilities and may describe a remote user of network resources in a communications network. The term “user equipment” or “UE” may be considered synonymous to, and may be referred to as, client, mobile, mobile device, mobile terminal, user terminal, mobile unit, station, mobile station, mobile user, subscriber, user, remote station, access agent, user agent, receiver, radio equipment, reconfigurable radio equipment, reconfigurable mobile device, and/or the like. Furthermore, the term “user equipment” or “UE” may include any type of wireless/wired device or any computing device including a wireless communications interface. Examples of UEs, client devices, and/or the like, include desktop computers, workstations, laptop computers, mobile data terminals, smartphones, tablet computers, wearable devices, machine-to-machine (M2M) devices, machine-type communication (MTC) devices, Internet of Things (IoT) devices, embedded systems, sensors, autonomous vehicles, drones, robots, in-vehicle infotainment systems, instrument clusters, onboard diagnostic devices, dashtop mobile equipment, electronic engine management systems, electronic/engine control units/modules, microcontrollers, control module, server devices, network appliances, head-up display (HUD) devices, helmet-mounted display devices, augmented reality (AR) devices, virtual reality (VR) devices, mixed reality (MR) devices, and/or other like systems or devices.

The term “station” or “STA” at least in some examples refers to a logical entity that is a singly addressable instance of a medium access control (MAC) and physical layer (PHY) interface to the wireless medium (WM). The term “wireless medium” or WM” at least in some examples refers to the medium used to implement the transfer of protocol data units (PDUs) between peer physical layer (PHY) entities of a wireless local area network (LAN).

The term “network element” at least in some examples refers to physical or virtualized equipment and/or infrastructure used to provide wired or wireless communication network services. The term “network element” may be considered synonymous to and/or referred to as a networked computer, networking hardware, network equipment, network node, router, switch, hub, bridge, radio network controller, network access node (NAN), base station, access point (AP), RAN device, RAN node, gateway, server, network appliance, network function (NF), virtualized NF (VNF), and/or the like.

The term “network access node” or “NAN” at least in some examples refers to a network element in a radio access network (RAN) responsible for the transmission and reception of radio signals in one or more cells or coverage areas to or from a UE or station. A “network access node” or “NAN” can have an integrated antenna or may be connected to an antenna array by feeder cables. Additionally or alternatively, a “network access node” or “NAN” may include specialized digital signal processing, network function hardware, and/or compute hardware to operate as a compute node. In some examples, a “network access node” or “NAN” may be split into multiple functional blocks operating in software for flexibility, cost, and performance. In some examples, a “network access node” or “NAN” may be a base station (e.g, an evolved Node B (eNB) or a next generation Node B (gNB)), an access point and/or wireless network access point, router, switch, hub, radio unit or remote radio head, Transmission Reception Point (TRxP), a gateway device (e.g, Residential Gateway, Wireline 5G Access Network, Wireline 5G Cable Access Network, Wireline BBF Access Network, and the like), network appliance, and/or some other network access hardware.

The term “access point” or “AP” at least in some examples refers to an entity that contains one station (STA) and provides access to the distribution services, via the wireless medium (WM) for associated STAs. An AP comprises a STA and a distribution system access function (DSAF).

The term “cell” at least in some examples refers to a radio network object that can be uniquely identified by a UE from an identifier (e.g, cell ID) that is broadcasted over a geographical area from a network access node (NAN). Additionally or alternatively, the term “cell” at least in some examples refers to a geographic area covered by a NAN.

The term “serving cell” at least in some examples refers to a primary cell (PCell) for a UE in a connected mode or state (e.g, RRC_CONNECTED) and not configured with carrier aggregation (CA) and/or dual connectivity (DC). Additionally or alternatively, the term “serving cell” at least in some examples refers to a set of cells comprising zero or more special cells and one or more secondary cells for a UE in a connected mode or state (e.g, RRC_CONNECTED) and configured with CA.

The term “primary cell” or “PCell” at least in some examples refers to a Master Cell Group (MCG) cell, operating on a primary frequency, in which a UE either performs an initial connection establishment procedure or initiates a connection re-establishment procedure. The term “Secondary Cell” or “SCell” at least in some examples refers to a cell providing additional radio resources on top of a special cell (SpCell) for a UE configured with CA. The term “special cell” or “SpCell” at least in some examples refers to a PCell for non-DC operation or refers to a PCell of an MCG or a PSCell of an SCG for DC operation.

The term “Master Cell Group” or “MCG” at least in some examples refers to a group of serving cells associated with a “Master Node” comprising a SpCell (PCell) and optionally one or more SCells. The term “Secondary Cell Group” or “SCG” at least in some examples refers to a subset of serving cells comprising a Primary SCell (PSCell) and zero or more SCells for a UE configured with DC. The term “Primary SCG Cell” refers to the SCG cell in which a UE performs random access when performing a reconfiguration with sync procedure for DC operation.

The term “Master Node” or “MN” at least in some examples refers to a NAN that provides control plane connection to a core network. The term “Secondary Node” or “SN” at least in some examples refers to a NAN providing resources to the UE in addition to the resources provided by an MN and/or a NAN with no control plane connection to a core network

The term “E-UTEAN NodeB”, “eNodeB”, or “eNB” at least in some examples refers to a RAN node providing E-UTRA user plane (PDCP/RLC/MAC/PHY) and control plane (RRC) protocol terminations towards a UE, and connected via an S1 interface to the Evolved Packet Core (EPC). Two or more eNBs are interconnected with each other (and/or with one or more en-gNBs) by means of an X2 interface.

The term “next generation eNB” or “ng-eNB” at least in some examples refers to a RAN node providing E-UTRA user plane and control plane protocol terminations towards a UE, and connected via the NG interface to the 5GC. Two or more ng-eNBs are interconnected with each other (and/or with one or more gNBs) by means of an Xn interface.

The term “Next Generation NodeB”, “gNodeB”, or “gNB” at least in some examples refers to a RAN node providing NR user plane and control plane protocol terminations towards a UE, and connected via the NG interface to the 5GC. Two or more gNBs are interconnected with each other (and/or with one or more ng-eNBs) by means of an Xn interface.

The term “E-UTRA-NR gNB” or “en-gNB” at least in some examples refers to a RAN node providing NR user plane and control plane protocol terminations towards a UE, and acting as a Secondary Node in E-UTRA-NR Dual Connectivity (EN-DC) scenarios (see e.g, 3GPP TS 37.340 v16.6.0 (2021-07-09)). Two or more en-gNBs are interconnected with each other (and/or with one or more eNBs) by means of an X2 interface.

The term “Next Generation RAN node” or “NG-RAN node” at least in some examples refers to either a gNB or an ng-eNB.

The term “IAB-node” at least in some examples refers to a RAN node that supports new radio (NR) access links to user equipment (UEs) and NR backhaul links to parent nodes and child nodes. The term “IAB-donor” at least in some examples refers to a RAN node (e.g, a gNB) that provides network access to UEs via a network of backhaul and access links.

The term “Transmission Reception Point” or “TRxP” at least in some examples refers to an antenna array with one or more antenna elements available to a network located at a specific geographical location for a specific area.

The term “Central Unit” or “CU” at least in some examples refers to a logical node hosting radio resource control (RRC), Service Data Adaptation Protocol (SDAP), and/or Packet Data Convergence Protocol (PDCP) protocols/layers of an NG-RAN node, or RRC and PDCP protocols of the en-gNB that controls the operation of one or more DUs; a CU terminates an F1 interface connected with a DU and may be connected with multiple DUs.

The term “Distributed Unit” or “DU” at least in some examples refers to a logical node hosting Backhaul Adaptation Protocol (BAP), F1 application protocol (F1AP), radio link control (RLC), medium access control (MAC), and physical (PHY) layers of the NG-RAN node or en-gNB, and its operation is partly controlled by a CU; one DU supports one or multiple cells, and one cell is supported by only one DU; and a DU terminates the F1 interface connected with a CU.

The term “Radio Unit” or “RU” at least in some examples refers to a logical node hosting PHY layer or Low-PHY layer and radiofrequency (RF) processing based on a lower layer functional split.

The term “split architecture” at least in some examples refers to an architecture in which an RU and DU are physically separated from one another, and/or an architecture in which a DU and a CU are physically separated from one another. The term “integrated architecture at least in some examples refers to an architecture in which an RU and DU are implemented on one platform, and/or an architecture in which a DU and a CU are implemented on one platform.

The term “Residential Gateway” or “RG” at least in some examples refers to a device providing, for example, voice, data, broadcast video, video on demand, to other devices in customer premises. The term “Wireline 5G Access Network” or “W-5GAN” at least in some examples refers to a wireline AN that connects to a 5GC via N2 and N3 reference points. The W-5GAN can be either a W-5GBAN or W-5GCAN. The term “Wireline 5G Cable Access Network” or “W-5GCAN” at least in some examples refers to an Access Network defined in/by CableLabs. The term “Wireline BBF Access Network” or “W-5GBAN” at least in some examples refers to an Access Network defined in/by the Broadband Forum (BBF). The term “Wireline Access Gateway Function” or “W-AGF” at least in some examples refers to a Network function in W-5GAN that provides connectivity to a 3GPP 5G Core network (5GC) to 5G-RG and/or FN-RG. The term “5G-RG” at least in some examples refers to an RG capable of connecting to a 5GC playing the role of a user equipment with regard to the 5GC; it supports secure element and exchanges N1 signaling with 5GC. The 5G-RG can be either a 5G-BRG or 5G-CRG.

The term “edge computing” encompasses many implementations of distributed computing that move processing activities and resources (e.g, compute, storage, acceleration resources) towards the “edge” of the network, in an effort to reduce latency and increase throughput for endpoint users (client devices, user equipment, and/or the like). Such edge computing implementations typically involve the offering of such activities and resources in cloud-like services, functions, applications, and subsystems, from one or multiple locations accessible via wireless networks. Thus, the references to an “edge” of a network, cluster, domain, system or computing arrangement used herein are groups or groupings of functional distributed compute elements and, therefore, generally unrelated to “edges” (links or connections) as used in graph theory.

The term “central office” (or CO) indicates an aggregation point for telecommunications infrastructure within an accessible or defined geographical area, often where telecommunication service providers have traditionally located switching equipment for one or multiple types of access networks. The CO can be physically designed to house telecommunications infrastructure equipment or compute, data storage, and network resources. The CO need not, however, be a designated location by a telecommunications service provider. The CO may host any number of compute devices for Edge applications and services, or even local implementations of cloud-like services.

The term “cloud computing” or “cloud” at least in some examples refers to a paradigm for enabling network access to a scalable and elastic pool of shareable computing resources with self-service provisioning and administration on-demand and without active management by users. Cloud computing provides cloud computing services (or cloud services), which are one or more capabilities offered via cloud computing that are invoked using a defined interface (e.g, an API or the like). The term “cloud service provider” or “CSP” at least in some examples refers to an organization that operates and/or provides cloud resources including centralized, regional, and edge data centers. A CSP may be referred to as a cloud service operator (CSO). References to “cloud computing” or “cloud computing services” at least in some examples refers to computing resources and services offered by a CSP or CSO at remote locations with at least some increased latency, distance, or constraints.

The term “compute resource” or simply “resource” at least in some examples refers to any physical or virtual component, or usage of such components, of limited availability within a computer system or network. Examples of computing resources include usage/access to, for a period of time, servers, processor(s), storage equipment, memory devices, memory areas, networks, electrical power, input/output (peripheral) devices, mechanical devices, network connections (e.g, channels/links, ports, network sockets, and/or the like), operating systems, virtual machines (VMs), virtualization containers, software/applications, computer files, and/or the like.

The term “data center” at least in some examples refers to a purpose-designed structure that is intended to house multiple high-performance compute and data storage nodes such that a large amount of compute, data storage and network resources are present at a single location. This often entails specialized rack and enclosure systems, suitable heating, cooling, ventilation, security, fire suppression, and power delivery systems. The term may also refer to a compute and data storage node in some contexts. A data center may vary in scale between a centralized or cloud data center (e.g, largest), regional data center, and edge data center (e.g, smallest).

The term “access edge layer” indicates the sub-layer of infrastructure edge closest to the end user or device. For example, such layer may be fulfilled by an edge data center deployed at a cellular network site. The access edge layer functions as the front line of the infrastructure Edge and may connect to an aggregation Edge layer higher in the hierarchy.

The term “aggregation edge layer” indicates the layer of infrastructure edge one hop away from the access edge layer. This layer can exist as either a medium-scale data center in a single location or may be formed from multiple interconnected micro data centers to form a hierarchical topology with the access Edge to allow for greater collaboration, workload failover, and scalability than access Edge alone.

The term “network function” or “NF” at least in some examples refers to a functional block within a network infrastructure that has one or more external interfaces and a defined functional behavior.

The term “network service” or “NS” at least in some examples refers to a composition of Network Function(s) and/or Network Service(s), defined by its functional and behavioral specification(s).

The term “network function virtualization” or “NFV” at least in some examples refers to the principle of separating network functions from the hardware they run on by using virtualization techniques and/or virtualization technologies.

The term “virtualized network function” or “VNF” at least in some examples refers to an implementation of an NF that can be deployed on a Network Function Virtualization Infrastructure (NFVI).

The term “Network Functions Virtualization Infrastructure Manager” or “NFVI” at least in some examples refers to a totality of all hardware and software components that build up the environment in which VNFs are deployed.

The term “management function” at least in some examples refers to a logical entity playing the roles of a service consumer and/or a service producer. The term “management service” at least in some examples refers to a set of offered management capabilities.

The term “slice” at least in some examples refers to a set of characteristics and behaviors that separate one instance, traffic, data flow, application, application instance, link or connection, RAT, device, system, entity, element, and/or the like. from another instance, traffic, data flow, application, application instance, link or connection, RAT, device, system, entity, element, and/or the like, or separate one type of instance, and/or the like, from another instance, and/or the like.

The term “network slice” at least in some examples refers to a logical network that provides specific network capabilities and network characteristics and/or supports various service properties for network slice service consumers. Additionally or alternatively, the term “network slice” at least in some examples refers to a logical network topology connecting a number of endpoints using a set of shared or dedicated network resources that are used to satisfy specific service level objectives (SLOs) and/or service level agreements (SLAs). The term “network slicing” at least in some examples refers to methods, processes, techniques, and technologies used to create one or multiple unique logical and virtualized networks over a common multi-domain infrastructure. The term “access network slice”, “radio access network slice”, or “RAN slice” at least in some examples refers to a part of a network slice that provides resources in a RAN to fulfill one or more application and/or service requirements (e.g, SLAs, and/or the like). The term “network slice instance” at least in some examples refers to a set of Network Function instances and the required resources (e.g. compute, storage and networking resources) which form a deployed network slice. Additionally or alternatively, the term “network slice instance” at least in some examples refers to a representation of a service view of a network slice. The term “network instance” at least in some examples refers to information identifying a domain.

The term “service consumer” at least in some examples refers to an entity that consumes one or more services. The term “service producer” at least in some examples refers to an entity that offers, serves, or otherwise provides one or more services. The term “service provider” at least in some examples refers to an organization or entity that provides one or more services to at least one service consumer. For purposes of the present disclosure, the terms “service provider” and “service producer” may be used interchangeably even though these terms may refer to difference concepts. Examples of service providers include cloud service provider (CSP), network service provider (NSP), application service provider (ASP) (e.g, Application software service provider in a service-oriented architecture (ASSP)), internet service provider (ISP), telecommunications service provider (TSP), online service provider (OSP), payment service provider (PSP), managed service provider (MSP), storage service providers (SSPs), SAML service provider, and/or the like. At least in some examples, SLAs may specify, for example, particular aspects of the service to be provided including quality, availability, responsibilities, metrics by which service is measured, as well as remedies or penalties should agreed-on service levels not be achieved. The term “SAML service provider” at least in some examples refers to a system and/or entity that receives and accepts authentication assertions in conjunction with a single sign-on (SSO) profile of the Security Assertion Markup Language (SAML) and/or some other security mechanism(s).

The term “Virtualized Infrastructure Manager” or “VIM” at least in some examples refers to a functional block that is responsible for controlling and managing the NFVI compute, storage and network resources, usually within one operator's infrastructure domain.

The term “virtualization container”, “execution container”, or “container” at least in some examples refers to a partition of a compute node that provides an isolated virtualized computation environment. The term “OS container” at least in some examples refers to a virtualization container utilizing a shared Operating System (OS) kernel of its host, where the host providing the shared OS kernel can be a physical compute node or another virtualization container. Additionally or alternatively, the term “container” at least in some examples refers to a standard unit of software (or a package) including code and its relevant dependencies, and/or an abstraction at the application layer that packages code and dependencies together. Additionally or alternatively, the term “container” or “container image” at least in some examples refers to a lightweight, standalone, executable software package that includes everything needed to run an application such as, for example, code, runtime environment, system tools, system libraries, and settings.

The term “virtual machine” or “VM” at least in some examples refers to a virtualized computation environment that behaves in a same or similar manner as a physical computer and/or a server. The term “hypervisor” at least in some examples refers to a software element that partitions the underlying physical resources of a compute node, creates VMs, manages resources for VMs, and isolates individual VMs from each other.

The term “edge compute node” or “edge compute device” at least in some examples refers to an identifiable entity implementing an aspect of edge computing operations, whether part of a larger system, distributed collection of systems, or a standalone apparatus. In some examples, a compute node may be referred to as a “edge node”, “edge device”, “edge system”, whether in operation as a client, server, or intermediate entity. Additionally or alternatively, the term “edge compute node” at least in some examples refers to a real-world, logical, or virtualized implementation of a compute-capable element in the form of a device, gateway, bridge, system or subsystem, component, whether operating in a server, client, endpoint, or peer mode, and whether located at an “edge” of an network or at a connected location further within the network. References to a “node” used herein are generally interchangeable with a “device”, “component”, and “sub-system”; however, references to an “edge computing system” generally refer to a distributed architecture, organization, or collection of multiple nodes and devices, and which is organized to accomplish or offer some aspect of services or resources in an edge computing setting.

The term “cluster” at least in some examples refers to a set or grouping of entities as part of an Edge computing system (or systems), in the form of physical entities (e.g, different computing systems, networks or network groups), logical entities (e.g, applications, functions, security constructs, containers), and the like. In some locations, a “cluster” is also referred to as a “group” or a “domain”. The membership of cluster may be modified or affected based on conditions or functions, including from dynamic or property-based membership, from network or system management scenarios, or from various example techniques discussed below which may add, modify, or remove an entity in a cluster. Clusters may also include or be associated with multiple layers, levels, or properties, including variations in security features and results based on such layers, levels, or properties.

The term “Data Network” or “DN” at least in some examples refers to a network hosting data-centric services such as, for example, operator services, the internet, third-party services, or enterprise networks. Additionally or alternatively, a DN at least in some examples refers to service networks that belong to an operator or third party, which are offered as a service to a client or user equipment (UE). DNs are sometimes referred to as “Packet Data Networks” or “PDNs”. The term “Local Area Data Network” or “LADN” at least in some examples refers to a DN that is accessible by the UE only in specific locations, that provides connectivity to a specific DNN, and whose availability is provided to the UE.

The term “Internet of Things” or “IoT” at least in some examples refers to a system of interrelated computing devices, mechanical and digital machines capable of transferring data with little or no human interaction, and may involve technologies such as real-time analytics, machine learning and/or artificial intelligence (AI), embedded systems, wireless sensor networks, control systems, automation (e.g, smarthome, smart building and/or smart city technologies), and the like. IoT devices are usually low-power devices without heavy compute or storage capabilities. The term “Edge IoT devices” at least in some examples refers to any kind of IoT devices deployed at a network's edge.

The term “protocol” at least in some examples refers to a predefined procedure or method of performing one or more operations. Additionally or alternatively, the term “protocol” at least in some examples refers to a common means for unrelated objects to communicate with each other (sometimes also called interfaces).

The term “communication protocol” at least in some examples refers to a set of standardized rules or instructions implemented by a communication device and/or system to communicate with other devices and/or systems, including instructions for packetizing/depacketizing data, modulating/demodulating signals, implementation of protocols stacks, and/or the like. In various implementations, a “protocol” and/or a “communication protocol” may be represented using a protocol stack, a finite state machine (FSM), and/or any other suitable data structure.

The term “standard protocol” at least in some examples refers to a protocol whose specification is published and known to the public and is controlled by a standards body.

The term “protocol stack” or “network stack” at least in some examples refers to an implementation of a protocol suite or protocol family. In various implementations, a protocol stack includes a set of protocol layers, where the lowest protocol deals with low-level interaction with hardware and/or communications interfaces and each higher layer adds additional capabilities.

The term “application layer” at least in some examples refers to an abstraction layer that specifies shared communications protocols and interfaces used by hosts in a communications network. Additionally or alternatively, the term “application layer” at least in some examples refers to an abstraction layer that interacts with software applications that implement a communicating component, and may include identifying communication partners, determining resource availability, and synchronizing communication. Examples of application layer protocols include HTTP, HTTPs, File Transfer Protocol (FTP), Dynamic Host Configuration Protocol (DHCP), Internet Message Access Protocol (IMAP), Lightweight Directory Access Protocol (LDAP), MQTT, Remote Authentication Dial-In User Service (RADIUS), Diameter protocol, Extensible Authentication Protocol (EAP), RDMA over Converged Ethernet version 2 (RoCEv2), Real-time Transport Protocol (RTP), RTP Control Protocol (RTCP), Real Time Streaming Protocol (RTSP), Skinny Client Control Protocol (SCCP), Session Initiation Protocol (SIP), Session Description Protocol (SDP), Simple Mail Transfer Protocol (SMTP), Simple Network Management Protocol (SNMP), Simple Service Discovery Protocol (SSDP), Small Computer System Interface (SCSI), Internet SCSI (iSCSI), iSCSI Extensions for RDMA (iSER), Transport Layer Security (TLS), voice over IP (VoIP), Virtual Private Network (VPN), Extensible Messaging and Presence Protocol (XMPP), and/or the like.

The term “session layer” at least in some examples refers to an abstraction layer that controls dialogues and/or connections between entities or elements, and may include establishing, managing and terminating the connections between the entities or elements.

The term “transport layer” at least in some examples refers to a protocol layer that provides end-to-end (e2e) communication services such as, for example, connection-oriented communication, reliability, flow control, and multiplexing. Examples of transport layer protocols include datagram congestion control protocol (DCCP), fibre channel protocol (FBC), Generic Routing Encapsulation (GRE), GPRS Tunneling (GTP), Micro Transport Protocol (pTP), Multipath TCP (MPTCP), MultiPath QUIC (MPQUIC), Multipath UDP (MPUDP), Quick UDP Internet Connections (QUIC), Remote Direct Memory Access (RDMA), Resource Reservation Protocol (RSVP), Stream Control Transmission Protocol (SCTP), transmission control protocol (TCP), user datagram protocol (UDP), and/or the like.

The term “network layer” at least in some examples refers to a protocol layer that includes means for transferring network packets from a source to a destination via one or more networks. Additionally or alternatively, the term “network layer” at least in some examples refers to a protocol layer that is responsible for packet forwarding and/or routing through intermediary nodes. Additionally or alternatively, the term “network layer” or “internet layer” at least in some examples refers to a protocol layer that includes interworking methods, protocols, and specifications that are used to transport network packets across a network. As examples, the network layer protocols include internet protocol (IP), IP security (IPsec), Internet Control Message Protocol (ICMP), Internet Group Management Protocol (IGMP), Open Shortest Path First protocol (OSPF), Routing Information Protocol (RIP), RDMA over Converged Ethernet version 2 (RoCEv2), Subnetwork Access Protocol (SNAP), and/or some other internet or network protocol layer.

The term “link layer” or “data link layer” at least in some examples refers to a protocol layer that transfers data between nodes on a network segment across a physical layer. Examples of link layer protocols include logical link control (LLC), medium access control (MAC), Ethernet, RDMA over Converged Ethernet version 1 (RoCEv1), and/or the like.

The term “radio resource control”, “RRC layer”, or “RRC” at least in some examples refers to a protocol layer or sublayer that performs system information handling; paging; establishment, maintenance, and release of RRC connections; security functions; establishment, configuration, maintenance and release of Signaling Radio Bearers (SRBs) and Data Radio Bearers (DRBs); mobility functions/services; QoS management; and some sidelink specific services and functions over the Uu interface (see e.g., 3GPP TS 36.331 v17.0.0 (2022-04-13) and/or 3GPP TS 38.331 v17.0.0 (2022-04-19) (“[TS38331]”)).

The term “Service Data Adaptation Protocol”, “SDAP layer”, or “SDAP” at least in some examples refers to a protocol layer or sublayer that performs mapping between QoS flows and a data radio bearers (DRBs) and marking QoS flow IDs (QFI) in both DL and UL packets (see e.g., 3GPP TS 37.324 v17.0.0 (2022-04-13)).

The term “Packet Data Convergence Protocol”, “PDCP layer”, or “PDCP” at least in some examples refers to a protocol layer or sublayer that performs transfer user plane or control plane data; maintains PDCP sequence numbers (SNs); header compression and decompression using the Robust Header Compression (ROHC) and/or Ethernet Header Compression (EHC) protocols; ciphering and deciphering; integrity protection and integrity verification; provides timer based SDU discard; routing for split bearers; duplication and duplicate discarding; reordering and in-order delivery; and/or out-of-order delivery (see e.g., 3GPP TS 36.323 v17.0.0 (2022-04-15) and/or 3GPP TS 38.323 v17.0.0 (2022-04-14)).

The term “radio link control layer”, “RLC layer”, or “RLC” at least in some examples refers to a protocol layer or sublayer that performs transfer of upper layer PDUs; sequence numbering independent of the one in PDCP; error Correction through ARQ; segmentation and/or re-segmentation of RLC SDUs; reassembly of SDUs; duplicate detection; RLC SDU discarding; RLC re-establishment; and/or protocol error detection (see e.g., 3GPP TS 38.322 v17.0.0 (2022-04-15) and 3GPP TS 36.322 v17.0.0 (2022-04-15)).

The term “medium access control protocol”, “MAC protocol”, or “MAC” at least in some examples refers to a protocol that governs access to the transmission medium in a network, to enable the exchange of data between stations in a network. Additionally or alternatively, the term “medium access control layer”, “MAC layer”, or “MAC” at least in some examples refers to a protocol layer or sublayer that performs functions to provide frame-based, connectionless-mode (e.g., datagram style) data transfer between stations or devices. Additionally or alternatively, the term “medium access control layer”, “MAC layer”, or “MAC” at least in some examples refers to a protocol layer or sublayer that performs mapping between logical channels and transport channels; multiplexing/demultiplexing of MAC SDUs belonging to one or different logical channels into/from transport blocks (TB) delivered to/from the physical layer on transport channels; scheduling information reporting; error correction through HARQ (one HARQ entity per cell in case of CA); priority handling between UEs by means of dynamic scheduling; priority handling between logical channels of one UE by means of logical channel prioritization; priority handling between overlapping resources of one UE; and/or padding (see e.g., [IEEE802], 3GPP TS 38.321 v17.0.0 (2022-04-14), and 3GPP TS 36.321 v17.0.0 (2022-04-19)).

The term “physical layer”, “PHY layer”, or “PHY” at least in some examples refers to a protocol layer or sublayer that includes capabilities to transmit and receive modulated signals for communicating in a communications network (see e.g., [IEEE802], 3GPP TS 38.201 v17.0.0 (2022-01-05) and 3GPP TS 36.201 v17.0.0 (2022-03-31)).

The term “radio technology” at least in some examples refers to technology for wireless transmission and/or reception of electromagnetic radiation for information transfer. The term “radio access technology” or “RAT” at least in some examples refers to the technology used for the underlying physical connection to a radio based communication network.

The term “RAT type” at least in some examples may identify a transmission technology and/or communication protocol used in an access network, for example, new radio (NR), Long Term Evolution (LTE), narrowband IoT (NB-IoT), untrusted non-3GPP, trusted non-3GPP, trusted Institute of Electrical and Electronics Engineers (IEEE) 802 (e.g, [IEEE80211]; see also IEEE Standard for Local and Metropolitan Area Networks: Overview and Architecture, IEEE Std 802-2014, pp. 1-74 (30 Jun. 2014) (“[IEEE802]”), the contents of which is hereby incorporated by reference in its entirety), non-3GPP access, MuLTEfire, WiMAX, wireline, wireline-cable, wireline broadband forum (wireline-BBF), and the like. Examples of RATs and/or wireless communications protocols include Advanced Mobile Phone System (AMPS) technologies such as Digital AMPS (D-AMPS), Total Access Communication System (TACS) (and variants thereof such as Extended TACS (ETACS), and/or the like); Global System for Mobile Communications (GSM) technologies such as Circuit Switched Data (CSD), High-Speed CSD (HSCSD), General Packet Radio Service (GPRS), and Enhanced Data Rates for GSM Evolution (EDGE); Third Generation Partnership Project (3GPP) technologies including, for example, Universal Mobile Telecommunications System (UMTS) (and variants thereof such as UMTS Terrestrial Radio Access (UTRA), Wideband Code Division Multiple Access (W-CDMA), Freedom of Multimedia Access (FOMA), Time Division-Code Division Multiple Access (TD-CDMA), Time Division-Synchronous Code Division Multiple Access (TD-SCDMA), and/or the like), Generic Access Network (GAN)/Unlicensed Mobile Access (UMA), High Speed Packet Access (HSPA) (and variants thereof such as HSPA Plus (HSPA+), and/or the like), Long Term Evolution (LTE) (and variants thereof such as LTE-Advanced (LTE-A), Evolved UTRA (E-UTRA), LTE Extra, LTE-A Pro, LTE LAA, MuLTEfire, and/or the like), Fifth Generation (5G) or New Radio (NR), and/or the like; ETSI technologies such as High Performance Radio Metropolitan Area Network (HiperMAN) and the like; IEEE technologies such as [IEEE802] and/or WiFi (e.g, [IEEE80211] and variants thereof), Worldwide Interoperability for Microwave Access (WiMAX) (e.g, [WiMAX] and variants thereof), Mobile Broadband Wireless Access (MBWA)/iBurst (e.g, IEEE 802.20 and variants thereof), and/or the like; Integrated Digital Enhanced Network (iDEN) (and variants thereof such as Wideband Integrated Digital Enhanced Network (WiDEN); millimeter wave (mmWave) technologies/standards (e.g, wireless systems operating at 10-300 GHz and above such as 3GPP 5G, Wireless Gigabit Alliance (WiGig) standards (e.g, IEEE 802.11 ad, IEEE 802.11ay, and the like); short-range and/or wireless personal area network (WPAN) technologies/standards such as Bluetooth (and variants thereof such as Bluetooth 5.3, Bluetooth Low Energy (BLE), and/or the like), IEEE 802.15 technologies/standards (e.g, IEEE Standard for Low-Rate Wireless Networks, IEEE Std 802.15.4-2020, pp. 1-800 (23 Jul. 2020) (“[IEEE802154]”), ZigBee, Thread, IPv6 over Low power WPAN (6LoWPAN), WirelessHART, MiWi, ISA100.11a, IEEE Standard for Local and metropolitan area networks—Part 15.6: Wireless Body Area Networks, IEEE Std 802.15.6-2012, pp. 1-271 (29 Feb. 2012), WiFi-direct, ANT/ANT+, Z-Wave, 3GPP Proximity Services (ProSe), Universal Plug and Play (UPnP), low power Wide Area Networks (LPWANs), Long Range Wide Area Network (LoRA or LoRaWAN™), and the like; optical and/or visible light communication (VLC) technologies/standards such as IEEE Standard for Local and metropolitan area networks—Part 15.7: Short-Range Optical Wireless Communications, IEEE Std 802.15.7-2018, pp. 1-407 (23 Apr. 2019), and the like; V2X communication including 3GPP cellular V2X (C-V2X), Wireless Access in Vehicular Environments (WAVE) (IEEE Standard for Information technology—Local and metropolitan area networks—Specific requirements—Part 11: Wireless LAN Medium Access Control (MAC) and Physical Layer (PHY) Specifications Amendment 6: Wireless Access in Vehicular Environments, IEEE Std 802.iip-2010, pp. 1-51 (15 Jul. 2010) (“[IEEE80211p]”), which is now part of [IEEE80211]), IEEE 802.11bd (e.g, for vehicular ad-hoc environments), Dedicated Short Range Communications (DSRC), Intelligent-Transport-Systems (ITS) (including the European ITS-G5, ITS-G5B, ITS-G5C, and/or the like); Sigfox; Mobitex; 3GPP2 technologies such as cdmaOne (2G), Code Division Multiple Access 2000 (CDMA 2000), and Evolution-Data Optimized or Evolution-Data Only (EV-DO); Push-to-talk (PTT), Mobile Telephone System (MTS) (and variants thereof such as Improved MTS (IMTS), Advanced MTS (AMTS), and/or the like); Personal Digital Cellular (PDC); Personal Handy-phone System (PHS), Cellular Digital Packet Data (CDPD); Cellular Digital Packet Data (CDPD); DataTAC; Digital Enhanced Cordless Telecommunications (DECT) (and variants thereof such as DECT Ultra Low Energy (DECT ULE), DECT-2020, DECT-5G, and/or the like); Ultra High Frequency (UHF) communication; Very High Frequency (VHF) communication; and/or any other suitable RAT or protocol. In addition to the aforementioned RATs/standards, any number of satellite uplink technologies may be used for purposes of the present disclosure including, for example, radios compliant with standards issued by the International Telecommunication Union (ITU), or the ETSI, among others. The examples provided herein are thus understood as being applicable to various other communication technologies, both existing and not yet formulated.

The term “V2X” at least in some examples refers to vehicle to vehicle (V2V), vehicle to infrastructure (V2I), infrastructure to vehicle (I2V), vehicle to network (V2N), and/or network to vehicle (N2V) communications and associated radio access technologies.

The term “channel” at least in some examples refers to any transmission medium, either tangible or intangible, which is used to communicate data or a data stream. The term “channel” may be synonymous with and/or equivalent to “communications channel,” “data communications channel,” “transmission channel,” “data transmission channel,” “access channel,” “data access channel,” “link,” “data link,” “carrier,” “radiofrequency carrier,” and/or any other like term denoting a pathway or medium through which data is communicated. Additionally, the term “link” at least in some examples refers to a connection between two devices through a RAT for the purpose of transmitting and receiving information.

The term “local area network” or “LAN” at least in some examples refers to a network of devices, whether indoors or outdoors, covering a limited area or a relatively small geographic area (e.g, within a building or a campus). The term “wireless local area network”, “wireless LAN”, or “WLAN” at least in some examples refers to a LAN that involves wireless communications. The term “wide area network” or “WAN” at least in some examples refers to a network of devices that extends over a relatively large geographic area (e.g, a telecommunications network). Additionally or alternatively, the term “wide area network” or “WAN” at least in some examples refers to a computer network spanning regions, countries, or even an entire planet. The term “backbone network”, “backbone”, or “core network” at least in some examples refers to a computer network which interconnects networks, providing a path for the exchange of information between different subnetworks such as LANs or WANs.

The term “interworking” at least in some examples refers to the use of interconnected stations in a network for the exchange of data, by means of protocols operating over one or more underlying data transmission paths.

The term “flow” at least in some examples refers to a sequence of data and/or data units (e.g, datagrams, packets, or the like) from a source entity/element to a destination entity/element. Additionally or alternatively, the terms “flow” or “traffic flow” at least in some examples refer to an artificial and/or logical equivalent to a call, connection, or link. Additionally or alternatively, the terms “flow” or “traffic flow” at least in some examples refer to a sequence of packets sent from a particular source to a particular unicast, anycast, or multicast destination that the source desires to label as a flow; from an upper-layer viewpoint, a flow may include of all packets in a specific transport connection or a media stream, however, a flow is not necessarily 1:1 mapped to a transport connection. Additionally or alternatively, the terms “flow” or “traffic flow” at least in some examples refer to a set of data and/or data units (e.g, datagrams, packets, or the like) passing an observation point in a network during a certain time interval. Additionally or alternatively, the term “flow” at least in some examples refers to a user plane data link that is attached to an association. Examples are circuit switched phone call, voice over IP call, reception of an SMS, sending of a contact card, PDP context for internet access, demultiplexing a TV channel from a channel multiplex, calculation of position coordinates from geopositioning satellite signals, and/or the like. For purposes of the present disclosure, the terms “traffic flow”, “data flow”, “dataflow”, “packet flow”, “network flow”, and/or “flow” may be used interchangeably even though these terms at least in some examples refers to different concepts.

The term “dataflow” or “data flow” at least in some examples refers to the movement of data through a system including software elements, hardware elements, or a combination of both software and hardware elements. Additionally or alternatively, the term “dataflow” or “data flow” at least in some examples refers to a path taken by a set of data from an origination or source to destination that includes all nodes through which the set of data travels.

The term “stream” at least in some examples refers to a sequence of data elements made available over time. At least in some examples, functions that operate on a stream, which may produce another stream, are referred to as “filters,” and can be connected in pipelines, analogously to function composition; filters may operate on one item of a stream at a time, or may base an item of output on multiple items of input, such as a moving average. Additionally or alternatively, the term “stream” or “streaming” at least in some examples refers to a manner of processing in which an object is not represented by a complete logical data structure of nodes occupying memory proportional to a size of that object, but are processed “on the fly” as a sequence of events.

The term “service” at least in some examples refers to the provision of a discrete function within a system and/or environment. Additionally or alternatively, the term “service” at least in some examples refers to a functionality or a set of functionalities that can be reused. The term “microservice” at least in some examples refers to one or more processes that communicate over a network to fulfil a goal using technology-agnostic protocols (e.g, HTTP or the like). Additionally or alternatively, the term “microservice” at least in some examples refers to services that are relatively small in size, messaging-enabled, bounded by contexts, autonomously developed, independently deployable, decentralized, and/or built and released with automated processes. Additionally or alternatively, the term “microservice” at least in some examples refers to a self-contained piece of functionality with clear interfaces, and may implement a layered architecture through its own internal components. Additionally or alternatively, the term “microservice architecture” at least in some examples refers to a variant of the service-oriented architecture (SOA) structural style wherein applications are arranged as a collection of loosely-coupled services (e.g, fine-grained services) and may use lightweight protocols. The term “network service” at least in some examples refers to a composition of Network Function(s) and/or Network Service(s), defined by its functional and behavioral specification.

The term “session” at least in some examples refers to a temporary and interactive information interchange between two or more communicating devices, two or more application instances, between a computer and user, and/or between any two or more entities or elements. Additionally or alternatively, the term “session” at least in some examples refers to a connectivity service or other service that provides or enables the exchange of data between two entities or elements. The term “network session” at least in some examples refers to a session between two or more communicating devices over a network. The term “web session” at least in some examples refers to session between two or more communicating devices over the Internet or some other network. The term “session identifier,” “session ID,” or “session token” at least in some examples refers to a piece of data that is used in network communications to identify a session and/or a series of message exchanges.

The term “quality” at least in some examples refers to a property, character, attribute, or feature of something as being affirmative or negative, and/or a degree of excellence of something. Additionally or alternatively, the term “quality” at least in some examples, in the context of data processing, refers to a state of qualitative and/or quantitative aspects of data, processes, and/or some other aspects of data processing systems. The term “Quality of Service” or “QoS’ at least in some examples refers to a description or measurement of the overall performance of a service (e.g, telephony and/or cellular service, network service, wireless communication/connectivity service, cloud computing service, and/or the like). In some cases, the QoS may be described or measured from the perspective of the users of that service, and as such, QoS may be the collective effect of service performance that determine the degree of satisfaction of a user of that service. In other cases, QoS at least in some examples refers to traffic prioritization and resource reservation control mechanisms rather than the achieved perception of service quality. In these cases, QoS is the ability to provide different priorities to different applications, users, or flows, or to guarantee a certain level of performance to a flow. In either case, QoS is characterized by the combined aspects of performance factors applicable to one or more services such as, for example, service operability performance, service accessibility performance; service retain ability performance; service reliability performance, service integrity performance, and other factors specific to each service. Several related aspects of the service may be considered when quantifying the QoS, including packet loss rates, bit rates, throughput, transmission delay, availability, reliability, jitter, signal strength and/or quality measurements, and/or other measurements such as those discussed herein. Additionally or alternatively, the term “Quality of Service” or “QoS’ at least in some examples refers to mechanisms that provide traffic-forwarding treatment based on flow-specific traffic classification. In some implementations, the term “Quality of Service” or “QoS” can be used interchangeably with the term “Class of Service” or “CoS”.

The term “queue” at least in some examples refers to a collection of entities (e.g, data, objects, events, and/or the like) are stored and held to be processed later. that are maintained in a sequence and can be modified by the addition of entities at one end of the sequence and the removal of entities from the other end of the sequence; the end of the sequence at which elements are added may be referred to as the “back”, “tail”, or “rear” of the queue, and the end at which elements are removed may be referred to as the “head” or “front” of the queue. Additionally, a queue may perform the function of a buffer, and the terms “queue” and “buffer” may be used interchangeably throughout the present disclosure. The term “enqueue” at least in some examples refers to one or more operations of adding an element to the rear of a queue. The term “dequeue” at least in some examples refers to one or more operations of removing an element from the front of a queue.

The term “time to live” or “TTL” at least in some examples refers to a mechanism which limits the lifespan or lifetime of data in a computer or network. In some examples, a TTL is implemented as a counter or timestamp attached to or embedded in data or a data unit, wherein once the prescribed event count or timespan has elapsed, the data is discarded or revalidated.

The term “PDU Connectivity Service” at least in some examples refers to a service that provides exchange of protocol data units (PDUs) between a UE and a data network (DN). The term “PDU Session” at least in some examples refers to an association between a UE and a DN that provides a PDU connectivity service (see e.g, 3GPP TS 38.415 v16.6.0 (2021-12-23) (“[TS38415]”) and 3GPP TS 38.413 v16.8.0 (2021-12-23) (“[TS38413]”), the contents of each of which are hereby incorporated by reference in their entireties); a PDU Session type can be IPv4, IPv6, IPv4v6, Ethernet), Unstructured, or any other network/connection type, such as those discussed herein. The term “PDU Session Resource” at least in some examples refers to an NG-RAN interface (e.g, NG, Xn, and/or E1 interfaces) and radio resources provided to support a PDU Session. The term “multi-access PDU session” or “MA PDU Session” at least in some examples refers to a PDU Session that provides a PDU connectivity service, which can use one access network at a time or multiple access networks simultaneously.

The term “network address” at least in some examples refers to an identifier for a node or host in a computer network, and may be a unique identifier across a network and/or may be unique to a locally administered portion of the network. Examples of network addresses include a Closed Access Group Identifier (CAG-ID), Bluetooth hardware device address (BD_ADDR), a cellular network address (e.g, Access Point Name (APN), AMF identifier (ID), AF-Service-Identifier, Edge Application Server (EAS) ID, Data Network Access Identifier (DNAI), Data Network Name (DNN), EPS Bearer Identity (EBI), Equipment Identity Register (EIR) and/or 5G-EIR, Extended Unique Identifier (EUI), Group ID for Network Selection (GIN), Generic Public Subscription Identifier (GPSI), Globally Unique AMF Identifier (GUAMI), Globally Unique Temporary Identifier (GUTI) and/or 5G-GUTI, Radio Network Temporary Identifier (RNTI) (including any RNTI discussed in clause 8.1 of 3GPP TS 38.300 v17.0.0 (2022-04-13) (“[TS38300]”)), International Mobile Equipment Identity (IMEI), IMEI Type Allocation Code (IMEA/TAC), International Mobile Subscriber Identity (IMSI), IMSI software version (IMSISV), permanent equipment identifier (PEI), Local Area Data Network (LADN) DNN, Mobile Subscriber Identification Number (MSIN), Mobile Subscriber/Station ISDN Number (MSISDN), Network identifier (NID), Network Slice Instance (NSI) ID, Permanent Equipment Identifier (PEI), Public Land Mobile Network (PLMN) ID, QoS Flow ID (QFI) and/or 5G QoS Identifier (5QI), RAN ID, Routing Indicator, SMS Function (SMSF) ID, Stand-alone Non-Public Network (SNPN) ID, Subscription Concealed Identifier (SUCI), Subscription Permanent Identifier (SUPI), Temporary Mobile Subscriber Identity (TMSI) and variants thereof, UE Access Category and Identity, and/or other cellular network related identifiers), an email address, Enterprise Application Server (EAS) ID, an endpoint address, an Electronic Product Code (EPC) as defined by the EPCglobal Tag Data Standard, a Fully Qualified Domain Name (FQDN), an internet protocol (IP) address in an IP network (e.g, IP version 4 (Ipv4), IP version 6 (IPv6), and/or the like), an internet packet exchange (IPX) address, Local Area Network (LAN) ID, a media access control (MAC) address, personal area network (PAN) ID, a port number (e.g, Transmission Control Protocol (TCP) port number, User Datagram Protocol (UDP) port number), QUIC connection ID, RFID tag, service set identifier (SSID) and variants thereof, telephone numbers in a public switched telephone network (PTSN), a socket address, universally unique identifier (UUID) (e.g, as specified in ISO/IEC 11578:1996), a Universal Resource Locator (URL) and/or Universal Resource Identifier (URI), Virtual LAN (VLAN) ID, an X.21 address, an X.25 address, Zigbee® ID, Zigbee® Device Network ID, and/or any other suitable network address and components thereof. The term “application identifier”, “application ID”, or “app ID” at least in some examples refers to an identifier that can be mapped to a specific application or application instance; in the context of 3GPP 5G/NR systems, an “application identifier” at least in some examples refers to an identifier that can be mapped to a specific application traffic detection rule.

The term “endpoint address” at least in some examples refers to an address used to determine the host/authority part of a target URI, where the target URI is used to access an NF service (e.g, to invoke service operations) of an NF service producer or for notifications to an NF service consumer.

The term “Radio Equipment” or “RE” at least in some examples refers to an electrical or electronic product, which intentionally emits and/or receives radio waves for the purpose of radio communication and/or radiodetermination, or an electrical or electronic product which must be completed with an accessory, such as antenna, so as to intentionally emit and/or receive radio waves for the purpose of radio communication and/or radiodetermination. The term “radio frequency transceiver” or “RF transceiver” at least in some examples refers to part of a radio platform converting, for transmission, baseband signals into radio signals, and, for reception, radio signals into baseband signals. The term “radio reconfiguration” at least in some examples refers to reconfiguration of parameters related to air interface. The term “radio system” refers to a system capable to communicate some user information by using electromagnetic waves. The term “reconfigurable radio equipment” or “RRE” at least in some examples refers to an RE with radio communication capabilities providing support for radio reconfiguration. Examples of RREs include smartphones, feature phones, tablets, laptops, connected vehicle communication platforms, network platforms, IoT devices, and/or other like equipment.

The term “reference point at least in some examples refers to a conceptual point at the conjunction of two non-overlapping functions that can be used to identify the type of information passing between these functions

The term “application” at least in some examples refers to a computer program designed to carry out a specific task other than one relating to the operation of the computer itself. Additionally or alternatively, term “application” at least in some examples refers to a complete and deployable package, environment to achieve a certain function in an operational environment.

The term “algorithm” at least in some examples refers to an unambiguous specification of how to solve a problem or a class of problems by performing calculations, input/output operations, data processing, automated reasoning tasks, and/or the like.

The term “analytics” at least in some examples refers to the discovery, interpretation, and communication of meaningful patterns in data.

The term “application programming interface” or “API” at least in some examples refers to a set of subroutine definitions, communication protocols, and tools for building software. Additionally or alternatively, the term “application programming interface” or “API” at least in some examples refers to a set of clearly defined methods of communication among various components. An API may be for a web-based system, operating system, database system, computer hardware, or software library.

The terms “instantiate,” “instantiation,” and the like at least in some examples refers to the creation of an instance. An “instance” also at least in some examples refers to a concrete occurrence of an object, which may occur, for example, during execution of program code.

The term “data processing” or “processing” at least in some examples refers to any operation or set of operations which is performed on data or on sets of data, whether or not by automated means, such as collection, recording, writing, organization, structuring, storing, adaptation, alteration, retrieval, consultation, use, disclosure by transmission, dissemination or otherwise making available, alignment or combination, restriction, erasure and/or destruction.

The term “data pipeline” or “pipeline” at least in some examples refers to a set of data processing elements (or data processors) connected in series and/or in parallel, where the output of one data processing element is the input of one or more other data processing elements in the pipeline; the elements of a pipeline may be executed in parallel or in time-sliced fashion and/or some amount of buffer storage can be inserted between elements.

The term “filter” at least in some examples refers to computer program, subroutine, or other software element capable of processing a stream, data flow, or other collection of data, and producing another stream. In some implementations, multiple filters can be strung together or otherwise connected to form a pipeline.

The term “use case” at least in some examples refers to a description of a system from a user's perspective. Use cases sometimes treat a system as a black box, and the interactions with the system, including system responses, are perceived as from outside the system. Use cases typically avoid technical jargon, preferring instead the language of the end user or domain expert.

The term “user” at least in some examples refers to an abstract representation of any entity issuing commands, requests, and/or data to a compute node or system, and/or otherwise consumes or uses services.

The term “user profile” or “consumer profile” at least in some examples refer to a collection of settings and information associated with a user, consumer, or data subject, which contains information that can be used to identify the user, consumer, or data subject such as demographic information, audio or visual media/content, and individual characteristics such as knowledge or expertise. Inferences drawn from collected data/information can also be used to create a profile about a consumer reflecting the consumer's preferences, characteristics, psychological trends, predispositions, behavior, attitudes, intelligence, abilities, and aptitudes.

The term “datagram” at least in some examples at least in some examples refers to a basic transfer unit associated with a packet-switched network; a datagram may be structured to have header and payload sections. The term “datagram” at least in some examples may be synonymous with any of the following terms, even though they may refer to different aspects: “data unit”, a “protocol data unit” or “PDU”, a “service data unit” or “SDU”, “frame”, “packet”, a “network packet”, “segment”, “block”, “cell”, “chunk”, and/or the like. Examples of datagrams, network packets, and the like, include internet protocol (IP) packet, Internet Control Message Protocol (ICMP) packet, UDP packet, TCP packet, SCTP packet, ICMP packet, Ethernet frame, RRC messages/packets, SDAP PDU, SDAP SDU, PDCP PDU, PDCP SDU, MAC PDU, MAC SDU, BAP PDU. BAP SDU, RLC PDU, RLC SDU, WiFi frames as discussed in a [IEEE802] protocol/standard (e.g, [IEEE80211] or the like), and/or other like data structures.

The term “information element” or “IE” at least in some examples refers to a structural element containing one or more fields. Additionally or alternatively, the term “information element” or “IE” at least in some examples refers to a field or set of fields defined in a standard or specification that is used to convey data and/or protocol information.

The term “field” at least in some examples refers to individual contents of an information element, or a data element that contains content. The term “data element” or “DE” at least in some examples refers to a data type that contains one single data. The term “data frame” or “DF” at least in some examples refers to a data type that contains more than one data element in a predefined order.

The term “reference” at least in some examples refers to data useable to locate other data and may be implemented a variety of ways (e.g, a pointer, an index, a handle, a key, an identifier, a hyperlink, and/or the like).

The term “translation” at least in some examples refers to the process of converting or otherwise changing data from a first form, shape, configuration, structure, arrangement, example, description, or the like into a second form, shape, configuration, structure, arrangement, example, description, or the like; at least in some examples there may be two different types of translation: transcoding and transformation. The term “transcoding” at least in some examples refers to taking information/data in one format (e.g, a packed binary format) and translating the same information/data into another format in the same sequence. Additionally or alternatively, the term “transcoding” at least in some examples refers to taking the same information, in the same sequence, and packaging the information (e.g, bits or bytes) differently. The term “transformation” at least in some examples refers to changing data from one format and writing it in another format, keeping the same order, sequence, and/or nesting of data items. Additionally or alternatively, the term “transformation” at least in some examples involves the process of converting data from a first format or structure into a second format or structure, and involves reshaping the data into the second format to conform with a schema or other like specification. Transformation may include rearranging data items or data objects, which may involve changing the order, sequence, and/or nesting of the data items/objects. Additionally or alternatively, the term “transformation” at least in some examples refers to changing the schema of a data object to another schema.

The term “authorization” at least in some examples refers to a prescription that a particular behavior shall not be prevented.

The term “confidential data” at least in some examples refers to any form of information that a person or entity is obligated, by law or contract, to protect from unauthorized access, use, disclosure, modification, or destruction. Additionally or alternatively, “confidential data” at least in some examples refers to any data owned or licensed by a person or entity that is not intentionally shared with the general public or that is classified by the person or entity with a designation that precludes sharing with the general public.

The term “consent” at least in some examples refers to any freely given, specific, informed and unambiguous indication of a data subject's wishes by which he or she, by a statement or by a clear affirmative action, signifies agreement to the processing of personal data relating to the data subject.

The term “consistency check” at least in some examples refers to a test or assessment performed to determine if data has any internal conflicts, conflicts with other data, and/or whether any contradictions exist. In some examples, a “consistency check” may operate according to a “consistency model”, which at least in some examples refers to a set of operations for performing a consistency check and/or rules or policies used to determine if data is consistent (or predictable) or not.

The term “cryptographic mechanism” at least in some examples refers to any cryptographic protocol and/or cryptographic algorithm. Additionally or alternatively, the term “cryptographic protocol” at least in some examples refers to a sequence of steps precisely specifying the actions to required of two or more entities to achieve specific security objectives (e.g, cryptographic protocol for key agreement). Additionally or alternatively, the term “cryptographic algorithm” at least in some examples refers to an algorithm specifying the steps followed by a single entity to achieve specific security objectives (e.g, cryptographic algorithm for symmetric key encryption).

The term “cryptographic hash function”, “hash function”, or “hash”) at least in some examples refers to a mathematical algorithm that maps data of arbitrary size (sometimes referred to as a “message”) to a bit array of a fixed size (sometimes referred to as a “hash value”, “hash”, or “message digest”). A cryptographic hash function is usually a one-way function, which is a function that is practically infeasible to invert.

The term “data breach” at least in some examples refers to a breach of security leading to the accidental or unlawful destruction, loss, alteration, unauthorised disclosure of, or access to, data (including personal, sensitive, and/or confidential data) transmitted, stored or otherwise processed.

The term “information security” or “InfoSec” at least in some examples refers to any practice, technique, and technology for protecting information by mitigating information risks and typically involves preventing or reducing the probability of unauthorized/inappropriate access to data, or the unlawful use, disclosure, disruption, deletion, corruption, modification, inspection, recording, or devaluation of information; and the information to be protected may take any form including electronic information, physical or tangible (e.g, computer-readable media storing information, paperwork, and the like), or intangible (e.g, knowledge, intellectual property assets, and the like).

The term “integrity” at least in some examples refers to a mechanism that assures that data has not been altered in an unapproved way. Examples of cryptographic mechanisms that can be used for integrity protection include digital signatures, message authentication codes (MAC), and secure hashes.

The term “personal data,” “personally identifiable information,” “PII,” at least in some examples refers to information that relates to an identified or identifiable individual (referred to as a “data subject”). Additionally or alternatively, “personal data,” “personally identifiable information,” “PII,” at least in some examples refers to information that can be used on its own or in combination with other information to identify, contact, or locate a data subject, or to identify a data subject in context.

The term “plausibility check” at least in some examples refers to a test or assessment performed to determine whether data is, or can be, plausible. The term “plausible” at least in some examples refers to an amount or quality of being acceptable, reasonable, comprehensible, and/or probable.

The term “pseudonymization” at least in some examples refers to any means of processing personal data or sensitive data in such a manner that the personal/sensitive data can no longer be attributed to a specific data subject (e.g, person or entity) without the use of additional information. The additional information may be kept separately from the personal/sensitive data and may be subject to technical and organizational measures to ensure that the personal/sensitive data are not attributed to an identified or identifiable natural person.

The term “sensitive data” at least in some examples refers to data related to racial or ethnic origin, political opinions, religious or philosophical beliefs, or trade union membership, genetic data, biometric data, data concerning health, and/or data concerning a natural person's sex life or sexual orientation.

The term “shielded location” at least in some examples refers to a memory location within the hardware root of trust, protected against attacks on confidentiality and manipulation attacks including deletion that impact the integrity of the memory, in which access is enforced by the hardware root of trust.

Although many of the previous examples are provided with use of specific cellular/mobile network terminology, including with the use of 4G/5G 3GPP network components (or expected terahertz-based 6G/6G+technologies), it will be understood these examples may be applied to many other deployments of wide area and local wireless networks, as well as the integration of wired networks (including optical networks and associated fibers, transceivers, and/or the like). Furthermore, various standards (e.g, 3GPP, ETSI, and/or the like) may define various message formats, PDUs, containers, frames, and/or the like, as comprising a sequence of optional or mandatory data elements (DEs), data frames (DFs), information elements (IEs), and/or the like. However, it should be understood that the requirements of any particular standard should not limit the examples discussed herein, and as such, any combination of containers, frames, DFs, DEs, IEs, values, actions, and/or features are possible in various examples, including any combination of containers, DFs, DEs, values, actions, and/or features that are strictly required to be followed in order to conform to such standards or any combination of containers, frames, DFs, DEs, IEs, values, actions, and/or features strongly recommended and/or used with or in the presence/absence of optional elements.

Such aspects of the inventive subject matter may be referred to herein, individually and/or collectively, merely for convenience and without intending to voluntarily limit the scope of this application to any single aspect or inventive concept if more than one is in fact disclosed. Thus, although specific aspects have been illustrated and described herein, it should be appreciated that any arrangement calculated to achieve the same purpose may be substituted for the specific aspects shown. This disclosure is intended to cover any and all adaptations or variations of various aspects. Combinations of the above aspects and other aspects not specifically described herein will be apparent to those of skill in the art upon reviewing the above description.

1-62. (canceled)

63. An apparatus employed as measurement equipment, the apparatus comprising:
memory circuitry to store instructions for operating the measurement equipment; and
processor circuitry connected to the memory circuitry, wherein the processor circuitry is to execute the instructions to:
send first signaling to an external radio equipment under test (REuT) via a testing access interface between the measurement equipment and the REuT, wherein the first signaling includes data or commands for testing one or more components of the REuT;
receive second signaling from the REuT over the testing access interface, wherein the second signaling includes data or commands based on execution of the first signaling by the one or more components of the REuT; and
verify or validate the execution of the first signaling by the one or more components of the REuT based on the second signaling.

64. The apparatus of claim 63, wherein the testing access interface is a wired or wireless connection between the REuT and the measurement equipment.

65. The apparatus of claim 63, wherein the measurement equipment is communicatively coupled with a Monitoring and Enforcement Function (MEF) via the testing access interface, the MEF is disposed between the REuT and the measurement equipment, and the first signaling is conveyed via the MEF over an Nmef service-based interface exposed by the MEF.

66. The apparatus of claim 63, wherein a translation entity within the REuT terminates the test access interface, and the translation entity is to convert the first signaling into an internal format for consumption by a component under test (CUT) within the REuT.

67. The apparatus of claim 66, wherein the first signaling includes an attack vector to be applied to one or more target components of the REuT, and the translation entity is to provide the attack vector to the CUT via an interface between the translation entity and the CUT, wherein the interface between the translation entity and the CUT is a standardized interconnect or a proprietary interface.

68. The apparatus of claim 67, wherein the processor circuitry is to execute the instructions to: receive, from the translation entity, a test results indicator including attack vector data, the attack vector data indicating whether the attack vector was successful or not successful, wherein the test results indicator indicates that the attack was unsuccessful when the CUT is able to detect the attack vector and is able to initiate one or more countermeasures to the attack vector, and the test results indicator indicates that the attack was successful when the CUT is unable to detect the attack vector during a predefined period of time.

69. The apparatus of claim 63, wherein the processor circuitry is to execute the instructions to: access attack history data from the REuT via a special access interface, wherein the special access interface is between the measurement equipment and a memory unit of the REuT.

70. The apparatus of claim 69, wherein the memory unit is a shielded location or tamper-resistant circuitry configured to buffer history data related to exchanges with external entities and/or observed (attempted) attacks.

71. The apparatus of claim 70, wherein the memory unit includes some or all of a write-only memory of the REuT, a trusted execution environment (TEE) of the REuT, a trusted platform module (TPM) of the REuT, or one or more secure enclaves of the REuT, and wherein the processor circuitry is to execute the instructions to:
receive, from the memory unit, a data structure including the history data, the history data including information about attempted attacks on the REuT, successful attacks on the REuT, and other exchanges between the REuT and one or more other devices;
evaluate whether the REuT has been compromised based on the history data; and
deactivate the REuT when the REuT has been determined to be compromised.

72. The apparatus of claim 63, wherein the measurement equipment is a user equipment (UE), a radio access network (RAN) node, a user plane function (UPF), or a data network (DN) node; and the REuT is a UE, a RAN node, a UPF, or a DN node.

73. A non-transitory computer readable medium (NTCRM) comprising instructions for operating a Monitoring and Enforcement Function (MEF), wherein execution of the instructions by one or more processors is to cause the MEF to:
monitor network traffic based on one or more security rules;
categorize the monitored network traffic based on the one or more security rules; and
control the categorized network traffic based on the one or more security rules.

74. The NTCRM of claim 73, wherein, to control the control the categorized network traffic, execution of the instructions is to cause the MEF to:
cause encryption of security sensitive payloads of the network traffic through an encryption mechanism; and
route the network traffic with the security sensitive payloads through one or more trusted network routes.

75. The NTCRM of claim 73, wherein, to control the control the categorized network traffic, execution of the instructions is to cause the MEF to:
detect a potential distributed denial of service (DDoS) attack based on a threshold number of requests issed from a source network address to a target network address; and
implement one or more DDoS countermeasures when a potential DDoS attack is detected, wherein the one or more DDoS countermeasures include one or more of: increasing network latency randomly across various requests to reduce a number of simultaneously arriving requests; randomly dropping a certain amount of packets such that a level of requests stays at a manageable level for the target network address; holding randomly selected packets back for a limited period of time to reduce a number of simultaneously arriving requests; excluding one or more source network addresses from network access for a predetermined or configured period of time; and limiting network capacity for one or more identified source network addresses.

76. The NTCRM of claim 73, wherein, to control the control the categorized network traffic, execution of the instructions is to cause the MEF to:
identify access rights associated with the network traffic; and
attach a time-to-live (TTL) indicator to packets belonging to the network traffic, wherein the TTL indicator is based on the identified access rights, wherein the access rights associated with the network traffic are withdrawn after expiration of a TTL indicated by the TTL indicator.

77. The NTCRM of claim 73, wherein, to control the control the categorized network traffic, execution of the instructions is to cause the MEF to:
monitor inputs to one or more network nodes and outputs from the one or more network nodes;
detect an anomaly based on the monitored inputs or the monitored outputs; and
implement one or more countermeasures when the anomaly is detected.

78. The NTCRM of claim 77, wherein, to implement the one or more countermeasures, execution of the instructions is to cause the MEF to:
interact with one or more network functions (NFs) in a cellular core network to cause one or more of:
disable network access for identified nodes ones of the one or more network nodes,
throttle network access for the identified nodes,
increase network latency for the identified nodes,
limit network capacity for the identified nodes, and
reduce a transmission rate of the identified nodes;
drop randomly selected packets sent to the identified nodes or sent from the identified nodes;
hold, for a predetermined or configured period of time, randomly selected packets sent to the identified nodes or sent from the identified nodes; and
inform a government or regulatory body about the identified nodes.

79. The NTCRM of claim 77, wherein the detection of the anomaly includes one or more of: detection of known hardware and software vulnerabilities of the one or more network nodes; detection of hardware and software updates that do not meet security requirements; detection of identical passwords being used for network access; detection of network traffic exhibiting password sniffing behavior; detection of passwords conflicting with a password policy; detection of a predetermined or configured number of failed network access attempts; detection of an attempted credential theft; and detection of unverified or unvalidated network access credentials;

80. The NTCRM of claim 73, wherein the MEF is a standalone network function (NF) in a cellular core network.

81. The NTCRM of claim 73, wherein the MEF is a Network Exposure Function (NEF) in a fifth generation core network (5GC).

82. The NTCRM of claim 73, wherein the MEF is communicatively coupled with measurement equipment and a radio equipment under test (REuT) separate from the measurement equipment, and execution of the instructions is to cause the MEF to:
receive first signaling from the measurement equipment for delivery to the REuT, wherein the first signaling includes data or commands for testing one or more components of the REuT;
deliver the first signaling to the REuT;
receive second signaling from the REuT for delivery to the measurement equipment, wherein the second signaling includes data or commands based on execution of the first signaling by the one or more components of the REuT; and
deliver the second signaling to the measurement equipment, wherein the second signaling is for verification or validation of the execution of the first signaling by the one or more components of the REuT based on the second signaling.
